(19) United States
(12) Patent Application Publication
(10) Pub. No.: US 2025/0383529 A1
(43) Pub. Date: Dec. 18, 2025

(54) PHOTOGRAPHING OPTICAL LENS SYSTEM, IMAGE CAPTURING UNIT AND ELECTRONIC DEVICE

(71) Applicant: LARGAN PRECISION CO., LTD., Taichung City (TW)

(72) Inventors: Kuan-Ting YEH, Taichung City (TW); YI-CHENG LIN, Taichung City (TW); Cheng-Yu TSAI, Taichung City (TW)

(73) Assignee: LARGAN PRECISION CO., LTD., Taichung City (TW)

(21) Appl. No.: 18/775,272

(22) Filed: Jul. 17, 2024

(30) Foreign Application Priority Data
Jun. 12, 2024 (TW) 113121693

(51) Int. Cl. G02B 13/00; G02B 1/04; G02B 9/34

(52) U.S. Cl. CPC G02B 13/004; G02B 1/041; G02B 9/34; G02B 13/0065

(57) ABSTRACT

A photographing optical lens system includes four lens elements which are, in order from an object side to an image side along an optical path: a first lens element, a second lens element, a third lens element and a fourth lens element. The first lens element with positive refractive power has an object-side surface being convex in a convex region thereof. The second lens element with positive refractive power has an object-side surface being convex in a convex region thereof. The third lens element with negative refractive power has an image-side surface being concave in a paraxial region thereof. The fourth lens element has an image-side surface being convex in a paraxial region thereof. At least one surface of at least one lens element in the photographing optical lens system has at least one inflection point.

### RELATED APPLICATIONS

This application claims priority to Taiwan Application 113121693, filed on Jun. 12, 2024, which is incorporated by reference herein in its entirety.

### BACKGROUND

### Technical Field

The present disclosure relates to a photographing optical lens system, an image capturing unit and an electronic device, more particularly to a photographing optical lens system and an image capturing unit applicable to an electronic device.

### Description of Related Art

With the development of semiconductor manufacturing technology, the performance of image sensors has improved, and the pixel size thereof has been scaled down. Therefore, featuring high image quality becomes one of the indispensable features of an optical system nowadays.

Furthermore, due to the rapid changes in technology, electronic devices equipped with optical systems are trending towards multi-functionality for various applications, and therefore the functionality requirements for the optical systems have been increasing. However, it is difficult for a conventional optical system to obtain a balance among the requirements such as high image quality, low sensitivity, a proper aperture size, miniaturization and a desirable field of view.

### SUMMARY

According to one aspect of the present disclosure, a photographing optical lens system includes four lens elements. The four lens elements are, in order from an object side to an image side along an optical path, a first lens element, a second lens element, a third lens element and a fourth lens element. Each of the four lens elements has an object-side surface facing toward the object side and an image-side surface facing toward the image side.

Preferably, the first lens element has positive refractive power. Preferably, the object-side surface of the first lens element is convex in a paraxial region thereof. Preferably, the second lens element has positive refractive power. Preferably, the object-side surface of the second lens element is convex in a paraxial region thereof. Preferably, the third lens element has negative refractive power. Preferably, the image-side surface of the third lens element is concave in a paraxial region thereof. Preferably, the image-side surface of the fourth lens element is convex in a paraxial region thereof. Preferably, at least one surface of at least one lens element in the photographing optical lens system has at least one inflection point.

When an axial distance between the object-side surface of the first lens element and the image-side surface of the fourth lens element is TD, an axial distance between the image-side surface of the fourth lens element and an image surface is BL, a focal length of the second lens element is f2, a focal length of the fourth lens element is f4, a central thickness of the first lens element is CT1, a central thickness of the second lens element is CT2, a central thickness of the third lens element is CT3, a curvature radius of the object-side surface of the first lens element is R1, and a curvature radius of the object-side surface of the third lens element is R5, the following conditions are preferably satisfied:

$$\begin{matrix}0.05 < TD / BL < 0 \text{.60} ; \\ 0.05 < \vert f 2 / f 4 \vert < 1.5 ; \\ 0.1 < ( C T 2 + C T 3 ) / C T 1 < 1. ; and \\ - 4.5 < ( R 1 - R 5 ) / ( R 1 + R 5 ) < 0.25 .\end{matrix}$$

According to another aspect of the present disclosure, a photographing optical lens system includes four lens elements. The four lens elements are, in order from an object side to an image side along an optical path, a first lens element, a second lens element, a third lens element and a fourth lens element. Each of the four lens elements has an object-side surface facing toward the object side and an image-side surface facing toward the image side.

Preferably, the first lens element has positive refractive power. Preferably, the object-side surface of the first lens element is convex in a paraxial region thereof. Preferably, the second lens element has positive refractive power. Preferably, the third lens element has negative refractive power. Preferably, the image-side surface of the third lens element is concave in a paraxial region thereof. Preferably, at least one surface of at least one lens element in the photographing optical lens system has at least one inflection point.

When an axial distance between the object-side surface of the first lens element and the image-side surface of the fourth lens element is TD, an axial distance between the image-side surface of the fourth lens element and an image surface is BL, a refractive index of the first lens element is N1, an Abbe number of the second lens element is V2, a central thickness of the second lens element is CT2, and an axial distance between the third lens element and the fourth lens element is T34, the following conditions are preferably satisfied:

$$\begin{matrix}0.05 < TD / BL < 0 \text{.60} ; \\ 1.65 < N 1 < 2.2 ; \\ 10. < V 2 < 45. ; and \\ 0.05 < C T 2 / T 34 < 1. .\end{matrix}$$

According to another aspect of the present disclosure, an image capturing unit includes one of the aforementioned photographing optical lens systems and an image sensor, wherein the image sensor is disposed on the image surface of the photographing optical lens system.

According to another aspect of the present disclosure, an electronic device includes the aforementioned image capturing unit.

### BRIEF DESCRIPTION OF THE DRAWINGS

The disclosure can be better understood by reading the following detailed description of the embodiments, with reference made to the accompanying drawings as follows:

FIG. 1 is a schematic view of an image capturing unit according to the 1st embodiment of the present disclosure;

FIG. 2 shows spherical aberration curves, astigmatic field curves and a distortion curve of the image capturing unit according to the 1st embodiment;

FIG. 3 is a schematic view of an image capturing unit according to the 2nd embodiment of the present disclosure;

FIG. 4 shows spherical aberration curves, astigmatic field curves and a distortion curve of the image capturing unit according to the 2nd embodiment;

FIG. 5 is a schematic view of an image capturing unit according to the 3rd embodiment of the present disclosure;

FIG. 6 shows spherical aberration curves, astigmatic field curves and a distortion curve of the image capturing unit according to the 3rd embodiment;

FIG. 7 is a schematic view of an image capturing unit according to the 4th embodiment of the present disclosure;

FIG. 8 shows spherical aberration curves, astigmatic field curves and a distortion curve of the image capturing unit according to the 4th embodiment;

FIG. 9 is a schematic view of an image capturing unit according to the 5th embodiment of the present disclosure;

FIG. 10 shows spherical aberration curves, astigmatic field curves and a distortion curve of the image capturing unit according to the 5th embodiment;

FIG. 11 is a schematic view of an image capturing unit according to the 6th embodiment of the present disclosure;

FIG. 12 shows spherical aberration curves, astigmatic field curves and a distortion curve of the image capturing unit according to the 6th embodiment;

FIG. 13 is a schematic view of an image capturing unit according to the 7th embodiment of the present disclosure;

FIG. 14 shows spherical aberration curves, astigmatic field curves and a distortion curve of the image capturing unit according to the 7th embodiment;

FIG. 15 is a schematic view of an image capturing unit according to the 8th embodiment of the present disclosure;

FIG. 16 shows spherical aberration curves, astigmatic field curves and a distortion curve of the image capturing unit according to the 8th embodiment;

FIG. 17 is a schematic view of an image capturing unit according to the 9th embodiment of the present disclosure;

FIG. 18 shows spherical aberration curves, astigmatic field curves and a distortion curve of the image capturing unit according to the 9th embodiment;

FIG. 19 is a perspective view of an image capturing unit according to the 10th embodiment of the present disclosure;

FIG. 20 is one perspective view of an electronic device according to the 11th embodiment of the present disclosure;

FIG. 21 is another perspective view of the electronic device in FIG. 20;

FIG. 22 is a block diagram of the electronic device in FIG. 20;

FIG. 23 is one schematic view of an electronic device according to the 12th embodiment of the present disclosure;

FIG. 24 is another schematic view of the electronic device in FIG. 23;

FIG. 25 is one perspective view of an electronic device according to the 13th embodiment of the present disclosure;

FIG. 26 shows a schematic view of inflection points and critical points on lens surfaces according to the 1st embodiment of the present disclosure;

FIG. 27 shows a schematic view of Sag3R1, ET2 and ET3 according to the 1st embodiment of the present disclosure;

FIG. 28 shows a schematic view of a shape of an aperture stop according to the present disclosure;

FIG. 29 shows a schematic view of another shape of an aperture stop according to the present disclosure;

FIG. 30 to FIG. 32 each shows a schematic view of a configuration of one reflective element in a photographing optical lens system according to one embodiment of the present disclosure;

FIG. 33 and FIG. 34 each shows a schematic view of a configuration of two reflective elements in a photographing optical lens system according to one embodiment of the present disclosure;

FIG. 35 shows a schematic view of a configuration of a double-reflection reflective element in a photographing optical lens system according to one embodiment of the present disclosure;

FIG. 36 shows a schematic view of a configuration of a triple-reflection reflective element in a photographing optical lens system according to one embodiment of the present disclosure;

FIG. 37 shows a schematic view of a configuration of a quadruple-reflection reflective element in a photographing optical lens system according to one embodiment of the present disclosure;

FIG. 38 shows a schematic view of a configuration of a quintuple-reflection reflective element in a photographing optical lens system according to one embodiment of the present disclosure;

FIG. 39 shows a schematic view of a configuration of one reflective element in a photographing optical lens system according to one embodiment of the present disclosure;

FIG. 40 shows a schematic view of a configuration of another reflective element in a photographing optical lens system according to one embodiment of the present disclosure;

FIG. 41 shows a schematic view of a configuration of a reflective element and its associated light path deflection in the image capturing unit according to the 1st embodiment;

FIG. 42 shows a schematic view of a configuration of another reflective element and its associated light path deflection in the image capturing unit according to the 1st embodiment;

FIG. 43 shows a schematic view of a configuration of another reflective element and its associated light path deflection in the image capturing unit according to the 1st embodiment;

FIG. 44 shows a schematic view of a configuration of another reflective element and its associated light path deflection in the image capturing unit according to the 1st embodiment;

FIG. 45 shows a schematic view of a configuration of another reflective element and its associated light path deflection in the image capturing unit according to the 1st embodiment;

FIG. 46 shows a schematic view of a configuration of another reflective element and its associated light path deflection in the image capturing unit according to the 1st embodiment;

FIG. 47 shows a schematic view of a configuration of another reflective element and its associated light path deflection in the image capturing unit according to the 1st embodiment;

FIG. 48 shows a schematic view of a configuration of another reflective element and its associated light path deflection in the image capturing unit according to the 9th embodiment;

FIG. 49 shows a schematic view of a configuration of a reflective element in the photographing optical lens system of the image capturing unit according to the 1st embodiment;

FIG. 50 shows a perspective view of the reflective element from FIG. 49 before forming trimmed edges and a recess; and

FIG. 51 shows a perspective view of the reflective element from FIG. 49 after forming trimmed edges and a recess.

### DETAILED DESCRIPTION

A photographing optical lens system includes four lens elements. The four lens elements are, in order from an object side to an image side along an optical path, a first lens element, a second lens element, a third lens element and a fourth lens element. Each of the four lens elements of the photographing optical lens system has an object-side surface facing toward the object side and an image-side surface facing toward the image side.

The first lens element has positive refractive power. Therefore, it is favorable for reducing size while simultaneously controlling the shooting angle and increasing incident light intake. The object-side surface of the first lens element is convex in a paraxial region thereof. Therefore, it is favorable for adjusting the surface shape of the first lens element to reduce the outer diameter on the object side of the photographing optical lens system.

The second lens element has positive refractive power. Therefore, it is favorable for converging light, controlling the light path, and correcting spherical aberration in the photographing optical lens system. The object-side surface of the second lens element can be convex in a paraxial region thereof. Therefore, it is favorable for providing the object-side surface of the second lens element with the ability to converge light, thereby achieving miniaturization.

The third lens element has negative refractive power. Therefore, it is favorable for balancing the refractive power of the first lens element to prevent excessive refraction angles of light, thereby reducing aberrations. The image-side surface of the third lens element is concave in a paraxial region thereof. Therefore, it is favorable for assisting in balancing the back focal length of the photographing optical lens system and correcting off-axis aberrations.

The fourth lens element can have positive refractive power. Therefore, it is favorable for balancing the light path and correcting spherical aberration in the photographing optical lens system, thereby maintaining an appropriate back focal length. The image-side surface of the fourth lens element can be convex in a paraxial region thereof. Therefore, it is favorable for adjusting the refraction direction of light in the fourth lens element to enlarge the image surface.

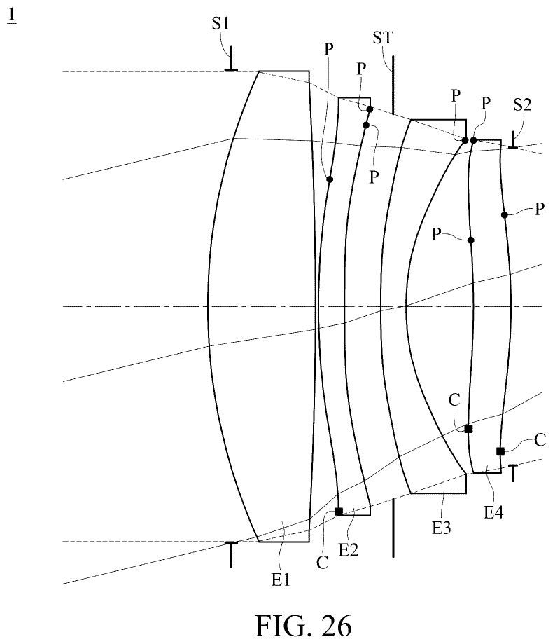

According to the present disclosure, at least one surface of at least one lens element in the photographing optical lens system has at least one inflection point. In detail, among the first lens element to the fourth lens element in the photographing optical lens system, one or more lens elements each have at least one inflection point, and the said lens element having at least one inflection point refers to a lens element in which at least one of the object-side surface and the image-side surface has at least one inflection point. Therefore, it is favorable for increasing the optical design flexibility for astigmatism corrections. Moreover, at least one of the object-side surface and the image-side surface of the fourth lens element can have at least one inflection point. Therefore, it is favorable for adjusting the incidence angle of light on the image surface and controlling the angle of peripheral light to reduce distortion. Please refer to FIG. 26, which shows a schematic view of the inflection points P on the lens surfaces according to the 1st embodiment of the present disclosure. In FIG. 26, the object-side surface of the second lens element E2, the image-side surface of the third lens element E3 and the image-side surface of the fourth lens element E4 each have one inflection point P, and the image-side surface of the second lens element E2 and the object-side surface of the fourth lens element E4 each have two inflection points P. The 1st embodiment of the present disclosure shown in FIG. 26 is only exemplary. Each of the lens elements in various embodiments of the present disclosure can have one or more inflection points.

The object-side surface of the fourth lens element can have at least one critical point in an off-axis region thereof. Therefore, it is favorable for enhancing the ability of the fourth lens element to correct aberrations in peripheral images. Please refer to FIG. 26, which shows a schematic view of the critical points C on the lens surfaces according to the 1st embodiment of the present disclosure. In FIG. 26, the object-side surface of the second lens element E2, and the object-side surface and the image-side surface of the fourth lens element E4 each have one critical point C in an off-axis region thereof. The 1st embodiment of the present disclosure shown in FIG. 26 is only exemplary. Each of the lens elements in various embodiments of the present disclosure can have one or more critical points in an off-axis region thereof.

The first lens element can be made of glass material. Using glass material for the first lens element can reduce the sensitivity of the first lens element to environmental factors, providing high stability in various environments. Additionally, when glass material is used near the object side of the photographing optical lens system, it is favorable for resisting humid conditions and preventing surface scratches, thereby enhancing the lifespan of electronic products.

According to the present disclosure, the photographing optical lens system can further include at least one reflective element, and the at least one reflective element can be located between the fourth lens element and an image surface along a travelling direction of the optical path. Therefore, it is favorable for providing different optical path directions for the photographing optical lens system, making the lens space configuration more flexible so as to reduce mechanical constraints and facilitate the miniaturization of the lens. Moreover, the reflective element can have at least two reflective surfaces. Therefore, by having light rays undergo multiple reflections within the reflective element and form images, it is favorable for reducing the overall size of the image capturing unit. Moreover, the reflective element can also have at least three reflective surfaces.

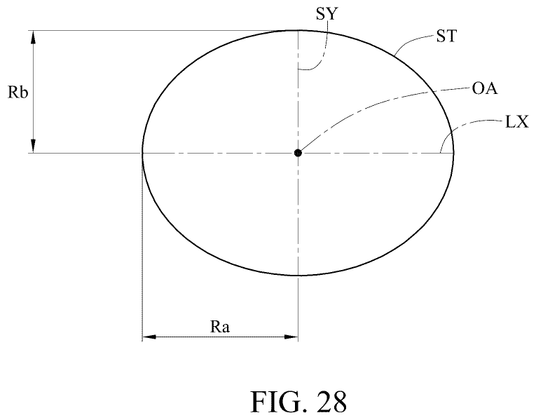

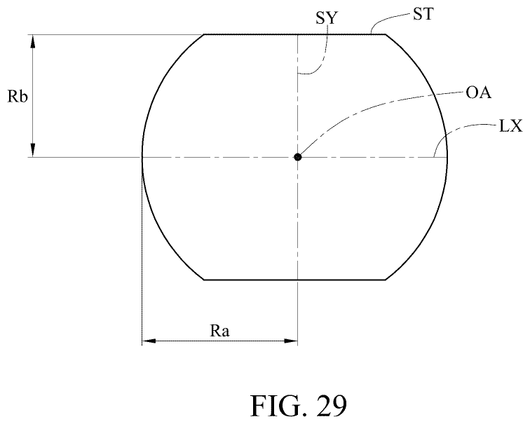

According to the present disclosure, the photographing optical lens system can further include an aperture stop. Therefore, it is favorable for ensuring the photographing optical lens system having a proper entrance pupil and controlling the field of view so as to achieve a telephoto photography effect. Moreover, the aperture stop can have a major axis direction and a minor axis direction which are perpendicular to an optical axis and different from each other, and an effective radius of the aperture stop in the major axis direction is different from an effective radius of the aperture stop in the minor axis direction. Therefore, it is favorable for adjusting the shape of the aperture stop so as to reduce stray light. For example, please refer to FIG. 28 and FIG. 29, which show schematic views of non-circular aperture stops according to the present disclosure, where FIG. 28 shows a schematic view of a shape of an aperture stop according to the present disclosure, and FIG. 29 shows a schematic view of another shape of an aperture stop according to the present disclosure. As shown in FIG. 28, in some configurations of the present disclosure, a shape of an aperture stop ST is elliptical, and the aperture stop ST has a major axis direction LX and a minor axis direction SY perpendicular to an optical axis OA. The major axis direction LX and the minor axis direction SY are two different directions, and an effective radius Ra of the aperture stop ST in the major axis direction LX is larger than an effective radius Rb of the aperture stop ST in the minor axis direction SY. As shown in FIG. 29, in some configurations of the present disclosure, an aperture stop ST is shaped to have trimmed edges at an outer periphery thereof, and the aperture stop ST has a major axis direction LX and a minor axis direction SY perpendicular to an optical axis OA. The major axis direction LX and the minor axis direction SY are two different directions, and an effective radius Ra of the aperture stop ST in the major axis direction LX is larger than an effective radius Rb of the aperture stop ST in the minor axis direction SY.

When an axial distance between the object-side surface of the first lens element and the image-side surface of the fourth lens element is TD, and an axial distance between the image-side surface of the fourth lens element and the image surface is BL, the following condition is satisfied: 0.05<TD/BL<0.60. Therefore, it is favorable for adjusting the back focal length to be an appropriate length to facilitate light path folding. Moreover, the following condition can also be satisfied: 0.10<TD/BL<0.45. Moreover, the following condition can also be satisfied: 0.12<TD/BL<0.35. Moreover, the following condition can also be satisfied: 0.19≤TD/BL≤0.31.

When a focal length of the second lens element is f2, and a focal length of the fourth lens element is f4, the following condition can be satisfied: 0.05<|f2/f4|<1.50. Therefore, it is favorable for balancing the refractive power of the second lens element and the fourth lens element to balance light convergence or divergence and improve the overall focusing quality across the entire field of view. Moreover, the following condition can also be satisfied: 0.15<|f2/f4|<1.25. Moreover, the following condition can also be satisfied: 0.20≤|f2/f4|≤1.14.

When a central thickness of the first lens element is CT1, a central thickness of the second lens element is CT2, and a central thickness of the third lens element is CT3, the following condition can be satisfied: 0.10<(CT2+CT3)/CT1<1.00.

Therefore, it is favorable for balancing the spatial distribution of the central thicknesses of the first lens element, the second lens element and the third lens element to accommodate the manufacturing limitations of the first lens element; additionally, by adjusting the central thicknesses of the second lens element and the third lens element, the size of the photographing optical lens system can be reduced. Moreover, the following condition can also be satisfied: 0.30<(CT2+CT3)/CT1<0.85. Moreover, the following condition can also be satisfied: 0.35<(CT2+CT3)/CT1<0.95. Moreover, the following condition can also be satisfied: 0.48≤(CT2+CT3)/CT1≤0.91.

When a curvature radius of the object-side surface of the first lens element is R1, and a curvature radius of the object-side surface of the third lens element is R5, the following condition can be satisfied: −5.00<(R1−R5)/(R1+R5)<0.50. Therefore, it is favorable for balancing the curvature radii of the object-side surface of the first lens element and the object-side surface of the third lens element to improve the central focusing effect of the imaging. Moreover, the following condition can also be satisfied: −4.50<(R1−R5)/(R1+R5)<0.25. Moreover, the following condition can also be satisfied: −3.50<(R1−R5)/(R1+R5)<−0.30. Moreover, the following condition can also be satisfied: −3.00<(R1-R5)/(R1+R5)<−0.60. Moreover, the following condition can also be satisfied: −2.88≤(R1−R5)/(R1+R5)≤−0.19.

When a refractive index of the first lens element is N1, the following condition can be satisfied: 1.650<N1<2.200. Therefore, it is favorable for adjusting the refractive index of the first lens element to enhance the ability to converge peripheral light, thereby improving imaging contrast and focusing quality. Moreover, the following condition can also be satisfied: 1.750<N1<2.100. Moreover, the following condition can also be satisfied: 1.850<N1<2.000. Moreover, the following condition can also be satisfied: 1.544≤N1≤1.954.

When an Abbe number of the second lens element is V2, the following condition can be satisfied: 10.0<V2<45.0. Therefore, it is favorable for adjusting the material composition of the second lens element to balance the convergence ability of light across different wavelengths. Moreover, the following condition can also be satisfied: 15.0<V2<40.0. Moreover, the following condition can also be satisfied: 20.0<V2<30.0. Moreover, the following condition can also be satisfied: 22.5≤V2≤56.0.

When the central thickness of the second lens element is CT2, and an axial distance between the third lens element and the fourth lens element is T34, the following condition can be satisfied: 0.05<CT2/T34<1.00. Therefore, it is favorable for balancing the central thickness of the second lens element and the distance between the third lens element and the fourth lens element to increase design flexibility and reduce manufacturing tolerances, thereby achieving the goal of a thinner photographing optical lens system. Moreover, the following condition can also be satisfied: 0.20<CT2/T34<0.80. Moreover, the following condition can also be satisfied: 0.39≤CT2/T34≤0.90.

When a focal length of the photographing optical lens system is f, and a focal length of the third lens element is f3, the following condition can be satisfied: −5.00<f/f3<−1.80. Therefore, it is favorable for balancing the light path of the first lens element and correcting systematic spherical aberration to maintain an appropriate back focal length. Moreover, the following condition can also be satisfied: 4.00<f/f3<−2.00.

When the focal length of the photographing optical lens system is f, a curvature radius of the image-side surface of the second lens element is R4, and the curvature radius of the object-side surface of the third lens element is R5, the following condition can be satisfied: 0.05<|f/R4|+|f/R5|<2.80. Therefore, it is favorable for adjusting the total focal length and the curvature radii of the image-side surface of the second lens element and the object-side surface of the third lens element to correct off-axis aberrations and maintain an appropriate back focal length within a limited space configuration. Moreover, the following condition can also be satisfied: 0.30<|f/R4|+|f/R5|<2.60.

When the curvature radius of the image-side surface of the second lens element is R4, and a curvature radius of the image-side surface of the third lens element is R6, the following condition can be satisfied: 0.20<(R4+R6)/(R4−R6)<1.80. Therefore, it is favorable for balancing the curvature radii of the image-side surface of the second lens element and the image-side surface of the third lens element, and adjusting the direction of peripheral light to correct astigmatism and reduce stray light within the photographing optical lens system. Moreover, the following condition can also be satisfied: 0.60<(R4+R6)/(R4−R6)<1.50.

When an f-number of the photographing optical lens system is Fno, the following condition can be satisfied: 1.50<Fno<2.50. Therefore, it is favorable for obtaining a balance between illuminance and depth of field, and enhancing incident light intake to improve image quality. Moreover, the following condition can also be satisfied: 1.80<Fno<2.40. Moreover, the following condition can also be satisfied: 2.00<Fno<2.35.

When half of a maximum field of view of the photographing optical lens system is HFOV, the following condition can be satisfied: 5.0 degrees<HFOV<20.0 degrees. Therefore, it is favorable for the photographing optical lens system to have an appropriate field of view suitable for telephoto applications. Moreover, the following condition can also be satisfied: 8.0 degrees<HFOV<17.0 degrees. Moreover, the following condition can also be satisfied: 10.0 degrees<HFOV<15.0 degrees.

When an axial distance between the aperture stop and the image-side surface of the fourth lens element is SD, and the axial distance between the object-side surface of the first lens element and the image-side surface of the fourth lens element is TD, the following condition can be satisfied: 0.05<SD/TD<0.90. Therefore, it is favorable for controlling the position of the aperture stop and the axial distance between the aperture stop and the image-side surface of the fourth lens element to be smaller than the axial distance from the object-side surface of the first lens element to the image-side surface of the fourth lens element to increase the relative illuminance of the peripheral field of view. Moreover, the following condition can also be satisfied: 0.10<SD/TD<0.88. Moreover, the following condition can also be satisfied: 0.30<SD/TD<0.65.

When an Abbe number of the third lens element is V3, and an Abbe number of the fourth lens element is V4, the following condition can be satisfied: 0.10<V3/V4<0.85. Therefore, it is favorable for adjusting the distribution of lens materials to correct chromatic aberration. Moreover, the following condition can also be satisfied: 0.20<V3/V4<0.50.

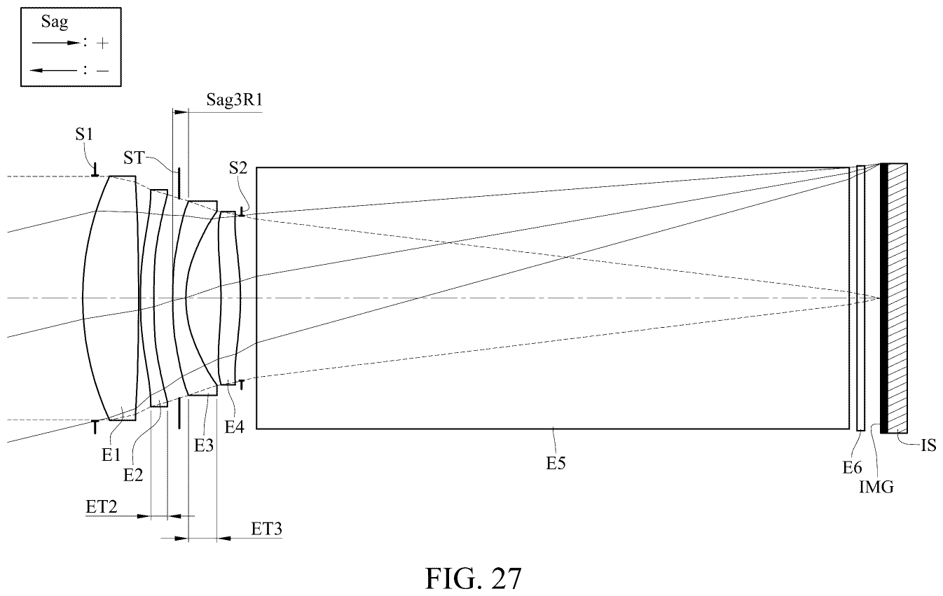

When a displacement in parallel with the optical axis from an axial vertex of the object-side surface of the third lens element to a maximum effective radius position of the object-side surface of the third lens element is Sag3R1, and the central thickness of the third lens element is CT3, the following condition can be satisfied: −0.10<Sag3R1/CT3<0.80. Therefore, it is favorable for the third lens element to have the ability to control the direction of the light beam at its periphery so as to control the incidence angle of light entering the image surface and prevent stray light from being generated after passing through light-folding elements (e.g., reflective elements). Moreover, the following condition can also be satisfied: 0<Sag3R1/CT3<0.75. Please refer to FIG. 27, which shows a schematic view of Sag3R1 according to the 1st embodiment of the present disclosure. When the direction from the axial vertex of one surface to the maximum effective radius position of the same surface is facing towards the image side of the photographing optical lens system, the value of displacement is positive; when the direction from the axial vertex of the surface to the maximum effective radius position of the same surface is facing towards the object side of the photographing optical lens system, the value of displacement is negative.

When a distance in parallel with the optical axis between a maximum effective radius position of the object-side surface of the second lens element and a maximum effective radius position of the image-side surface of the second lens element is ET2, and the central thickness of the second lens element is CT2, the following condition can be satisfied: 0.50<ET2/CT2<1.50. Therefore, it is favorable for adjusting the ratio of the edge thickness to the central thickness of the second lens element to maintain an appropriate edge thickness, thereby improving assembly yield. Moreover, the following condition can also be satisfied: 0.60<ET2/CT2<1.00. Please refer to FIG. 27, which shows a schematic view of ET2 according to the 1st embodiment of the present disclosure.

When an Abbe number of the first lens element is V1, and the Abbe number of the second lens element is V2, the following condition can be satisfied: 0.80<V1/V2<2.00. Therefore, it is favorable for adjusting the material composition of the first lens element and the second lens element to reduce chromatic aberration and improve the issue of purple fringing in peripheral images. Moreover, the following condition can also be satisfied: 0.90<V1/V2<1.80. Moreover, the following condition can also be satisfied: 1.00<V1/V2<1.50.

When the curvature radius of the object-side surface of the first lens element is R1, and the curvature radius of the image-side surface of the second lens element is R4, the following condition can be satisfied: −3.00<(R1+R4)/(R1−R4)<0. Therefore, it is favorable for balancing the curvature radii of the object-side surface of the first lens element and the image-side surface of the second lens element to enhance the focusing quality of the imaging light, improve field curvature, and reduce spherical aberration. Moreover, the following condition can also be satisfied: −2.50<(R1+R4)/(R1−R4)<−0.20.

When the axial distance between the object-side surface of the first lens element and the image-side surface of the fourth lens element is TD, the central thickness of the second lens element is CT2, and an axial distance between the second lens element and the third lens element is T23, the following condition can be satisfied: 4.50<TD/(CT2+T23)<8.00. Therefore, it is favorable for adjusting the lens element distribution and balancing the thickness of the second lens element with the distance between the second lens element and the third lens element to increase spatial utilization efficiency. Moreover, the following condition can also be satisfied: 4.70<TD/(CT2+T23)<7.00.

When a composite focal length of the first lens element and the second lens element is f12, and the focal length of the fourth lens element is f4, the following condition can be satisfied: 0.01<|f12/f4|<0.27. Therefore, it is favorable for balancing the ratio of the composite focal length of the first lens element and the second lens element to the focal length of the fourth lens element to increase systematic symmetry and reduce the spot size in the central field of view. Moreover, the following condition can also be satisfied: 0.05<|f12/f4|<0.26.

When an axial distance between the object-side surface of the first lens element and the image surface is TL, and a maximum image height of the photographing optical lens system (which can be half of a diagonal length of an effective photosensitive area of an image sensor) is ImgH, the following condition can be satisfied: 5.50<TL/ImgH<7.00. Therefore, it is favorable for balancing the total track length of the photographing optical lens system with the image height to reduce the size of lens elements and form a telephoto structure. Moreover, the following condition can also be satisfied: 5.60<TL/ImgH<6.80. Moreover, the following condition can also be satisfied: 5.70<TL/ImgH<6.50.

When the distance in parallel with the optical axis between the maximum effective radius position of the object-side surface of the second lens element and the maximum effective radius position of the image-side surface of the second lens element is ET2, and a distance in parallel with the optical axis between the maximum effective radius position of the object-side surface of the third lens element and a maximum effective radius position of the image-side surface of the third lens element is ET3, the following condition can be satisfied: 0.10<ET2/ET3<0.85. Therefore, it is favorable for balancing the edge thickness of the second lens element with the edge thickness of the third lens element to control the direction of peripheral light to achieve focusing, thereby improving peripheral image quality. Moreover, the following condition can also be satisfied: 0.20<ET2/ET3<0.80. Please refer to FIG. 27, which shows a schematic view of ET2 and ET3 according to the 1st embodiment of the present disclosure.

According to the present disclosure, the aforementioned features and conditions can be utilized in numerous combinations so as to achieve corresponding effects.

According to the present disclosure, the lens elements of the photographing optical lens system can be made of either glass or plastic material. When the lens elements are made of glass material, the refractive power distribution of the photographing optical lens system may be more flexible, and the influence on imaging caused by external environment temperature change may be reduced. The glass lens element can either be made by grinding or molding. When the lens elements are made of plastic material, the manufacturing costs can be effectively reduced. Furthermore, surfaces of each lens element can be arranged to be spherical or aspheric. Spherical lens elements are simple in manufacture. Aspheric lens element design allows more control variables for eliminating aberrations thereof and reducing the required number of lens elements, and the total track length of the photographing optical lens system can therefore be effectively shortened. Additionally, the aspheric surfaces may be formed by plastic injection molding or glass molding.

According to the present disclosure, when a lens surface is aspheric, it means that the lens surface has an aspheric shape throughout its optically effective area, or a portion(s) thereof.

According to the present disclosure, one or more of the lens elements' material may optionally include an additive which generates light absorption and interference effects and alters the lens elements' transmittance in a specific range of wavelength for a reduction in unwanted stray light or color deviation. For example, the additive may optionally filter out light in the wavelength range of 600 nm to 800 nm to reduce excessive red light and/or near infrared light; or may optionally filter out light in the wavelength range of 350 nm to 450 nm to reduce excessive blue light and/or near ultraviolet light from interfering the final image. The additive may be homogeneously mixed with a plastic material to be used in manufacturing a mixed-material lens element by injection molding. Moreover, the additive may be coated on the lens surfaces to provide the abovementioned effects.

According to the present disclosure, each of an object-side surface and an image-side surface has a paraxial region and an off-axis region. The paraxial region refers to the region of the surface where light rays travel close to the optical axis, and the off-axis region refers to the region of the surface away from the paraxial region. Particularly, unless otherwise stated, when the lens element has a convex surface, it indicates that the surface is convex in the paraxial region thereof; when the lens element has a concave surface, it indicates that the surface is concave in the paraxial region thereof. Moreover, when a region of refractive power or focus of a lens element is not defined, it indicates that the region of refractive power or focus of the lens element is in the paraxial region thereof.

According to the present disclosure, an inflection point is a point on the surface of the lens element at which the surface changes from concave to convex, or vice versa. A critical point is a non-axial point of the lens surface where its tangent is perpendicular to the optical axis.

According to the present disclosure, the image surface of the photographing optical lens system, based on the corresponding image sensor, can be flat or curved, especially a curved surface being concave facing towards the object side of the photographing optical lens system.

According to the present disclosure, an image correction unit, such as a field flattener, can be optionally disposed between the lens element closest to the image side of the photographing optical lens system along the optical path and the image surface for correction of aberrations such as field curvature. The optical properties of the image correction unit, such as curvature, thickness, index of refraction, position and surface shape (convex or concave surface with spherical, aspheric, diffractive or Fresnel types), can be adjusted according to the design of the image capturing unit. In general, a preferable image correction unit is, for example, a thin transparent element having a concave object-side surface and a planar image-side surface, and the thin transparent element is disposed near the image surface.

According to the present disclosure, at least one reflective element, such as a prism or a reflective mirror, can be optionally provided, and the surface of the prism or reflective mirror can be planar, spherical, aspheric or have a freeform shape, such that the photographing optical lens system can be more flexible in space arrangement. The reflective element can be disposed between an imaged object and the image surface so as to reduce the size of the photographing optical lens system. The optical path can be deflected at least one time by the reflective element. An angle between the optical axis and a normal direction of a reflective surface of the reflective element is not limited to 45 degrees, but can be other angles depending on the space arrangement. The optical path along an optical axis at the object side can be redirected to an optical axis at the image side by the reflective element. An angle between a vector of the optical axis at the object side and that at the image side can be any angle, not limited to 0, 90 or 180 degrees. In addition, in order to reduce the size of the photographing optical lens system, the length and the width of the reflective mirror may be different from each other, and the length, the width and the height of the prism may be different from one another. The surface of the reflective element (e.g., the surface of the prism or the reflective mirror) can be planar, spherical, aspheric or have a freeform shape according to the optical design requirements, but the present disclosure is not limited thereto. The reflective element can consist of more than one prism depending on the design requirements. The prism can be made of glass material or plastic material depending on the design requirements. In addition, the prism with optical path folding function is not one of the lens elements; that is, the prism with optical path folding function is not included in the four lens elements of the photographing optical lens system.

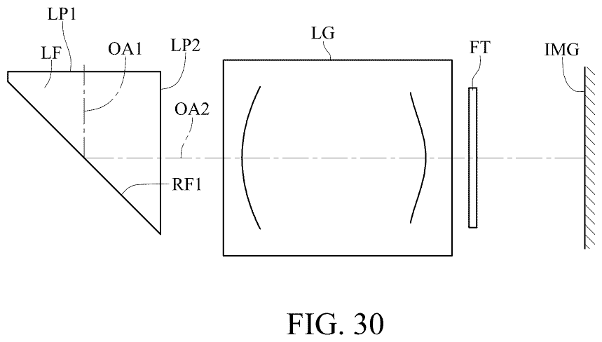

Furthermore, please refer to FIG. 30 through FIG. 32, each of which shows a schematic view of a configuration of one reflective element in a photographing optical lens system according to one embodiment of the present disclosure. As shown in FIG. 30 to FIG. 32, the photographing optical lens system can include, in order from an imaged object (not shown in the figures) to an image surface IMG along a travelling direction of an optical path, a reflective element LF, a lens group LG, a filter FT and the image surface IMG.

In FIG. 30, the reflective element LF is a prism and has, in sequence along a travelling direction of light on the optical path, a first light permeable surface LP1, a reflective surface RF1, and a second light permeable surface LP2. The optical path enters the reflective element LF through the first light permeable surface LP1 and reaches the reflective surface RF1 along a first optical axis OA1. The reflective surface RF1 deflects the optical path from the first optical axis OA1 to a second optical axis OA2, and the optical path then passes through the second light permeable surface LP2, travels through the lens group LG and the filter FT, and ultimately arrives at the image surface IMG along the second optical axis OA2. As shown in FIG. 30, both of the first light permeable surface LP1 and the second light permeable surface LP2 of the reflective element LF can be planar.

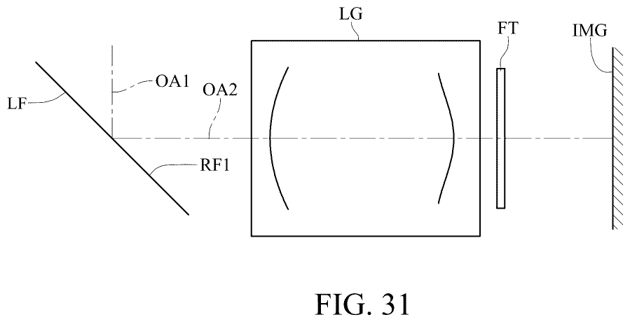

In FIG. 31, the reflective element LF is a flat reflective mirror having a reflective surface RF1. The optical path reaches the reflective surface RF1 along a first optical axis OA1. The reflective surface RF1 deflects the optical path from the first optical axis OA1 to a second optical axis OA2. Subsequently, the optical path travels through the lens group LG and the filter FT, and ultimately arrives at the image surface IMG along the second optical axis OA2.

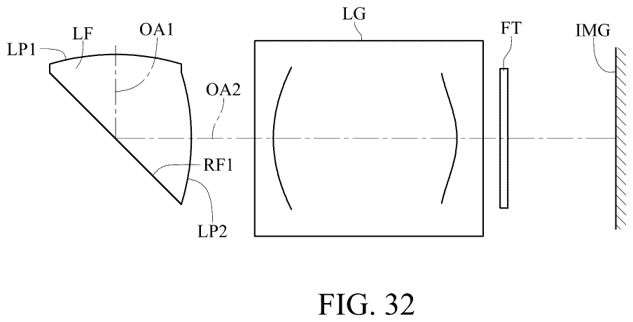

In FIG. 32, the reflective element LF is a prism and has, in sequence along a travelling direction of light on the optical path, a first light permeable surface LP1, a reflective surface RF1, and a second light permeable surface LP2. The optical path enters the reflective element LF through the first light permeable surface LP1 and reaches the reflective surface RF1 along a first optical axis OA1. The reflective surface RF1 deflects the optical path from the first optical axis OA1 to a second optical axis OA2, and the optical path then passes through the second light permeable surface LP2, travels through the lens group LG and the filter FT, and ultimately arrives at the image surface IMG along the second optical axis OA2. As shown in FIG. 32, both of the first light permeable surface LP1 and the second light permeable surface LP2 of the reflective element LF can be curved.

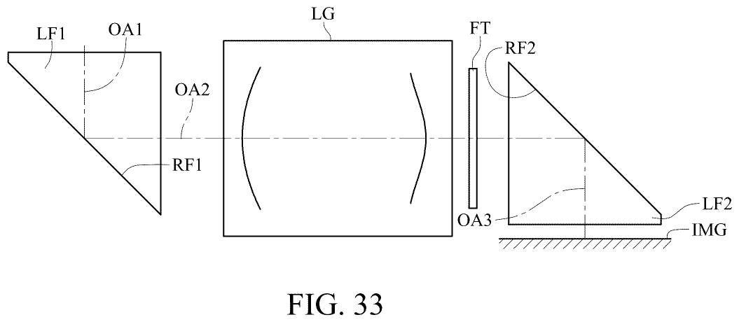

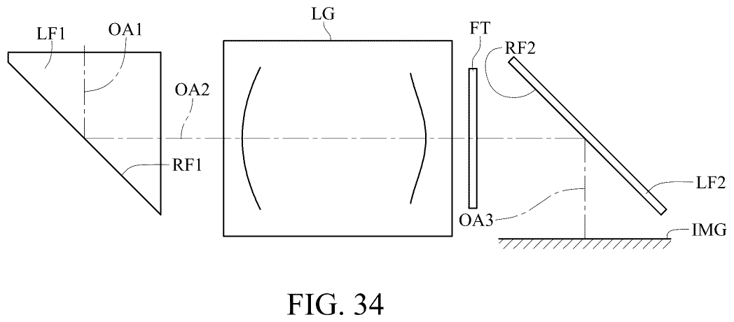

Moreover, please refer to FIG. 33 and FIG. 34, each of which shows a schematic view of a configuration of two reflective elements in a photographing optical lens system according to one embodiment of the present disclosure. As shown in FIG. 33 and FIG. 34, the photographing optical lens system can include, in order from an imaged object (not shown in the figures) to an image surface IMG along a travelling direction of an optical path, a first reflective element LF1, a lens group LG, a filter FT, a second reflective element LF2 and the image surface IMG. The optical path enters the first reflective element LF1 and reaches the first reflective surface RF1 along a first optical axis OA1, and the first reflective surface RF1 deflects the optical path from the first optical axis OA1 to a second optical axis OA2. The optical path travels through the lens group LG and the filter FT along the second optical axis OA2. Subsequently, the optical path enters the second reflective element LF2 and reaches the second reflective surface RF2 along the second optical axis OA2, and the second reflective surface RF2 deflects the optical path from the second optical axis OA2 to a third optical axis OA3. The optical path ultimately arrives at the image surface IMG along the third optical axis OA3. In FIG. 33, each of the first reflective element LF1 and the second reflective element LF2 can be a prism. In FIG. 34, the first reflective element LF1 and the second reflective element LF2 can be a prism and a flat reflective mirror, respectively.

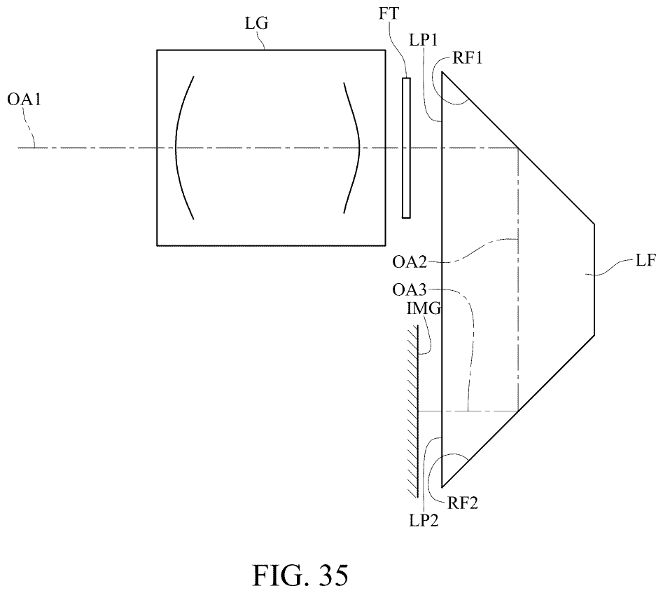

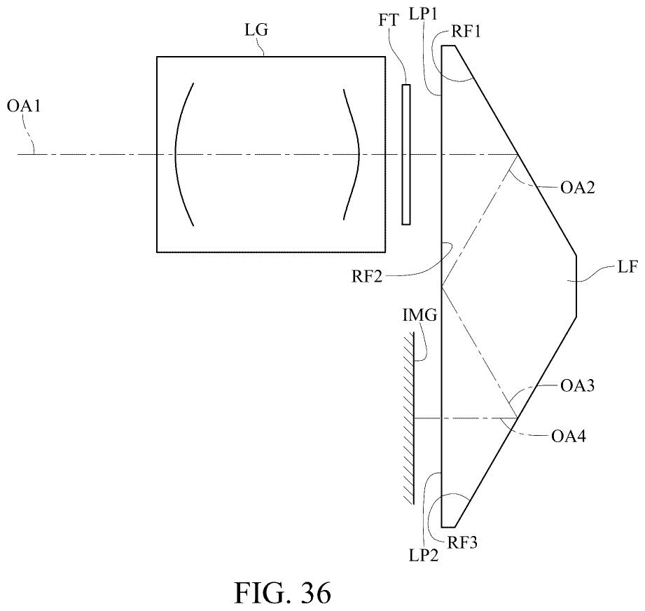

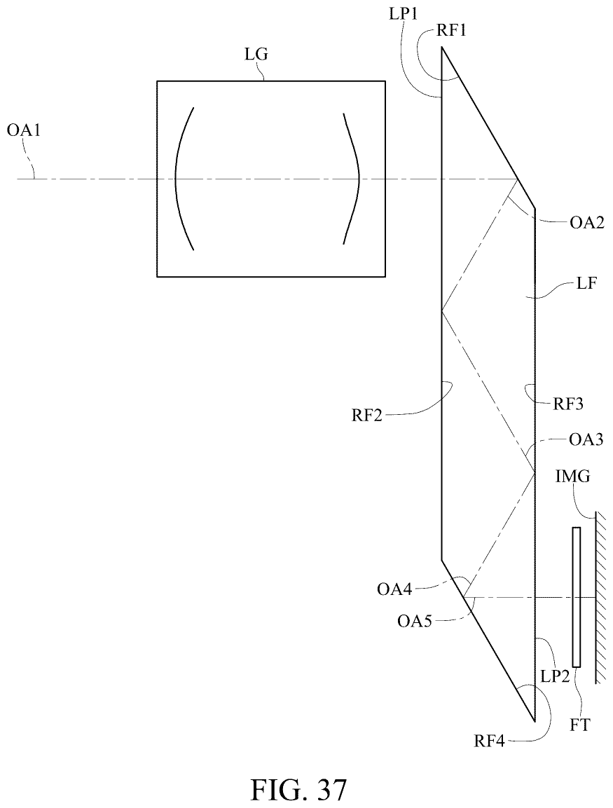

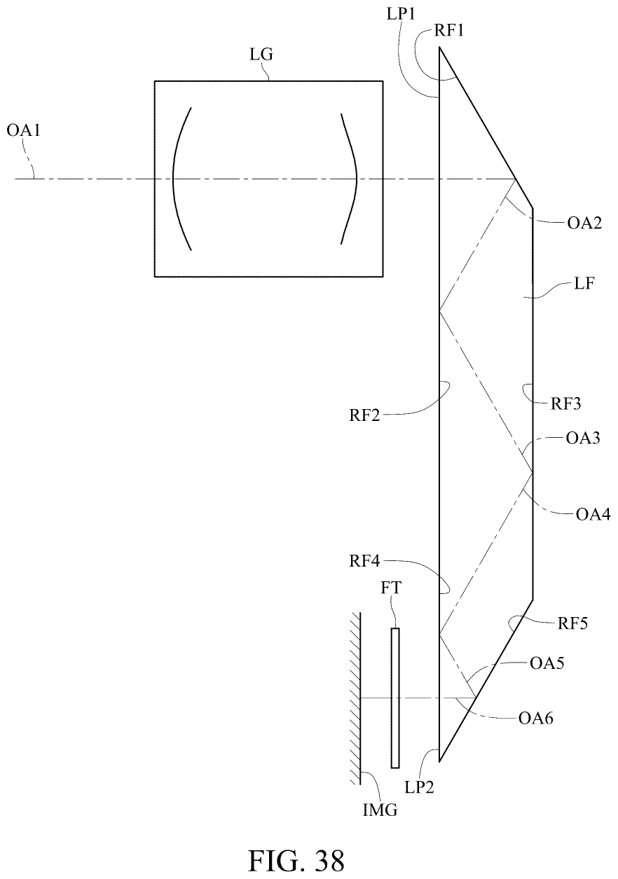

In addition, please refer to FIG. 35 to FIG. 38. FIG. 35 shows a schematic view of a configuration of a double-reflection reflective element in a photographing optical lens system according to one embodiment of the present disclosure, FIG. 36 shows a schematic view of a configuration of a triple-reflection reflective element in a photographing optical lens system according to one embodiment of the present disclosure, FIG. 37 shows a schematic view of a configuration of a quadruple-reflection reflective element in a photographing optical lens system according to one embodiment of the present disclosure, and FIG. 38 shows a schematic view of a configuration of a quintuple-reflection reflective element in a photographing optical lens system according to one embodiment of the present disclosure.

As shown in FIG. 35, the photographing optical lens system can include, in order from an imaged object (not shown in the figures) to an image surface IMG along a travelling direction of an optical path, a lens group LG, a filter FT, a reflective element LF and the image surface IMG. The reflective element LF can be a prism and has, in sequence along a travelling direction of light on the optical path, a first light permeable surface LP1, a first reflective surface RF1, a second reflective surface RF2 and a second light permeable surface LP2. The optical path travels through the lens group LG and the filter FT, enters the reflective element LF through the first light permeable surface LP1, and reaches the first reflective surface RF1 along a first optical axis OA1. The first reflective surface RF1 deflects the optical path from the first optical axis OA1 to a second optical axis OA2, the second reflective surface RF2 deflects the optical path from the second optical axis OA2 to a third optical axis OA3, and then the optical path passes through the second light permeable surface LP2 and ultimately arrives at the image surface IMG along the third optical axis OA3.

As shown in FIG. 36, the photographing optical lens system can include, in order from an imaged object (not shown in the figures) to an image surface IMG along a travelling direction of an optical path, a lens group LG, a filter FT, a reflective element LF and the image surface IMG. The reflective element LF can be a prism and has, in sequence along a travelling direction of light on the optical path, a first light permeable surface LP1, a first reflective surface RF1, a second reflective surface RF2, a third reflective surface RF3 and a second light permeable surface LP2. The optical path travels through the lens group LG and the filter FT, enters the reflective element LF through the first light permeable surface LP1 and reaches the first reflective surface RF1 along a first optical axis OA1. The first reflective surface RF1 deflects the optical path from the first optical axis OA1 to a second optical axis OA2, the second reflective surface RF2 deflects the optical path from the second optical axis OA2 to a third optical axis OA3, the third reflective surface RF3 deflects the optical path from the third optical axis OA3 to a fourth optical axis OA4, and then the optical path passes through the second light permeable surface LP2 and ultimately arrives at the image surface IMG along the fourth optical axis OA4. Moreover, the first light permeable surface LP1 and the second reflective surface RF2 can be coplanar.

As shown in FIG. 37, the photographing optical lens system can include, in order from an imaged object (not shown in the figures) to an image surface IMG along a travelling direction of an optical path, a lens group LG, a reflective element LF, a filter FT and the image surface IMG. The reflective element LF can be a prism and has, in sequence along a travelling direction of light on the optical path, a first light permeable surface LP1, a first reflective surface RF1, a second reflective surface RF2, a third reflective surface RF3, a fourth reflective surface RF4 and a second light permeable surface LP2. The optical path travels through the lens group LG, enters the reflective element LF through the first light permeable surface LP1 and reaches the first reflective surface RF1 along a first optical axis OA1. The first reflective surface RF1 deflects the optical path from the first optical axis OA1 to a second optical axis OA2, the second reflective surface RF2 deflects the optical path from the second optical axis OA2 to a third optical axis OA3, the third reflective surface RF3 deflects the optical path from the third optical axis OA3 to a fourth optical axis OA4, the fourth reflective surface RF4 deflects the optical path from the fourth optical axis OA4 to a fifth optical axis OA5. Subsequently, the optical path passes through the second light permeable surface LP2, travels through the filter FT, and ultimately arrives at the image surface IMG along the fifth optical axis OA5. Moreover, the first light permeable surface LP1 and the second reflective surface RF2 can be coplanar.

As shown in FIG. 38, the photographing optical lens system can include, in order from an imaged object (not shown in the figures) to an image surface IMG along a travelling direction of an optical path, a lens group LG, a reflective element LF, a filter FT and an image surface IMG. The reflective element LF can be a prism and has, in sequence along a travelling direction of light on the optical path, a first light permeable surface LP1, a first reflective surface RF1, a second reflective surface RF2, a third reflective surface RF3, a fourth reflective surface RF4, a fifth reflective surface RF5 and a second light permeable surface LP2. The optical path travels through the lens group LG, enters the reflective element LF through the first light permeable surface LP1 and reaches the first reflective surface RF1 along a first optical axis OA1. The first reflective surface RF1 deflects the optical path from the first optical axis OA1 to a second optical axis OA2, the second reflective surface RF2 deflects the optical path from the second optical axis OA2 to a third optical axis OA3, the third reflective surface RF3 deflects the optical path from the third optical axis OA3 to a fourth optical axis OA4, the fourth reflective surface RF4 deflects the optical path from the fourth optical axis OA4 to a fifth optical axis OA5, and the fifth reflective surface RF5 deflects the optical path from the fifth optical axis OA5 to a sixth optical axis OA6. Subsequently, the optical path passes through the second light permeable surface LP2, travels through the filter FT, and ultimately arrives at the image surface IMG along the sixth optical axis OA6. Moreover, the first light permeable surface LP1 and the second reflective surface RF2 can be coplanar.

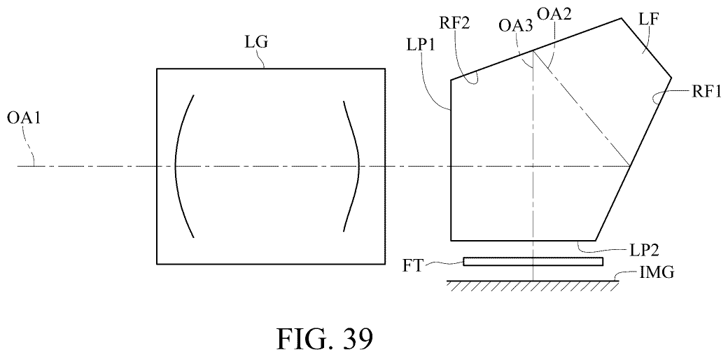

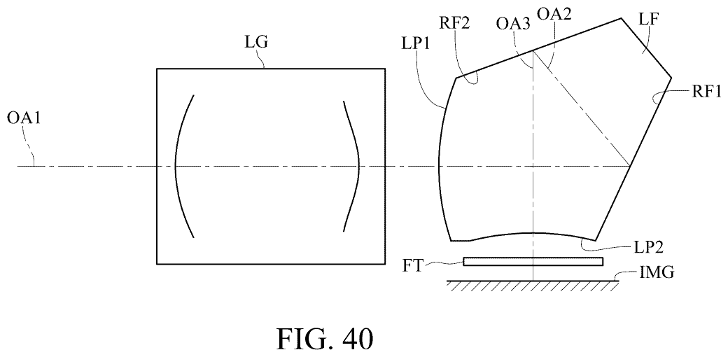

Moreover, please refer to FIG. 39 and FIG. 40. FIG. 39 shows a schematic view of a configuration of one reflective element in a photographing optical lens system according to one embodiment of the present disclosure, and FIG. 40 shows a schematic view of a configuration of another reflective element in a photographing optical lens system according to one embodiment of the present disclosure. As shown in FIG. 39 and FIG. 40, the photographing optical lens system can include, in order from an imaged object (not shown in the figures) to an image surface IMG along a travelling direction of an optical path, a lens group LG, a reflective element LF, a filter FT and the image surface IMG. The reflective element LF can be a pentaprism and has, in sequence along a travelling direction of light on the optical path, a first light permeable surface LP1, a first reflective surface RF1, a second reflective surface RF2 and a second light permeable surface LP2. The optical path enters the reflective element LF through the first light permeable surface LP1 and reaches the first reflective surface RF1 along a first optical axis OA1. The first reflective surface RF1 deflects the optical path from the first optical axis OA1 to a second optical axis OA2, and the second reflective surface RF2 deflects the optical path from the second optical axis OA2 to a third optical axis OA3. Subsequently, the optical path passes through the second light permeable surface LP2, then travels through the filter FT, and ultimately arrives at the image surface IMG along the third optical axis OA3. In FIG. 39, both of the first light permeable surface LP1 and the second light permeable surface LP2 can be planar. In FIG. 40, both of the first light permeable surface LP1 and the second light permeable surface LP2 can be curved. Furthermore, as shown in FIG. 39 and FIG. 40, the first optical axis OA1 and third optical axis OA3 can intersect and be perpendicular to each other.

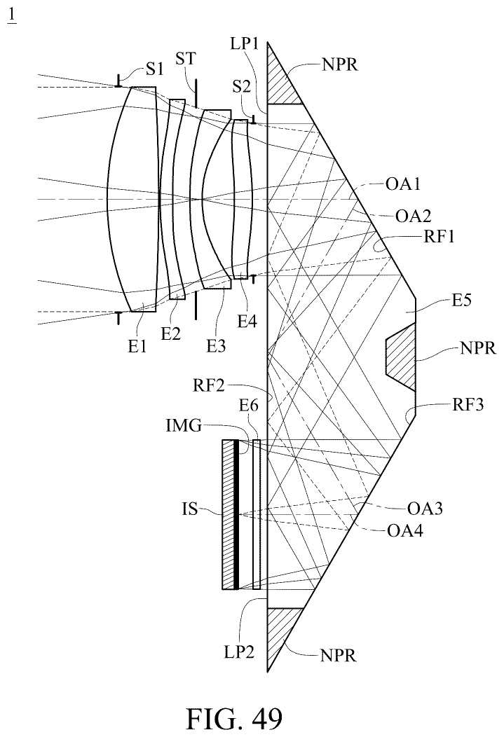

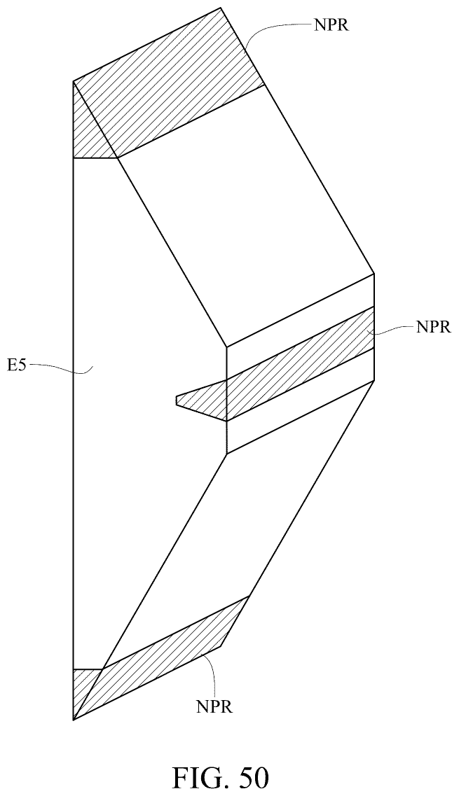

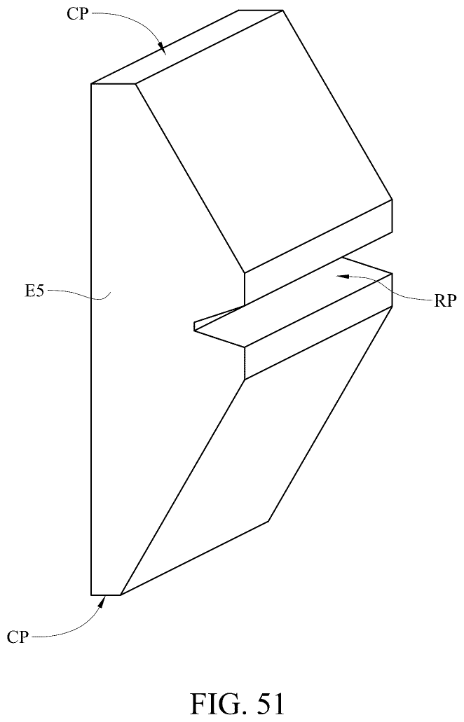

Furthermore, in order to reduce the size of the photographing optical lens system, the length and the width of the reflective mirror may be different from each other, the length, the width and the height of the prism may also be different from one another, and the prism can have at least one trimmed edge or at least one recess at its optically non-effective area so as to reduce its weight and size and to be configured in accordance with other components in the electronic device. Moreover, a light absorbing layer can be coated on the surface in the recess so as to prevent light reflection and block stray light. Please refer to FIG. 49 through FIG. 51, where FIG. 49 shows a schematic view of a configuration of a reflective element in the photographing optical lens system of the image capturing unit according to the 1st embodiment, FIG. 50 shows a perspective view of the reflective element from FIG. 49 before forming trimmed edges and a recess, and FIG. 51 shows a perspective view of the reflective element from FIG. 49 after forming trimmed edges and recess. As shown in FIG. 49 and FIG. 50, the reflective element E5 has optically non-effective areas NPR; that is, imaging light does not pass through the optically non-effective areas NPR in the reflective element E5. Therefore, in design, the parts of the reflective element E5 that correspond to the optically non-effective areas NPR as shown in FIG. 49 and FIG. 50 can be removed, and thus, the reflective element E5 can be formed with trimmed edges CP and a recess RP (as shown in FIG. 51).

The photographing optical lens system can be optionally provided with three or more reflective elements, and the present disclosure is not limited to the type, number and position of the reflective elements of the embodiments as disclosed in the aforementioned figures.

According to the present disclosure, the photographing optical lens system can include at least one stop, such as an aperture stop, a glare stop or a field stop. Said glare stop or said field stop is set for eliminating the stray light and thereby improving image quality thereof.

According to the present disclosure, an aperture stop can be configured as a front stop or a middle stop. A front stop disposed between an imaged object and the first lens element can provide a longer distance between an exit pupil of the photographing optical lens system and the image surface to produce a telecentric effect, and thereby improves the image-sensing efficiency of an image sensor (for example, CCD or CMOS). A middle stop disposed between the first lens element and the image surface is favorable for enlarging the viewing angle of the photographing optical lens system and thereby provides a wider field of view for the same.

According to the present disclosure, the photographing optical lens system can include an aperture control unit. The aperture control unit may be a mechanical component or a light modulator, which can control the size and shape of the aperture through electricity or electrical signals. The mechanical component can include a movable member, such as a blade assembly or a light shielding sheet. The light modulator can include a shielding element, such as a filter, an electrochromic material or a liquid-crystal layer. The aperture control unit controls the amount of incident light or exposure time to enhance the capability of image quality adjustment. In addition, the aperture control unit can be the aperture stop of the present disclosure, which changes the f-number to obtain different image effects, such as the depth of field or lens speed.

According to the present disclosure, the photographing optical lens system can include one or more optical elements for limiting the form of light passing through the photographing optical lens system. Each optical element can be, but not limited to, a filter, a polarizer, etc., and each optical element can be, but not limited to, a single-piece element, a composite component, a thin film, etc. The optical element can be located at the object side or the image side of the photographing optical lens system or between any two adjacent lens elements so as to allow light in a specific form to pass through, thereby meeting application requirements.

According to the present disclosure, the photographing optical lens system can include at least one optical lens element, an optical element, or a carrier, which has at least one surface with a low reflection layer. The low reflection layer can effectively reduce stray light generated due to light reflection at the interface. The low reflection layer can be disposed in an optical non-effective area of an object-side surface or an image-side surface of the said optical lens element, or a connection surface between the object-side surface and the image-side surface. The said optical element can be a light-blocking element, an annular spacer, a barrel element, a cover glass, a blue glass, a filter, a color filter, an optical path folding element (e.g., a reflective element), a prism, a mirror, etc. The said carrier can be a base for supporting a lens assembly, a micro lens disposed on an image sensor, a substrate surrounding the image sensor, a glass plate for protecting the image sensor, etc.

According to the present disclosure, the object side and image side are defined in accordance with the direction of the optical axis, and the axial optical data are calculated along the optical axis. Furthermore, if the optical axis is deflected by a light-folding element, the axial optical data are also calculated along the deflected optical axis.

According to the above description of the present disclosure, the following specific embodiments are provided for further explanation.

### 1st Embodiment

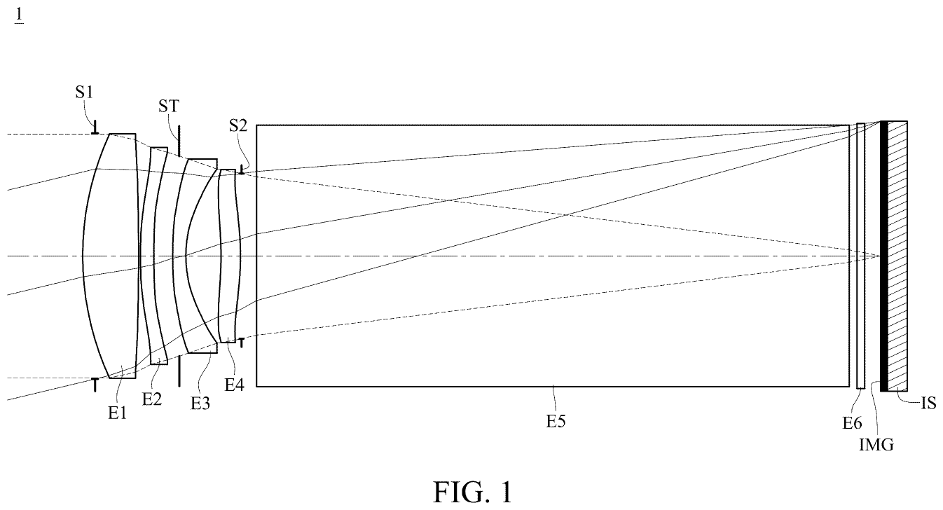

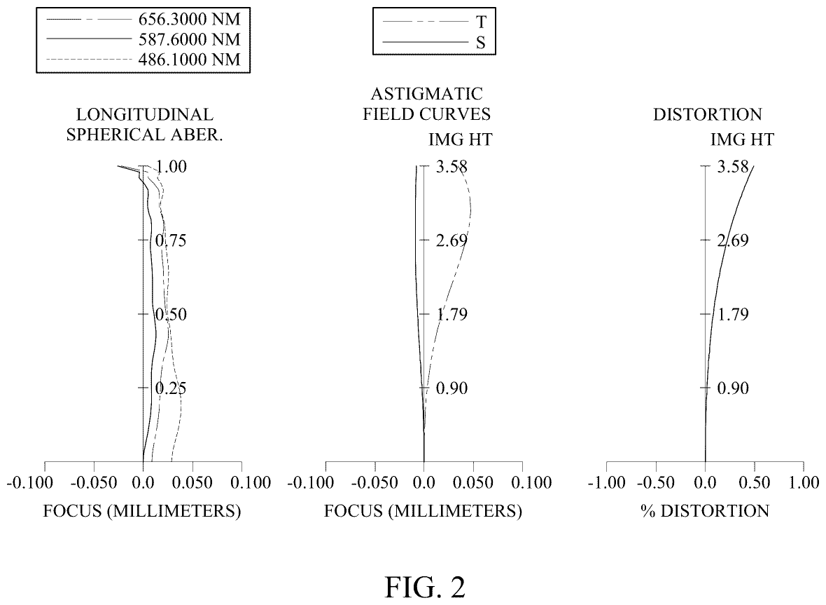

FIG. 1 is a schematic view of an image capturing unit according to the 1st embodiment of the present disclosure. FIG. 2 shows, in order from left to right, spherical aberration curves, astigmatic field curves and a distortion curve of the image capturing unit according to the 1st embodiment. In FIG. 1, the image capturing unit 1 includes the photographing optical lens system (its reference numeral is omitted) of the present disclosure and an image sensor IS. The photographing optical lens system includes, in order from an object side to an image side along an optical path, a stop S1, a first lens element E1, a second lens element E2, an aperture stop ST, a third lens element E3, a fourth lens element E4, a stop S2, a reflective element E5, a filter E6 and an image surface IMG. The photographing optical lens system includes four lens elements (E1, E2, E3 and E4) with no additional lens element disposed between each of the adjacent four lens elements.

The first lens element E1 with positive refractive power has an object-side surface being convex in a paraxial region thereof and an image-side surface being convex in a paraxial region thereof. The first lens element E1 is made of glass material and has the object-side surface and the image-side surface being both spherical.

The second lens element E2 with positive refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has two inflection points. The image-side surface of the second lens element E2 has two inflection points. The object-side surface of the second lens element E2 has one concave critical point in an off-axis region thereof.

The third lens element E3 with negative refractive power has an object-side surface being convex in a paraxial region thereof and an image-side surface being concave in a paraxial region thereof. The third lens element E3 is made of plastic material and has the object-side surface and the image-side surface being both aspheric. The image-side surface of the third lens element E3 has one inflection point.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has one inflection point. The object-side surface of the fourth lens element E4 has one convex critical point in an off-axis region thereof. The image-side surface of the fourth lens element E4 has one concave critical point in an off-axis region thereof.

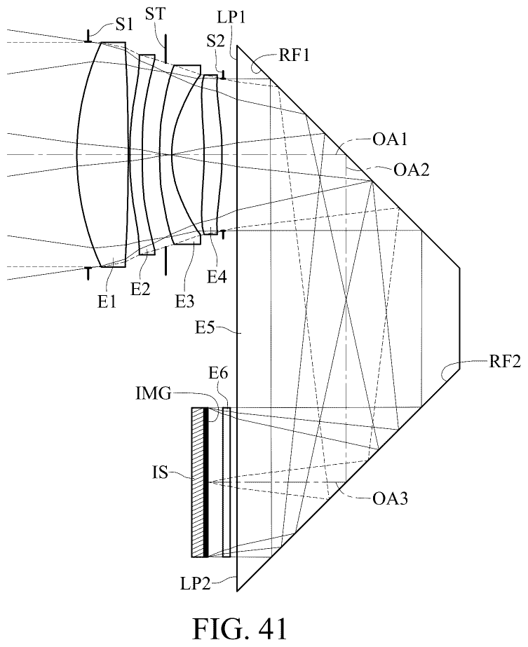

The reflective element E5 is made of glass material and located between the fourth lens element E4 and the image surface IMG along the optical axis, and will not affect the focal length of the photographing optical lens system. The reflective element E5 is a prism configured with a function to fold the optical path. For simplicity in illustration, FIG. 1 does not show the deflection effect caused by the reflective element E5 on the optical path. However, the reflective element E5 can have various configurations depending on actual design requirements, thereby causing different deflection effects on the optical path. For example, please refer to FIG. 41 through FIG. 47, each of which shows a schematic view of a configuration of a reflective element and its associated light path deflection in the image capturing unit according to the 1st embodiment.

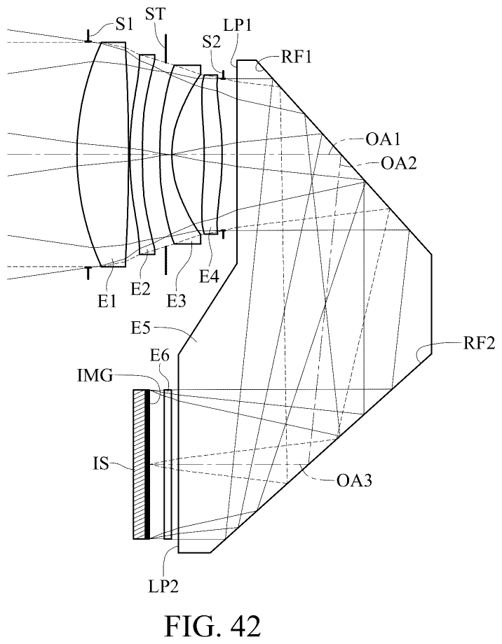

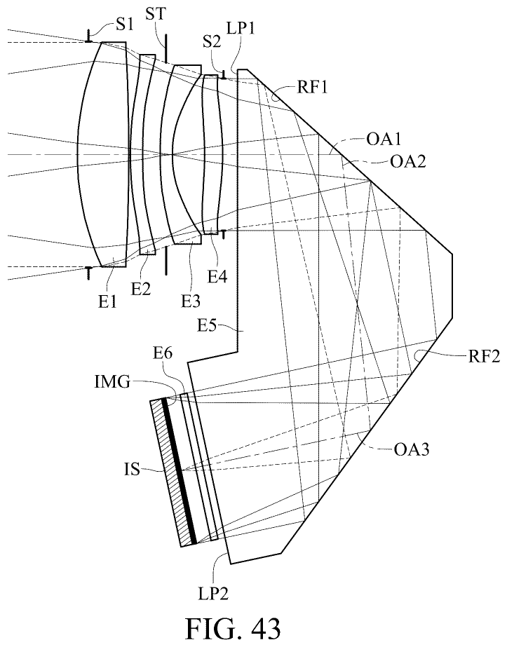

In FIG. 41 to FIG. 43, the reflective element E5 has, in sequence along a travelling direction of light on the optical path, a first light permeable surface LP1, a first reflective surface RF1, a second reflective surface RF2 and a second light permeable surface LP2. The first reflective surface RF1 deflects the optical path from a first optical axis OA1 to a second optical axis OA2, the second reflective surface RF2 deflects the optical path from the second optical axis OA2 to a third optical axis OA3, and then the optical path arrives at the image surface IMG along the third optical axis OA3. In FIG. 41 to FIG. 43, the reflective element E5 deflects the optical path two times. Moreover, FIG. 41 shows a configuration where the first light permeable surface LP1 and the second light permeable surface LP2 are coplanar, a normal direction of the first reflective surface RF1 can be at an angle of 45.0 degrees to both the first optical axis OA1 and the second optical axis OA2, and a normal direction of the second reflective surface RF2 can be at an angle of 45.0 degrees to both the second optical axis OA2 and the third optical axis OA3, such that an angle between a vector of the optical axis at the object side (e.g., the first optical axis OA1) and a vector of the optical axis at the image side (e.g., the third optical axis OA3) can be 180 degrees. FIG. 42 shows a configuration where the first light permeable surface LP1 and the second light permeable surface LP2 are parallel to each other and non-coplanar, a normal direction of the first reflective surface RF1 can be at an angle of 42.0 degrees to both the first optical axis OA1 and the second optical axis OA2, and a normal direction of the second reflective surface RF2 can be at an angle of 48.0 degrees to both the second optical axis OA2 and the third optical axis OA3, such that an angle between a vector of the optical axis at the object side (e.g., the first optical axis OA1) and a vector of the optical axis at the image side (e.g., the third optical axis OA3) can be 180 degrees. FIG. 43 shows a configuration where the first light permeable surface LP1 and the second light permeable surface LP2 are non-parallel to each other and non-coplanar, a normal direction of the first reflective surface RF1 can be at an angle of 47.0 degrees to both the first optical axis OA1 and the second optical axis OA2, and a normal direction of the second reflective surface RF2 can be at an angle of 55.6 degrees to both the second optical axis OA2 and the third optical axis OA3, such that an angle between a vector of the optical axis at the object side (e.g., the first optical axis OA1) and a vector of the optical axis at the image side (e.g., the third optical axis OA3) can be an obtuse angle.

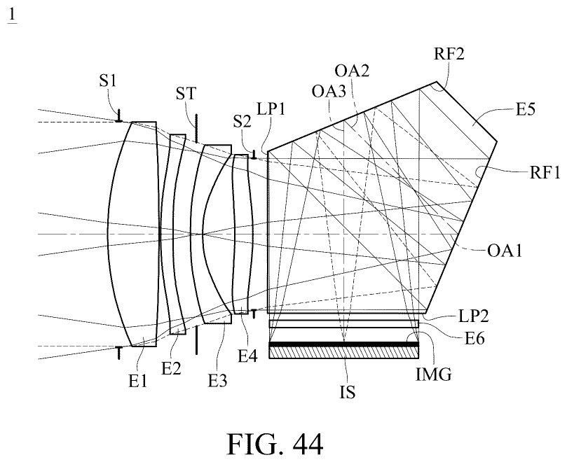

In FIG. 44, the reflective element E5 is a pentaprism and has, in sequence along a travelling direction of light on the optical path, a first light permeable surface LP1, a first reflective surface RF1, a second reflective surface RF2 and a second light permeable surface LP2. The first reflective surface RF1 deflects the optical path from a first optical axis OA1 to a second optical axis OA2, the second reflective surface RF2 deflects the optical path from the second optical axis OA2 to a third optical axis OA3, and then the optical path arrives at the image surface IMG along the third optical axis OA3. In FIG. 44, the reflective element E5 deflects the optical path two times, a normal direction of the first reflective surface RF1 can be at an angle of 23.5 degrees to both the first optical axis OA1 and the second optical axis OA2, and a normal direction of the second reflective surface RF2 can be at an angle of 21.5 degrees to both the second optical axis OA2 and the third optical axis OA3, such that an angle between a vector of the optical axis at the object side (e.g., the first optical axis OA1) and a vector of the optical axis at the image side (e.g., the third optical axis OA3) can be 90 degrees.

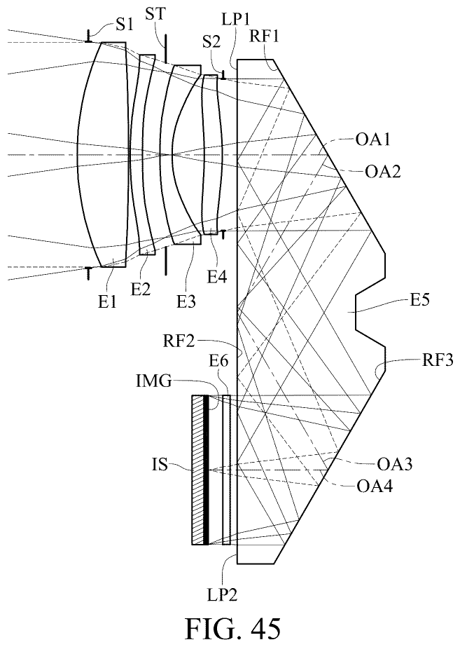

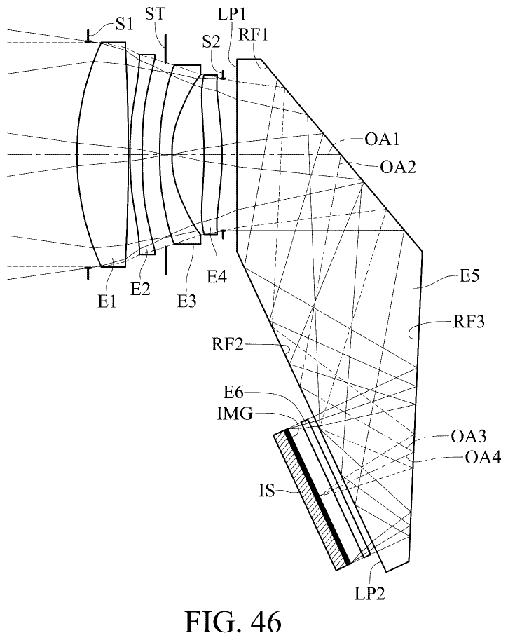

In FIG. 45 and FIG. 46, the reflective element E5 has, in sequence along a travelling direction of light on the optical path, a first light permeable surface LP1, a first reflective surface RF1, a second reflective surface RF2, a third reflective surface RF3 and a second light permeable surface LP2. The first reflective surface RF1 deflects the optical path from a first optical axis OA1 to a second optical axis OA2, the second reflective surface RF2 deflects the optical path from the second optical axis OA2 to a third optical axis OA3, the third reflective surface RF3 deflects the optical path from the third optical axis OA3 to a fourth optical axis OA4, and then the optical path arrives at the image surface IMG along the fourth optical axis OA4. In FIG. 45 and FIG. 46, the reflective element E5 deflects the optical path three times. Moreover, FIG. 45 shows a configuration where the first light permeable surface LP1, the second reflective surface RF2 and the second light permeable surface LP2 are coplanar, a normal direction of the first reflective surface RF1 can be at an angle of 30.0 degrees to both the first optical axis OA1 and the second optical axis OA2, a normal direction of the second reflective surface RF2 can be at an angle of 60.0 degrees to both the second optical axis OA2 and the third optical axis OA3, and a normal direction of the third reflective surface RF3 can be at an angle of 30.0 degrees to both the third optical axis OA3 and the fourth optical axis OA4, such that an angle between a vector of the optical axis at the object side (e.g., the first optical axis OA1) and a vector of the optical axis at the image side (e.g., the fourth optical axis OA4) can be 180 degrees. FIG. 46 shows a configuration where the first light permeable surface LP1 and the second light permeable surface LP2 are non-parallel to each other and non-coplanar, a normal direction of the first reflective surface RF1 can be at an angle of 40.0 degrees to both the first optical axis OA1 and the second optical axis OA2, a normal direction of the second reflective surface RF2 can be at an angle of 55.0 degrees to both the second optical axis OA2 and the third optical axis OA3, and a normal direction of the third reflective surface RF3 can be at an angle of 27.5 degrees to both the third optical axis OA3 and the fourth optical axis OA4, such that an angle between a vector of the optical axis at the object side (e.g., the first optical axis OA1) and a vector of the optical axis at the image side (e.g., the fourth optical axis OA4) can be an obtuse angle.

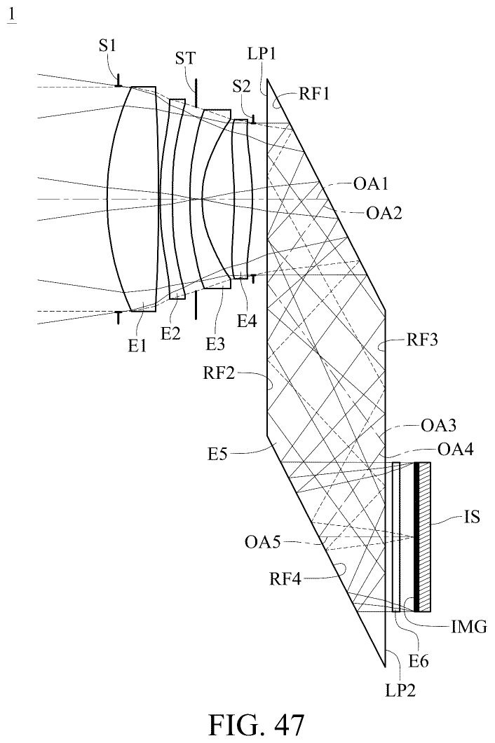

In FIG. 47, the reflective element E5 has, in sequence along a travelling direction of light on the optical path, a first light permeable surface LP1, a first reflective surface RF1, a second reflective surface RF2, a third reflective surface RF3, a fourth reflective surface RF4 and a second light permeable surface LP2. The first reflective surface RF1 deflects the optical path from a first optical axis OA1 to a second optical axis OA2, the second reflective surface RF2 deflects the optical path from the second optical axis OA2 to a third optical axis OA3, the third reflective surface RF3 deflects the optical path from the third optical axis OA3 to a fourth optical axis OA4, the fourth reflective surface RF4 deflects the optical path from the fourth optical axis OA4 to a fifth optical axis OA5, and the optical path arrives at the image surface IMG along the fifth optical axis OA5. In FIG. 47, the reflective element E5 deflects the optical path four times. A normal direction of the first reflective surface RF1 can be at an angle of 28.0 degrees to both the first optical axis OA1 and the second optical axis OA2, a normal direction of the second reflective surface RF2 can be at an angle of 56.0 degrees to both the second optical axis OA2 and the third optical axis OA3, a normal direction of the third reflective surface RF3 can be at an angle of 56.0 degrees to both the third optical axis OA3 and the fourth optical axis OA4, and a normal direction of the fourth reflective surface RF4 can be at an angle of 28.0 degrees to both the fourth optical axis OA4 and the fifth optical axis OA5, such that an angle between a vector of the optical axis at the object side (e.g., the first optical axis OA1) and a vector of the optical axis at the image side (e.g., the fifth optical axis OA5) can be 0 degree. Furthermore, the reflective element E5 in the 1st embodiment can have a configuration similar to that shown in FIG. 38, which deflects the optical path five times. Further details on this can be found in the descriptions corresponding to FIG. 38 and will not be repeated here.

The filter E6 is made of glass material and located between the reflective element E5 and the image surface IMG, and will not affect the focal length of the photographing optical lens system. The image sensor IS is disposed on or near the image surface IMG of the photographing optical lens system.

The equation of the aspheric surface profiles of the aforementioned lens elements of the 1st embodiment is expressed as follows:

$$X ( Y ) = ( {Y}^{2} / R ) / ( 1 + s q r t ( 1 - ( 1 + k ) \times {( Y / R )}^{2} ) ) + {\sum }_{i} ( Ai ) \times ( {Y}^{i} ) ,$$

where,
X is the displacement in parallel with an optical axis from an axial vertex on the aspheric surface to a point at a distance of Y from the optical axis on the aspheric surface;
Y is the vertical distance from the point on the aspheric surface to the optical axis;
R is the curvature radius;
k is the conic coefficient; and
Ai is the i-th aspheric coefficient, and in the embodiments, i may be, but is not limited to, 4, 6, 8, 10, 12, 14, 16, 18, 20, 22, 24, 26 and 28.

In the photographing optical lens system of the image capturing unit 1 according to the 1st embodiment, when a focal length of the photographing optical lens system is f, an f-number of the photographing optical lens system is Fno, and half of a maximum field of view of the photographing optical lens system is HFOV, these parameters have the following values: f=14.74 millimeters (mm), Fno=2.28, and HFOV=13.6 degrees (deg.).

When an axial distance between the object-side surface of the first lens element E1 and the image surface IMG is TL, and a maximum image height of the photographing optical lens system is ImgH, the following condition is satisfied: TL/ImgH=5.92.

When an axial distance between the object-side surface of the first lens element E1 and the image-side surface of the fourth lens element E4 is TD, and an axial distance between the image-side surface of the fourth lens element E4 and the image surface IMG is BL, the following condition is satisfied: TD/BL=0.25.

When an axial distance between the aperture stop ST and the image-side surface of the fourth lens element E4 is SD, and the axial distance between the object-side surface of the first lens element E1 and the image-side surface of the fourth lens element E4 is TD, the following condition is satisfied: SD/TD=0.39.

When the focal length of the photographing optical lens system is f, and a focal length of the third lens element E3 is f3, the following condition is satisfied: f/f3=−2.26.

When a focal length of the second lens element E2 is f2, and a focal length of the fourth lens element E4 is f4, the following condition is satisfied: |f2/f4|=0.43.

When a composite focal length of the first lens element E1 and the second lens element E2 is f12, and the focal length of the fourth lens element E4 is f4, the following condition is satisfied: |f12/f4|=0.10.

When the focal length of the photographing optical lens system is f, a curvature radius of the image-side surface of the second lens element E2 is R4, and a curvature radius of the object-side surface of the third lens element E3 is R5, the following condition is satisfied: |f/R4|+|f/R5|=1.60.

When a curvature radius of the object-side surface of the first lens element E1 is R1, and the curvature radius of the image-side surface of the second lens element E2 is R4, the following condition is satisfied: (R1+R4)/(R1−R4)=−2.06.

When the curvature radius of the object-side surface of the first lens element E1 is R1, and the curvature radius of the object-side surface of the third lens element E3 is R5, the following condition is satisfied: (R1−R5)/(R1+R5)=−0.33.

When the curvature radius of the image-side surface of the second lens element E2 is R4, and a curvature radius of the image-side surface of the third lens element E3 is R6, the following condition is satisfied: (R4+R6)/(R4−R6)=1.36.

When the axial distance between the object-side surface of the first lens element E1 and the image-side surface of the fourth lens element E4 is TD, a central thickness of the second lens element E2 is CT2, and an axial distance between the second lens element E2 and the third lens element E3 is T23, the following condition is satisfied: TD/(CT2+T23)=4.86. In this embodiment, an axial distance between two adjacent lens elements is a distance in a paraxial region between two adjacent lens surfaces of the two adjacent lens elements.

When a central thickness of the first lens element E1 is CT1, the central thickness of the second lens element E2 is CT2, and a central thickness of the third lens element E3 is CT3, the following condition is satisfied: (CT2+CT3)/CT1=0.48.

When the central thickness of the second lens element E2 is CT2, and an axial distance between the third lens element E3 and the fourth lens element E4 is T34, the following condition is satisfied: CT2/T34=0.39.

When a refractive index of the first lens element E1 is N1, the following condition is satisfied: N1=1.911.

When an Abbe number of the second lens element E2 is V2, the following condition is satisfied: V2=25.6.

When an Abbe number of the first lens element E1 is V1, and the Abbe number of the second lens element E2 is V2, the following condition is satisfied: V1/V2=1.38.

When an Abbe number of the third lens element E3 is V3, and an Abbe number of the fourth lens element E4 is V4, the following condition is satisfied: V3/V4=0.33.

When a distance in parallel with the optical axis between a maximum effective radius position of the object-side surface of the second lens element E2 and a maximum effective radius position of the image-side surface of the second lens element E2 is ET2, and the central thickness of the second lens element E2 is CT2, the following condition is satisfied: ET2/CT2=1.23.

When the distance in parallel with the optical axis between the maximum effective radius position of the object-side surface of the second lens element E2 and the maximum effective radius position of the image-side surface of the second lens element E2 is ET2, and a distance in parallel with the optical axis between a maximum effective radius position of the object-side surface of the third lens element E3 and a maximum effective radius position of the image-side surface of the third lens element E3 is ET3, the following condition is satisfied: ET2/ET3=0.58.

When a displacement in parallel with the optical axis from an axial vertex of the object-side surface of the third lens element E3 to the maximum effective radius position of the object-side surface of the third lens element E3 is Sag3R1, and the central thickness of the third lens element E3 is CT3, the following condition is satisfied: Sag3R1/CT3=1.19. In this embodiment, the direction of Sag3R1 points toward the image side of the photographing optical lens system, and the value of Sag3R1 is positive.

The detailed optical data of the 1st embodiment are shown in Table 1A and the aspheric surface data are shown in Table 1B below.

TABLE 1A
1st Embodiment
f = 14.74 mm, Fno = 2.28, HFOV = 13.6 deg.

| Surface # | | Curvature Radius | | Thickness | Material | Index | Abbe # | Focal Length |
|---|---|---|---|---|---|---|---|---|
| 0 | Object | Plano | | Infinity | | | | |
| 1 | Stop | Plano | | −0.326 | | | | |
| 2 | Lens 1 | 7.7757 | (SPH) | 1.490 | Glass | 1.911 | 35.3 | 7.57 |
| 3 | | −55.5556 | (SPH) | 0.040 | | | | |
| 4 | Lens 2 | 9.1159 | (ASP) | 0.360 | Plastic | 1.614 | 25.6 | 24.79 |
| 5 | | 22.4045 | (ASP) | 0.675 | | | | |
| 6 | Ape. Stop | Plano | | −0.173 | | | | |
| 7 | Lens 3 | 15.5768 | (ASP) | 0.350 | Plastic | 1.680 | 18.2 | −6.52 |
| 8 | | 3.4203 | (ASP) | 0.930 | | | | |
| 9 | Lens 4 | −9.8307 | (ASP) | 0.518 | Plastic | 1.544 | 56.0 | 57.42 |
| 10 | | −7.6165 | (ASP) | 0.030 | | | | |

| | | | | | | | |
|---|---|---|---|---|---|---|---|
| 11 | Stop | Plano | 0.400 | | | | |
| 12 | Prism | Plano | 15.750 | Glass | 1.804 | 46.6 | — |
| 13 | | Plano | 0.200 | | | | |
| 14 | Filter | Plano | 0.210 | Glass | 1.517 | 64.2 | — |
| 15 | | Plano | 0.429 | | | | |
| 16 | Image | Plano | — | | | | |

Note:
Reference wavelength is 587.6 nm (d-line).
An effective radius of the stop S1 (Surface 1) is 3.267 mm.
An effective radius of the stop S2 (Surface 11) is 2.194 mm.

TABLE 1B
Aspheric Coefficients

| Surface # | 4 | 5 | 7 | 8 |
|---|---|---|---|---|
| k= | 1.13918000E+00 | −7.89066000E+01 | 0.00000000E+00 | 0.00000000E+00 |
| A4= | −1.69827280E−02 | −1.77867550E−02 | −2.65134735E−03 | −2.67494055E−03 |
| A6= | 2.46432079E−02 | 4.87726817E−02 | 6.04044709E−02 | 4.76358147E−02 |
| A8= | −2.22074711E−02 | −4.80838313E−02 | −8.23966473E−02 | −7.19586522E−02 |
| A10= | 1.44666933E−02 | 3.29905523E−02 | 6.72498535E−02 | 6.16874635E−02 |
| A12= | −6.80437648E−03 | −1.64497157E−02 | −3.91217611E−02 | −3.81157182E−02 |
| A14= | 2.25209207E−03 | 5.84249275E−03 | 1.66061137E−02 | 1.74068640E−02 |
| A16= | −5.20097734E−04 | −1.45874194E−03 | −5.11841079E−03 | −5.74636616E−03 |
| A18= | 8.31666959E−05 | 2.52972825E−04 | 1.13522864E−03 | 1.33415964E−03 |
| A20= | −9.02149529E−06 | −2.97537054E−05 | −1.78501610E−04 | −2.10594963E−04 |
| A22= | 6.33470937E−07 | 2.25597680E−06 | 1.93529786E−05 | 2.13891569E−05 |
| A24= | −2.59771911E−08 | −9.85816823E−08 | −1.37234651E−06 | −1.25400692E−06 |
| A26= | 4.72421193E−10 | 1.80100495E−09 | 5.71480400E−08 | 3.20691670E−08 |
| A28= | — | 5.81655049E−12 | −1.05690705E−09 | — |

| Surface # | 9 | 10 |
|---|---|---|
| k= | 0.00000000E+00 | 0.00000000E+00 |
| A4= | 4.43701480E−03 | 2.15682601E−03 |
| A6= | 1.26018361E−02 | 1.17284210E−02 |
| A8= | −1.44812922E−02 | −1.64246128E−02 |
| A10= | 1.12169757E−02 | 1.58385620E−02 |
| A12= | −6.53912640E−03 | −1.08821362E−02 |
| A14= | 2.74468610E−03 | 5.29933783E−03 |
| A16= | −7.69812113E−04 | −1.80428018E−03 |
| A18= | 1.30156383E−04 | 4.22476733E−04 |
| A20= | −9.64998157E−06 | −6.61077076E−05 |
| A22= | −5.36143421E−07 | 6.54154854E−06 |
| A24= | 1.51888406E−07 | −3.65419632E−07 |
| A26= | −8.08485696E−09 | 8.60485725E−09 |

In Table 1A, the curvature radius, the thickness and the focal length are shown in millimeters (mm). Surface numbers 0-16 represent the surfaces sequentially arranged from the object side to the image side along the optical axis. In Table 1B, k represents the conic coefficient of the equation of the aspheric surface profiles. A4-A28 represent the aspheric coefficients ranging from the 4th order to the 28th order. The tables presented below for each embodiment are the corresponding schematic parameter and aberration curves, and the definitions of the tables are the same as Table 1A and Table 1B of the 1st embodiment. Therefore, an explanation in this regard will not be provided again.

### 2nd Embodiment

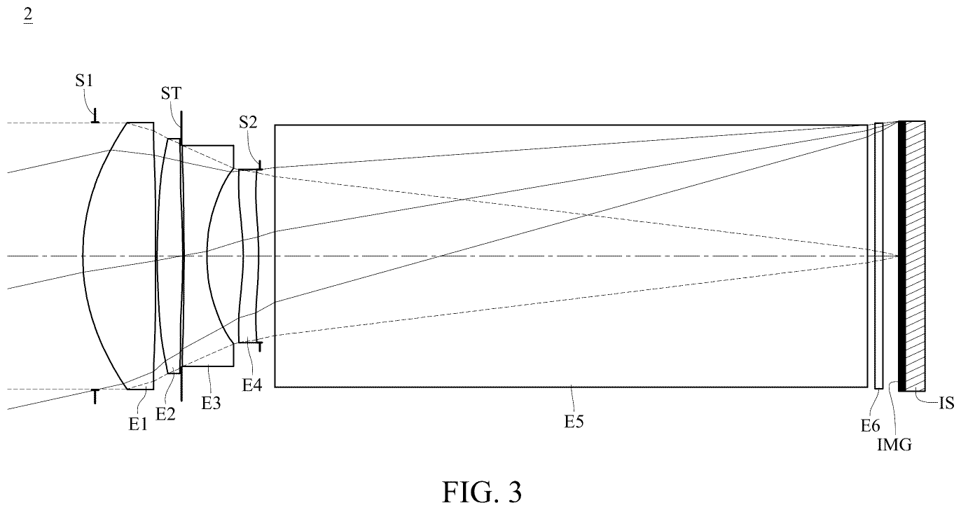

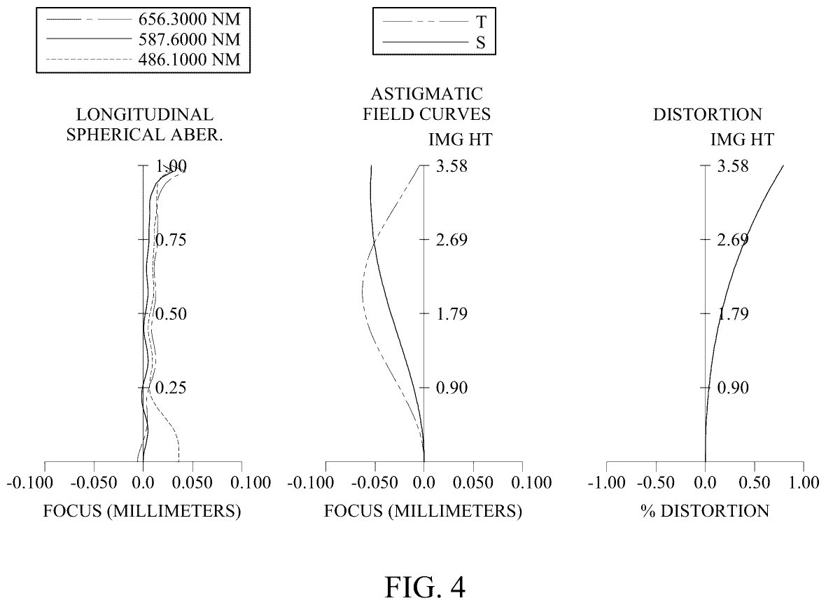

FIG. 3 is a schematic view of an image capturing unit according to the 2nd embodiment of the present disclosure. FIG. 4 shows, in order from left to right, spherical aberration curves, astigmatic field curves and a distortion curve of the image capturing unit according to the 2nd embodiment. In FIG. 3, the image capturing unit 2 includes the photographing optical lens system (its reference numeral is omitted) of the present disclosure and an image sensor IS. The photographing optical lens system includes, in order from an object side to an image side along an optical path, a stop S1, a first lens element E1, a second lens element E2, an aperture stop ST, a third lens element E3, a fourth lens element E4, a stop S2, a reflective element E5, a filter E6 and an image surface IMG. The photographing optical lens system includes four lens elements (E1, E2, E3 and E4) with no additional lens element disposed between each of the adjacent four lens elements.

The first lens element E1 with positive refractive power has an object-side surface being convex in a paraxial region thereof and an image-side surface being convex in a paraxial region thereof. The first lens element E1 is made of glass material and has the object-side surface and the image-side surface being both aspheric. The image-side surface of the first lens element E1 has one inflection point. The image-side surface of the first lens element E1 has one concave critical point in an off-axis region thereof.

The second lens element E2 with positive refractive power has an object-side surface being convex in a paraxial region thereof and an image-side surface being convex in a paraxial region thereof. The second lens element E2 is made of plastic material and has the object-side surface and the image-side surface being both aspheric. The object-side surface of the second lens element E2 has two inflection points. The image-side surface of the second lens element E2 has three inflection points. The image-side surface of the second lens element E2 has one concave critical point in an off-axis region thereof.

The third lens element E3 with negative refractive power has an object-side surface being concave in a paraxial region thereof and an image-side surface being concave in a paraxial region thereof. The third lens element E3 is made of plastic material and has the object-side surface and the image-side surface being both aspheric. The object-side surface of the third lens element E3 has three inflection points. The image-side surface of the third lens element E3 has one inflection point. The object-side surface of the third lens element E3 has one convex critical point in an off-axis region thereof.

The fourth lens element E4 with negative refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has two inflection points. The object-side surface of the fourth lens element E4 has one convex critical point and one concave critical point in an off-axis region thereof. The image-side surface of the fourth lens element E4 has one concave critical point in an off-axis region thereof.

The reflective element E5 is made of glass material and located between the fourth lens element E4 and the image surface IMG along the optical axis, and will not affect the focal length of the photographing optical lens system. The reflective element E5 is a prism with an optical path folding function. For simplicity in illustration, FIG. 3 does not show the deflection effect caused by the reflective element E5 on the optical path. However, the reflective element E5 can have various configurations depending on actual design requirements, thereby causing different deflection effects on the optical path. Moreover, the reflective element E5 of this embodiment can have a configuration similar to, for example, one of the configurations shown in FIG. 41 to FIG. 47, which can be referred to foregoing descriptions corresponding to FIG. 41 to FIG. 47, and the details in this regard will not be provided again. Furthermore, the reflective element E5 of this embodiment can have a configuration similar to, for example, the configuration shown in FIG. 38, deflecting the optical path five times, which can be referred to foregoing descriptions corresponding to FIG. 38, and the details in this regard will not be provided again.

The filter E6 is made of glass material and located between the reflective element E5 and the image surface IMG, and will not affect the focal length of the photographing optical lens system. The image sensor IS is disposed on or near the image surface IMG of the photographing optical lens system.

The detailed optical data of the 2nd embodiment are shown in Table 2A and the aspheric surface data are shown in Table 2B below.

TABLE 2A
2nd Embodiment
f = 16.04 mm, Fno = 2.27, HFOV = 12.5 deg.

| Surface # | | Curvature Radius | | Thickness | Material | Index | Abbe # | Focal Length |
|---|---|---|---|---|---|---|---|---|
| 0 | Object | Plano | | Infinity | | | | |
| 1 | Stop | Plano | | −0.326 | | | | |
| 2 | Lens 1 | 5.6925 | (ASP) | 1.935 | Glass | 1.782 | 37.1 | 7.17 |
| 3 | | −319.5034 | (ASP) | 0.040 | | | | |
| 4 | Lens 2 | 13.1706 | (ASP) | 0.680 | Plastic | 1.587 | 28.3 | 11.87 |
| 5 | | −14.5288 | (ASP) | −0.030 | | | | |
| 6 | Ape. Stop | Plano | | 0.070 | | | | |
| 7 | Lens 3 | −11.7363 | (ASP) | 0.605 | Plastic | 1.660 | 20.4 | −5.60 |
| 8 | | 5.5034 | (ASP) | 0.966 | | | | |
| 9 | Lens 4 | −5.5626 | (ASP) | 0.411 | Plastic | 1.614 | 25.6 | −35.88 |
| 10 | | −7.6521 | (ASP) | 0.030 | | | | |

| | | | | | | | |
|---|---|---|---|---|---|---|---|
| 11 | Stop | Plano | 0.400 | | | | |
| 12 | Prism | Plano | 15.750 | Glass | 1.804 | 46.6 | — |
| 13 | | Plano | 0.200 | | | | |
| 14 | Filter | Plano | 0.210 | Glass | 1.517 | 64.2 | — |
| 15 | | Plano | 0.423 | | | | |
| 16 | Image | Plano | — | | | | |

Note:
Reference wavelength is 587.6 nm (d-line).
An effective radius of the stop S1 (Surface 1) is 3.560 mm.
An effective radius of the stop S2 (Surface 11) is 2.300 mm.

TABLE 2B
Aspheric Coefficients

| Surface # | 2 | 3 | 4 | 5 |
|---|---|---|---|---|
| k= | −1.42028000E−01 | 9.90000000E+01 | 8.47472000E+00 | 1.50457000E+01 |
| A4= | 3.19244346E−04 | −6.74114925E−04 | −9.37197643E−03 | 4.46406403E−02 |
| A6= | −3.26539257E−06 | −3.66127886E−05 | 8.09370171E−04 | −6.60885328E−02 |
| A8= | −7.92444549E−06 | 8.58645764E−06 | 8.38498497E−04 | 6.05841937E−02 |
| A10= | 3.76996989E−07 | −1.92744569E−07 | −5.37255745E−04 | −3.69979317E−02 |
| A12= | — | — | 2.26266231E−04 | 1.60221320E−02 |
| A14= | — | — | −7.06738138E−05 | −5.05956093E−03 |
| A16= | — | — | 1.56703528E−05 | 1.17736098E−03 |
| A18= | — | — | −2.38948366E−06 | −2.01389893E−04 |
| A20= | — | — | 2.43240211E−07 | 2.49457808E−05 |
| A22= | — | — | −1.57267324E−08 | −2.17075893E−06 |
| A24= | — | — | 5.82126956E−10 | 1.25544404E−07 |
| A26= | — | — | −9.36229574E−12 | −4.32520829E−09 |
| A28= | — | — | — | 6.70913027E−11 |
| Surface # | 7 | 8 | 9 | 10 |
| k= | 0.00000000E+00 | 0.00000000E+00 | 0.00000000E+00 | 0.00000000E+00 |
| A4= | 7.07529935E−02 | 3.48320708E−02 | 2.82534497E−02 | 1.74601766E−02 |
| A6= | −8.02298181E−02 | −2.66012854E−02 | −5.68662945E−03 | 6.44926730E−03 |
| A8= | 6.56859438E−02 | 1.92762125E−02 | 1.85151570E−04 | −1.73386866E−02 |
| A10= | −3.88245099E−02 | −1.33715880E−02 | 1.60560048E−03 | 2.02056747E−02 |
| A12= | 1.65092795E−02 | 7.43940095E−03 | −1.68274251E−03 | −1.50708691E−02 |
| A14= | −5.11659072E−03 | −3.16282064E−03 | 8.94419528E−04 | 7.55633636E−03 |
| A16= | 1.16889164E−03 | 1.02166136E−03 | −2.74223950E−04 | −2.59201608E−03 |
| A18= | −1.96992467E−04 | −2.44326498E−04 | 4.83075985E−05 | 6.09598011E−04 |
| A20= | 2.41816506E−05 | 4.13013511E−05 | −4.12990297E−06 | −9.66947764E−05 |
| A22= | −2.09914494E−06 | −4.61170024E−06 | −1.19550517E−08 | 9.88989125E−06 |
| A24= | 1.21870563E−07 | 3.02832613E−07 | 2.99875602E−08 | −5.89053172E−07 |
| A26= | −4.23768209E−09 | −8.81793549E−09 | −1.63837900E−09 | 1.55252988E−08 |
| A28= | 6.66357188E−11 | — | — | — |

In the 2nd embodiment, the equation of the aspheric surface profiles of the aforementioned lens elements is the same as the equation of the 1st embodiment. Also, the definitions of these parameters shown in Table 2C below are the same as those stated in the 1st embodiment with corresponding values for the 2nd embodiment, so an explanation in this regard will not be provided again.

Moreover, these parameters can be calculated from Table 2A and Table 2B as the following values and satisfy the following conditions:

TABLE 2C
Values of Optical and Physical Parameters/Definitions

| | | | |
|---|---|---|---|
| f[mm] | 16.04 | (R4 + R6)/(R4 − R6) | 0.45 |
| Fno | 2.27 | TD/(CT2 + T23) | 6.50 |
| HFOV [deg.] | 12.5 | (CT2 + CT3)/CT1 | 0.66 |
| TL/ImgH | 6.05 | CT2/T34 | 0.70 |
| TD/BL | 0.27 | N1 | 1.782 |
| SD/TD | 0.44 | V2 | 28.3 |
| \|f2/f4\| | 0.33 | V1/V2 | 1.31 |
| \|f12/f4 | 0.13 | V3/V4 | 0.80 |
| \|f/R4\| + \|f/R5\| | 2.47 | ET2/CT2 | 0.46 |
| (R1 + R4)/(R1 − R4) | −0.44 | ET2/ET3 | 0.23 |
| (R1 − R5)/(R1 + R5) | −2.88 | Sag3R1/CT3 | −0.07 |
| f/f3 | −2.86 | — | — |

### 3rd Embodiment

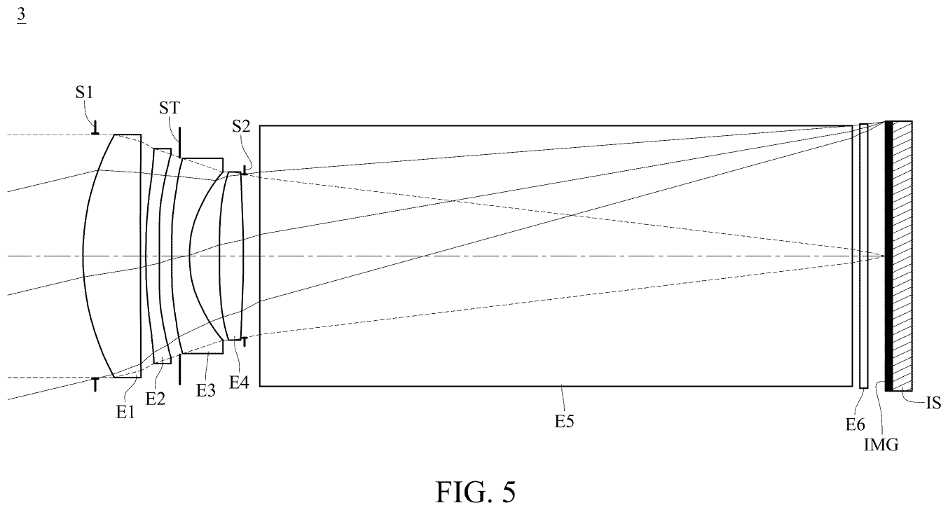

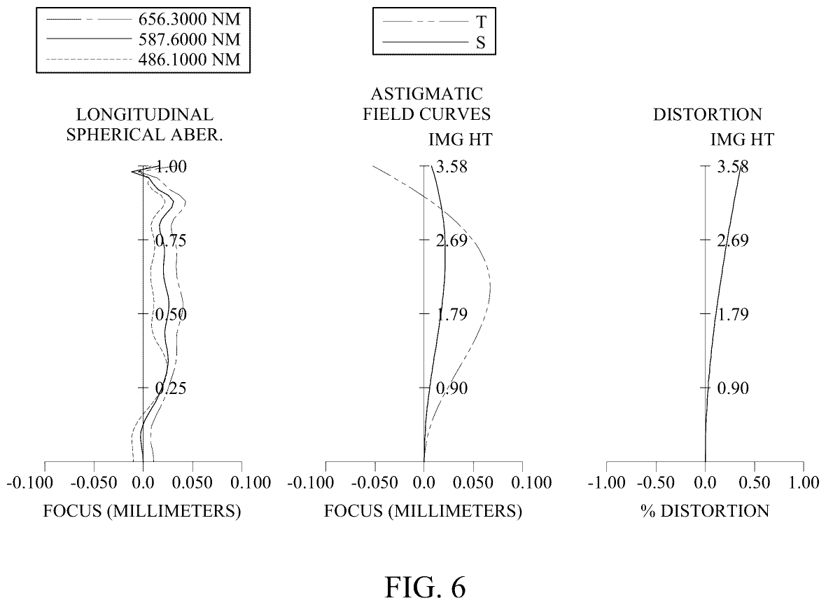

FIG. 5 is a schematic view of an image capturing unit according to the 3rd embodiment of the present disclosure. FIG. 6 shows, in order from left to right, spherical aberration curves, astigmatic field curves and a distortion curve of the image capturing unit according to the 3rd embodiment. In FIG. 5, the image capturing unit 3 includes the photographing optical lens system (its reference numeral is omitted) of the present disclosure and an image sensor IS. The photographing optical lens system includes, in order from an object side to an image side along an optical path, a stop S1, a first lens element E1, a second lens element E2, an aperture stop ST, a third lens element E3, a fourth lens element E4, a stop S2, a reflective element E5, a filter E6 and an image surface IMG. The photographing optical lens system includes four lens elements (E1, E2, E3 and E4) with no additional lens element disposed between each of the adjacent four lens elements.

The first lens element E1 with positive refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with positive refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has two inflection points. The image-side surface of the second lens element E2 has two inflection points.

The third lens element E3 with negative refractive power has an object-side surface being convex in a paraxial region thereof and an image-side surface being concave in a paraxial region thereof. The third lens element E3 is made of plastic material and has the object-side surface and the image-side surface being both aspheric.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The image-side surface of the fourth lens element E4 has two inflection points.

The reflective element E5 is made of glass material and located between the fourth lens element E4 and the image surface IMG along the optical axis, and will not affect the focal length of the photographing optical lens system. The reflective element E5 is a prism with an optical path folding function. For simplicity in illustration, FIG. 5 does not show the deflection effect caused by the reflective element E5 on the optical path. However, the reflective element E5 can have various configurations depending on actual design requirements, thereby causing different deflection effects on the optical path. Moreover, the reflective element E5 of this embodiment can have a configuration similar to, for example, one of the configurations shown in FIG. 41 to FIG. 47, which can be referred to foregoing descriptions corresponding to FIG. 41 to FIG. 47, and the details in this regard will not be provided again. Furthermore, the reflective element E5 of this embodiment can have a configuration similar to, for example, the configuration shown in FIG. 38, deflecting the optical path five times, which can be referred to foregoing descriptions corresponding to FIG. 38, and the details in this regard will not be provided again.

The filter E6 is made of glass material and located between the reflective element E5 and the image surface IMG, and will not affect the focal length of the photographing optical lens system. The image sensor IS is disposed on or near the image surface IMG of the photographing optical lens system.

The detailed optical data of the 3rd embodiment are shown in Table 3A and the aspheric surface data are shown in Table 3B below.

TABLE 3A
3rd Embodiment
f = 14.85 mm, Fno = 2.30, HFOV = 13.5 deg.

| Surface # | | Curvature Radius | | Thickness | Material | Index | Abbe # | Focal Length |
|---|---|---|---|---|---|---|---|---|
| 0 | Object | Plano | | Infinity | | | | |
| 1 | Stop | Plano | | −0.326 | | | | |
| 2 | Lens 1 | 6.6531 | (SPH) | 1.522 | Glass | 1.954 | 32.3 | 7.19 |
| 3 | | 201.6287 | (SPH) | 0.146 | | | | |
| 4 | Lens 2 | 11.1233 | (ASP) | 0.360 | Plastic | 1.587 | 28.3 | 26.08 |
| 5 | | 40.1546 | (ASP) | 0.550 | | | | |
| 6 | Ape. Stop | Plano | | −0.215 | | | | |
| 7 | Lens 3 | 177.6329 | (ASP) | 0.466 | Plastic | 1.660 | 20.4 | −5.32 |
| 8 | | 3.4410 | (ASP) | 0.797 | | | | |
| 9 | Lens 4 | 55.5556 | (ASP) | 0.638 | Plastic | 1.544 | 56.0 | 22.97 |
| 10 | | −16.0571 | (ASP) | 0.030 | | | | |

| | | | | | | | |
|---|---|---|---|---|---|---|---|
| 11 | Stop | Plano | 0.400 | | | | |
| 12 | Prism | Plano | 15.750 | Glass | 1.804 | 46.6 | — |
| 13 | | Plano | 0.200 | | | | |
| 14 | Filter | Plano | 0.210 | Glass | 1.517 | 64.2 | — |
| 15 | | Plano | 0.475 | | | | |
| 16 | Image | Plano | — | | | | |

Note:
Reference wavelength is 587.6 nm (d-line).
An effective radius of the stop S1 (Surface 1) is 3.258 mm.
An effective radius of the stop S2 (Surface 11) is 2.175 mm.

TABLE 3B
Aspheric Coefficients

| Surface # | 4 | 5 | 7 | 8 |
|---|---|---|---|---|
| k = | 1.64240000E+00 | 4.75669000E+01 | 0.00000000E+00 | 0.00000000E+00 |
| A4 = | −9.74753547E−03 | −1.88610074E−02 | −5.24334779E−03 | 7.23966525E−03 |
| A6 = | −2.29552248E−02 | −1.51768285E−02 | 3.51738437E−02 | 3.72746777E−02 |
| A8 = | 4.66611601E−02 | 7.28714072E−02 | −7.50999928E−03 | −4.83842009E−02 |
| A10 = | −3.80271688E−02 | −7.42161527E−02 | −1.88494446E−02 | 3.46529533E−02 |
| A12 = | 1.82716097E−02 | 4.08456387E−02 | 1.79866645E−02 | −2.28423116E−02 |
| A14 = | −5.76614790E−03 | −1.42903820E−02 | −7.98265210E−03 | 1.41361582E−02 |
| A16 = | 1.24412730E−03 | 3.35822620E−03 | 2.09536454E−03 | −6.69034707E−03 |
| A18 = | −1.85204310E−04 | −5.37599572E−04 | −3.32706261E−04 | 2.17073124E−03 |
| A20 = | 1.87394786E−05 | 5.78010702E−05 | 2.80002153E−05 | −4.62835331E−04 |
| A22 = | −1.23187623E−06 | −3.97674787E−06 | −2.32376331E−07 | 6.19867363E−05 |
| A24 = | 4.74793808E−08 | 1.55948974E−07 | −1.88865584E−07 | −4.73259206E−06 |
| A26 = | −8.14561976E−10 | −2.45802266E−09 | 1.66939486E−08 | 1.57291654E−07 |
| A28 = | — | −1.15477067E−11 | −4.79795925E−10 | — |

| Surface # | 9 | 10 |
|---|---|---|
| k = | 0.00000000E+00 | 0.00000000E+00 |
| A4 = | 1.56846721E−02 | 1.33911494E−02 |
| A6 = | −1.58480011E−03 | −1.89061275E−02 |
| A8 = | −5.32383277E−03 | 2.76338120E−02 |
| A10 = | 1.32029294E−02 | −2.59735586E−02 |
| A12 = | −1.67007413E−02 | 1.52835596E−02 |
| A14 = | 1.25034482E−02 | −5.55272548E−03 |
| A16 = | −5.93270967E−03 | 1.12927170E−03 |
| A18 = | 1.84071573E−03 | −6.37903221E−05 |
| A20 = | −3.73366793E−04 | −2.61183662E−05 |
| A22 = | 4.77864357E−05 | 6.92283274E−06 |
| A24 = | −3.50611799E−06 | −7.04736648E−07 |
| A26 = | 1.12502583E−07 | 2.74976310E−08 |

In the 3rd embodiment, the equation of the aspheric surface profiles of the aforementioned lens elements is the same as the equation of the 1st embodiment. Also, the definitions of these parameters shown in Table 3C below are the same as those stated in the 1st embodiment with corresponding values for the 3rd embodiment, so an explanation in this regard will not be provided again.

Moreover, these parameters can be calculated from Table 3A and Table 3B as the following values and satisfy the following conditions:

TABLE 3C
Values of Optical and Physical Parameters/Definitions

| | | | |
|---|---|---|---|
| f[mm] | 14.85 | (R4 + R6)/(R4 − R6) | 1.19 |
| Fno | 2.30 | TD/(CT2 + T23) | 6.14 |
| HFOV [deg.] | 13.5 | (CT2 + CT3)/CT1 | 0.54 |
| TL/ImgH | 5.95 | CT2/T34 | 0.45 |
| TD/BL | 0.25 | N1 | 1.954 |
| SD/TD | 0.40 | V2 | 28.3 |
| \|f2/f4\| | 1.14 | V1/V2 | 1.14 |
| \|f12/f4\| | 0.25 | V3/V4 | 0.36 |
| \|f/R4\| + \|f/R5\| | 0.45 | ET2/CT2 | 1.25 |
| (R1 + R4)/(R1 − R4) | −1.40 | ET2/ET3 | 0.42 |
| (R1 − R5)/(R1 + R5) | −0.93 | Sag3R1/CT3 | 0.61 |
| f/f3 | −2.79 | — | — |

### 4th Embodiment

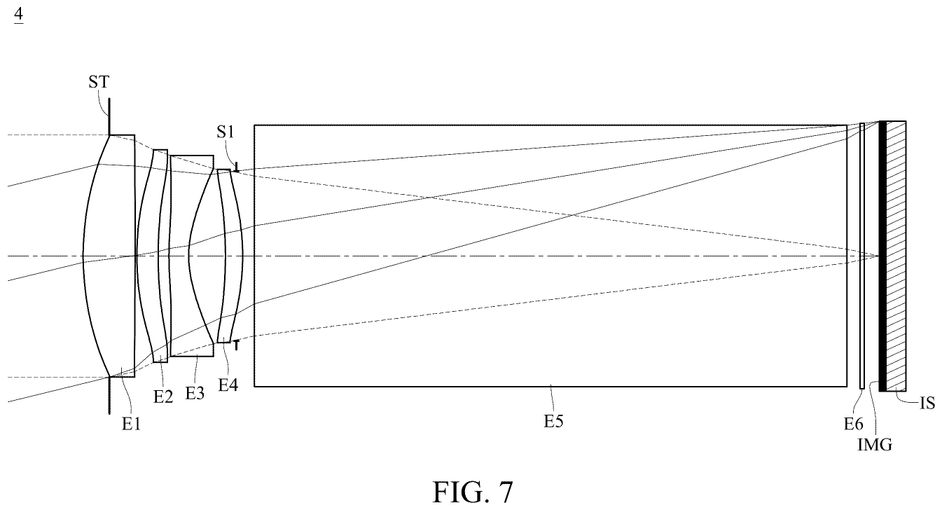

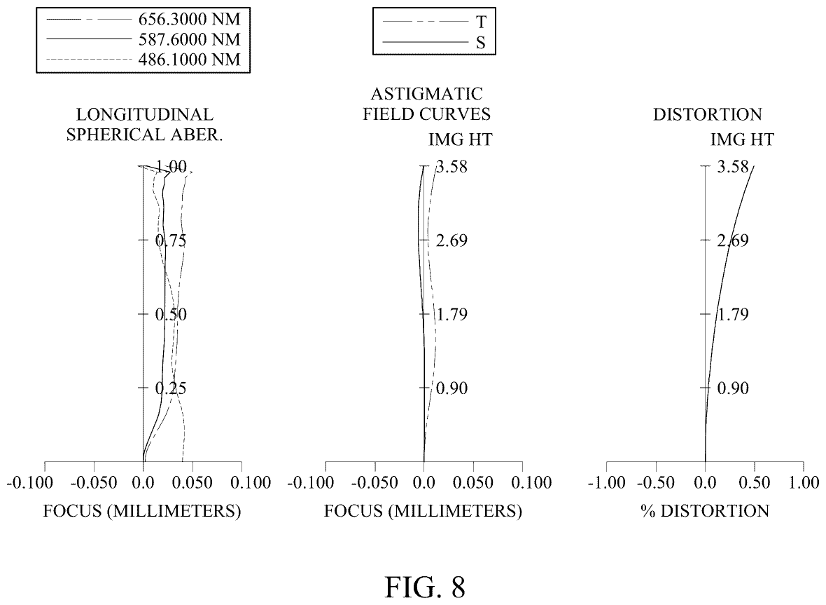

FIG. 7 is a schematic view of an image capturing unit according to the 4th embodiment of the present disclosure. FIG. 8 shows, in order from left to right, spherical aberration curves, astigmatic field curves and a distortion curve of the image capturing unit according to the 4th embodiment. In FIG. 7, the image capturing unit 4 includes the photographing optical lens system (its reference numeral is omitted) of the present disclosure and an image sensor IS. The photographing optical lens system includes, in order from an object side to an image side along an optical path, an aperture stop ST, a first lens element E1, a second lens element E2, a third lens element E3, a fourth lens element E4, a stop S1, a reflective element E5, a filter E6 and an image surface IMG. The photographing optical lens system includes four lens elements (E1, E2, E3 and E4) with no additional lens element disposed between each of the adjacent four lens elements.

The first lens element E1 with positive refractive power has an object-side surface being convex in a paraxial region thereof and an image-side surface being convex in a paraxial region thereof. The first lens element E1 is made of glass material and has the object-side surface and the image-side surface being both spherical.

The second lens element E2 with positive refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has two inflection points. The image-side surface of the second lens element E2 has one convex critical point and one concave critical point in an off-axis region thereof.

The third lens element E3 with negative refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has two inflection points. The object-side surface of the third lens element E3 has one convex critical point and one concave critical point in an off-axis region thereof.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has one inflection point. The object-side surface of the fourth lens element E4 has one convex critical point in an off-axis region thereof.

The reflective element E5 is made of glass material and located between the fourth lens element E4 and the image surface IMG along the optical axis, and will not affect the focal length of the photographing optical lens system. The reflective element E5 is a prism with an optical path folding function. For simplicity in illustration, FIG. 7 does not show the deflection effect caused by the reflective element E5 on the optical path. However, the reflective element E5 can have various configurations depending on actual design requirements, thereby causing different deflection effects on the optical path. Moreover, the reflective element E5 of this embodiment can have a configuration similar to, for example, one of the configurations shown in FIG. 41 to FIG. 47, which can be referred to foregoing descriptions corresponding to FIG. 41 to FIG. 47, and the details in this regard will not be provided again. Furthermore, the reflective element E5 of this embodiment can have a configuration similar to, for example, the configuration shown in FIG. 38, deflecting the optical path five times, which can be referred to foregoing descriptions corresponding to FIG. 38, and the details in this regard will not be provided again.

The filter E6 is made of glass material and located between the reflective element E5 and the image surface IMG, and will not affect the focal length of the photographing optical lens system. The image sensor IS is disposed on or near the image surface IMG of the photographing optical lens system.

The detailed optical data of the 4th embodiment are shown in Table 4A and the aspheric surface data are shown in Table 4B below.

TABLE 4A
4th Embodiment
f = 14.60 mm, Fno = 2.27, HFOV = 13.7 deg.

| Surface # | | Curvature Radius | | Thickness | Material | Index | Abbe # | Focal Length |
|---|---|---|---|---|---|---|---|---|
| 0 | Object | Plano | | Infinity | | | | |
| 1 | Ape. Stop | Plano | | −0.697 | | | | |
| 2 | Lens 1 | 7.6240 | (SPH) | 1.389 | Glass | 1.954 | 32.3 | 7.74 |
| 3 | | −209.2260 | (SPH) | 0.040 | | | | |
| 4 | Lens 2 | 7.9649 | (ASP) | 0.569 | Plastic | 1.544 | 56.0 | 25.55 |
| 5 | | 18.1875 | (ASP) | 0.287 | | | | |
| 6 | Lens 3 | 11.2966 | (ASP) | 0.522 | Plastic | 1.660 | 20.4 | −5.84 |
| 7 | | 2.8209 | (ASP) | 0.976 | | | | |
| 8 | Lens 4 | −11.0211 | (ASP) | 0.457 | Plastic | 1.544 | 56.0 | 25.94 |
| 9 | | −6.2785 | (ASP) | −0.165 | | | | |

| | | | | | | | |
|---|---|---|---|---|---|---|---|
| 10 | Stop | Plano | 0.480 | | | | |
| 11 | Prism | Plano | 15.750 | Glass | 1.804 | 46.6 | — |
| 12 | | Plano | 0.350 | | | | |
| 13 | Filter | Plano | 0.110 | Glass | 1.517 | 64.2 | — |
| 14 | | Plano | 0.406 | | | | |
| 15 | Image | Plano | — | | | | |

Note:
Reference wavelength is 587.6 nm (d-line).
An effective radius of the stop S1 (Surface 10) is 2.258 mm.

TABLE 4B
Aspheric Coefficients

| Surface # | 4 | 5 | 6 | 7 |
|---|---|---|---|---|
| k = | −4.98388000E+00 | 0.00000000E+00 | 0.00000000E+00 | 0.00000000E+00 |
| A4 = | 6.27654166E−03 | 2.58364976E−02 | 7.83194517E−03 | −1.37898347E−02 |
| A6 = | −1.96289280E−03 | −2.09322157E−02 | −3.00708161E−02 | −2.15365648E−02 |
| A8 = | 2.20661478E−04 | 1.22262914E−02 | 2.52106304E−02 | 2.36189851E−02 |
| A10 = | 1.74028971E−04 | −5.74500452E−03 | −1.48267955E−02 | −1.69101338E−02 |
| A12 = | −1.30487027E−04 | 2.13391752E−03 | 6.85486937E−03 | 9.20837933E−03 |
| A14 = | 4.95703250E−05 | −5.75169156E−04 | −2.40207525E−03 | −3.69451827E−03 |
| A16 = | −1.19901975E−05 | 1.07162972E−04 | 6.10281168E−04 | 1.03784435E−03 |
| A18 = | 1.83298616E−06 | −1.39435435E−05 | −1.09394165E−04 | −1.96152473E−04 |
| A20 = | −1.69102297E−07 | 1.33462849E−06 | 1.34604501E−05 | 2.37158869E−05 |
| A22 = | 8.53511542E−09 | −9.76594402E−08 | −1.08235909E−06 | −1.65908577E−06 |
| A24 = | −1.79900813E−10 | 4.96406210E−09 | 5.12276888E−08 | 5.11940514E−08 |
| A26 = | — | −1.22989074E−10 | −1.08128237E−09 | — |

| Surface # | 8 | 9 |
|---|---|---|
| k = | 0.00000000E+00 | 0.00000000E+00 |
| A4 = | 6.14945058E−03 | 5.13251964E−03 |
| A6 = | −9.43754281E−03 | −6.39309026E−03 |
| A8 = | 1.09685727E−02 | 8.25604912E−03 |
| A10 = | −1.07254573E−02 | −8.02719818E−03 |
| A12 = | 7.38684613E−03 | 5.35170590E−03 |
| A14 = | −3.36919602E−03 | −2.36271141E−03 |
| A16 = | 1.01166228E−03 | 6.89636262E−04 |
| A18 = | −1.98276717E−04 | −1.31631342E−04 |
| A20 = | 2.44947566E−05 | 1.58181467E−05 |
| A22 = | −1.73733337E−06 | −1.08748988E−06 |
| A24 = | 5.41051946E−08 | 3.26597262E− 08 |

In the 4th embodiment, the equation of the aspheric surface profiles of the aforementioned lens elements is the same as the equation of the 1st embodiment. Also, the definitions of these parameters shown in Table 4C below are the same as those stated in the 1st embodiment with corresponding values for the 4th embodiment, so an explanation in this regard will not be provided again.

Moreover, these parameters can be calculated from Table 4A and Table 4B as the following values and satisfy the following conditions:

TABLE 4C
Values of Optical and Physical Parameters/Definitions

| | | | |
|---|---|---|---|
| f[mm] | 14.60 | (R4 + R6)/(R4 − R6) | 1.37 |
| Fno | 2.27 | TD/(CT2 + T23) | 4.95 |
| HFOV [deg.] | 13.7 | (CT2 + CT3)/CT1 | 0.79 |
| TL/ImgH | 5.91 | CT2/T34 | 0.58 |
| TD/BL | 0.25 | N1 | 1.954 |
| SD/TD | 0.84 | V2 | 56.0 |
| \|f2/f4\| | 0.98 | V1/V2 | 0.58 |
| \|f12/f4 | 0.23 | V3/V4 | 0.36 |
| \|f/R4\| + \|f/R5\| | 2.09 | ET2/CT2 | 0.65 |
| (R1 + R4)/(R1 − R4) | −2.44 | ET2/ET3 | 0.32 |
| (R1 − R5)/(R1 + R5) | −0.19 | Sag3R1/CT3 | 0.07 |
| f/f3 | −2.50 | — | — |

### 5th Embodiment

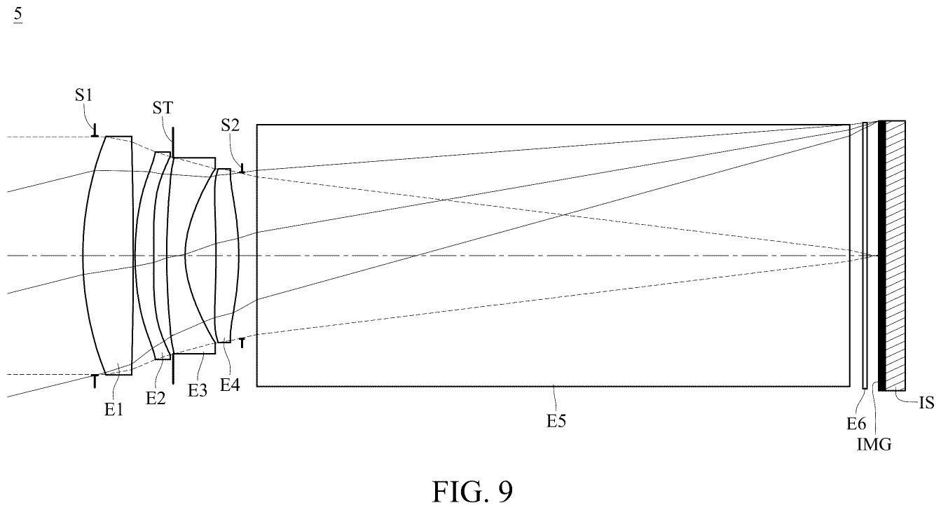

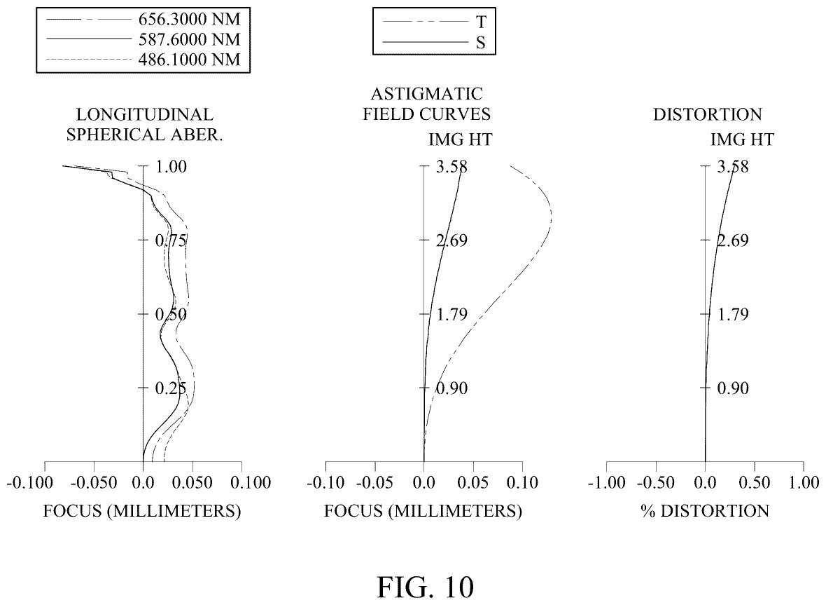

FIG. 9 is a schematic view of an image capturing unit according to the 5th embodiment of the present disclosure. FIG. 10 shows, in order from left to right, spherical aberration curves, astigmatic field curves and a distortion curve of the image capturing unit according to the 5th embodiment. In FIG. 9, the image capturing unit 5 includes the photographing optical lens system (its reference numeral is omitted) of the present disclosure and an image sensor IS. The photographing optical lens system includes, in order from an object side to an image side along an optical path, a stop S1, a first lens element E1, a second lens element E2, an aperture stop ST, a third lens element E3, a fourth lens element E4, a stop S2, a reflective element E5, a filter E6 and an image surface IMG. The photographing optical lens system includes four lens elements (E1, E2, E3 and E4) with no additional lens element disposed between each of the adjacent four lens elements.

The first lens element E1 with positive refractive power has an object-side surface being convex in a paraxial region thereof and an image-side surface being convex in a paraxial region thereof. The first lens element E1 is made of glass material and has the object-side surface and the image-side surface being both spherical.

The second lens element E2 with positive refractive power has an object-side surface being convex in a paraxial region thereof and an image-side surface being convex in a paraxial region thereof. The second lens element E2 is made of plastic material and has the object-side surface and the image-side surface being both aspheric. The object-side surface of the second lens element E2 has one inflection point. The image-side surface of the second lens element E2 has one inflection point. The image-side surface of the second lens element E2 has one concave critical point in an off-axis region thereof.

The third lens element E3 with negative refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has two inflection points. The image-side surface of the third lens element E3 has one inflection point.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has one inflection point. The object-side surface of the fourth lens element E4 has one convex critical point in an off-axis region thereof. The image-side surface of the fourth lens element E4 has one concave critical point in an off-axis region thereof.

The reflective element E5 is made of glass material and located between the fourth lens element E4 and the image surface IMG along the optical axis, and will not affect the focal length of the photographing optical lens system. The reflective element E5 is a prism with an optical path folding function. For simplicity in illustration, FIG. 9 does not show the deflection effect caused by the reflective element E5 on the optical path. However, the reflective element E5 can have various configurations depending on actual design requirements, thereby causing different deflection effects on the optical path. Moreover, the reflective element E5 of this embodiment can have a configuration similar to, for example, one of the configurations shown in FIG. 41 to FIG. 47, which can be referred to foregoing descriptions corresponding to FIG. 41 to FIG. 47, and the details in this regard will not be provided again. Furthermore, the reflective element E5 of this embodiment can have a configuration similar to, for example, the configuration shown in FIG. 38, deflecting the optical path five times, which can be referred to foregoing descriptions corresponding to FIG. 38, and the details in this regard will not be provided again.

The filter E6 is made of glass material and located between the reflective element E5 and the image surface IMG, and will not affect the focal length of the photographing optical lens system. The image sensor IS is disposed on or near the image surface IMG of the photographing optical lens system.

The detailed optical data of the 5th embodiment are shown in Table 5A and the aspheric surface data are shown in Table 5B below.

TABLE 5A
5th Embodiment
f = 14.34 mm, Fno = 2.27, HFOV = 14.0 deg.

| Surface # | | Curvature Radius | | Thickness | Material | Index | Abbe # | Focal Length |
|---|---|---|---|---|---|---|---|---|
| 0 | Object | Plano | | Infinity | | | | |
| 1 | Stop | Plano | | −0.316 | | | | |
| 2 | Lens 1 | 8.5045 | (SPH) | 1.340 | Glass | 1.954 | 32.3 | 8.38 |
| 3 | | −123.5800 | (SPH) | 0.050 | | | | |
| 4 | Lens 2 | 8.2283 | (ASP) | 0.493 | Plastic | 1.587 | 28.3 | 11.06 |
| 5 | | −30.1688 | (ASP) | 0.521 | | | | |
| 6 | Ape. Stop | Plano | | −0.174 | | | | |
| 7 | Lens 3 | 200.0000 | (ASP) | 0.489 | Plastic | 1.660 | 20.4 | −4.45 |
| 8 | | 2.8932 | (ASP) | 0.820 | | | | |
| 9 | Lens 4 | −18.6996 | (ASP) | 0.604 | Plastic | 1.544 | 56.0 | 21.04 |
| 10 | | −7.1804 | (ASP) | 0.085 | | | | |

| | | | | | | | |
|---|---|---|---|---|---|---|---|
| 11 | Stop | Plano | 0.400 | | | | |
| 12 | Prism | Plano | 15.750 | Glass | 1.804 | 46.6 | — |
| 13 | | Plano | 0.350 | | | | |
| 14 | Filter | Plano | 0.110 | Glass | 1.517 | 64.2 | — |
| 15 | | Plano | 0.312 | | | | |
| 16 | Image | Plano | — | | | | |

Note:
Reference wavelength is 587.6 nm (d-line).
An effective radius of the stop S1 (Surface 1) is 3.180 mm.
An effective radius of the stop S2 (Surface 11) is 2.214 mm.

TABLE 5B
Aspheric Coefficients

| Surface # | 4 | 5 | 7 | 8 |
|---|---|---|---|---|
| k = | 0.00000000E+00 | 0.00000000E+00 | 0.00000000E+00 | 0.00000000E+00 |
| A4 = | −1.78768290E−03 | 2.98578274E−02 | 5.69273917E−02 | 3.06775195E−02 |
| A6 = | 2.28302874E−02 | 4.09732948E−02 | −8.30470428E−03 | −1.87786045E−02 |
| A8 = | −2.88132947E−02 | −8.98533769E−02 | −8.95928855E−02 | −8.29786594E−02 |
| A10 = | 1.84785206E−02 | 7.70699654E−02 | 1.23764470E−01 | 1.50262281E−01 |
| A12 = | −7.08738464E−03 | −3.85232545E−02 | −8.69288222E−02 | −1.29095500E−01 |
| A14 = | 1.62148619E−03 | 1.22525906E−02 | 3.91291679E−02 | 6.97196272E−02 |
| A16 = | −1.56128047E−04 | −2.42721835E−03 | −1.21465679E−02 | −2.57173662E−02 |
| A18 = | −2.69466615E−05 | 2.40618163E−04 | 2.66663326E−03 | 6.66400769E−03 |
| A20 = | 1.23771924E−05 | 9.06815259E−06 | −4.13918896E−04 | −1.21351297E−03 |
| A22 = | −2.11507648E−06 | −6.21090804E−06 | 4.44529601E−05 | 1.51911907E−04 |
| A24 = | 1.99689921E−07 | 8.31687890E−07 | −3.14158932E−06 | −1.24250765E−05 |
| A26 = | −1.02510999E−08 | −5.22490288E−08 | 1.31384151E−07 | 5.96739928E−07 |
| A28 = | 2.24188185E−10 | 1.32694486E−09 | −2.46254181E−09 | −1.27455528E−08 |

| Surface # | 9 | 10 |
|---|---|---|
| k = | 0.00000000E+00 | 0.00000000E+00 |
| A4 = | 1.07103222E−02 | 3.85520374E−03 |
| A6 = | 1.34398774E−02 | 1.34575320E−02 |
| A8 = | −5.12947325E−02 | −4.02738719E−02 |
| A10 = | 6.72476547E−02 | 5.56117225E−02 |
| A12 = | −5.10581625E−02 | −4.72332157E−02 |
| A14 = | 2.55112770E−02 | 2.72024033E−02 |
| A16 = | −8.76120653E−03 | −1.10542853E−02 |
| A18 = | 2.08226109E−03 | 3.21373692E−03 |
| A20 = | −3.36012447E−04 | −6.65728192E−04 |
| A22 = | 3.50395810E−05 | 9.60984663E−05 |
| A24 = | −2.12294936E−06 | −9.20031389E−06 |
| A26 = | 5.65487308E−08 | 5.25932378E−07 |
| A28 = | — | −1.36107350E−08 |

In the 5th embodiment, the equation of the aspheric surface profiles of the aforementioned lens elements is the same as the equation of the 1st embodiment. Also, the definitions of these parameters shown in Table 5C below are the same as those stated in the 1st embodiment with corresponding values for the 5th embodiment, so an explanation in this regard will not be provided again.

Moreover, these parameters can be calculated from Table 5A and Table 5B as the following values and satisfy the following conditions:

TABLE 5C
Values of Optical and Physical Parameters/Definitions

| | | | |
|---|---|---|---|
| f [mm] | 14.34 | (R4 + R6)/(R4 − R6) | 0.82 |
| Fno | 2.27 | TD/(CT2 + T23) | 4.93 |
| HFOV [deg.] | 14.0 | (CT2 + CT3)/CT1 | 0.73 |
| TL/ImgH | 5.90 | CT2/T34 | 0.60 |
| TD/BL | 0.24 | N1 | 1.954 |
| SD/TD | 0.42 | V2 | 28.3 |
| \|f2/f4] | 0.53 | V1/V2 | 1.14 |
| \|f12/f4\| | 0.24 | V3/V4 | 0.36 |
| \|f/R4\| + \|f/R5\| | 0.55 | ET2/CT2 | 0.79 |
| (R1 + R4)/(R1 − R4) | −0.56 | ET2/ET3 | 0.36 |
| (R1 − R5)/(R1 + R5) | −0.92 | Sag3R1/CT3 | 0.41 |
| f/f3 | −3.22 | — | — |

### 6th Embodiment

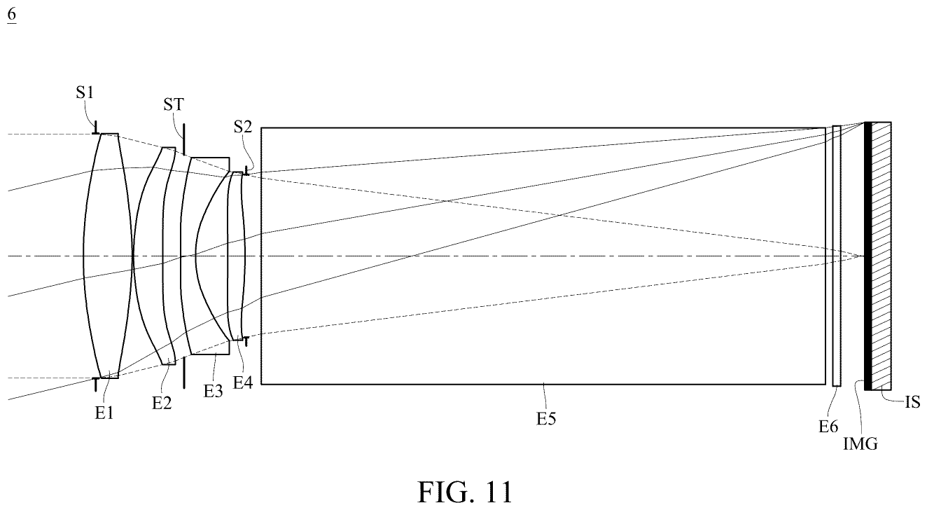

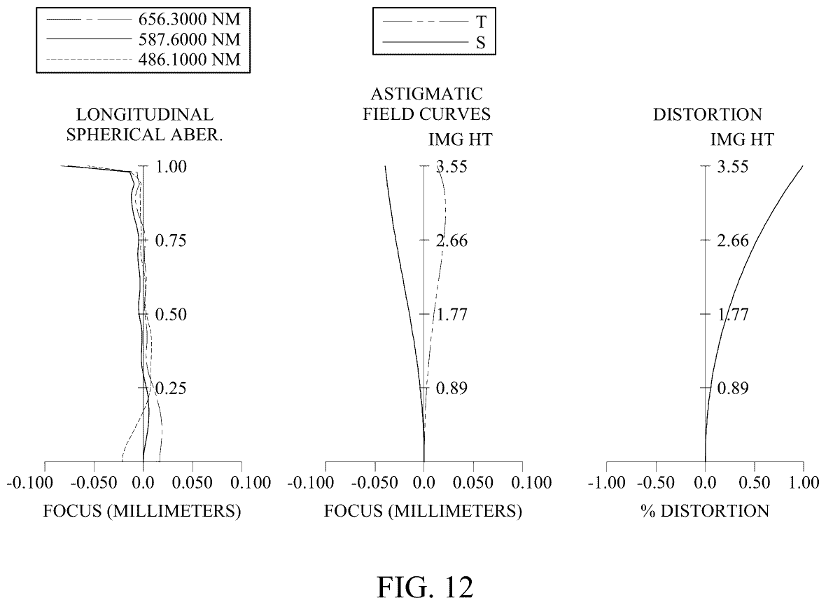

FIG. 11 is a schematic view of an image capturing unit according to the 6th embodiment of the present disclosure. FIG. 12 shows, in order from left to right, spherical aberration curves, astigmatic field curves and a distortion curve of the image capturing unit according to the 6th embodiment. In FIG. 11, the image capturing unit 6 includes the photographing optical lens system (its reference numeral is omitted) of the present disclosure and an image sensor IS. The photographing optical lens system includes, in order from an object side to an image side along an optical path, a stop S1, a first lens element E1, a second lens element E2, an aperture stop ST, a third lens element E3, a fourth lens element E4, a stop S2, a reflective element E5, a filter E6 and an image surface IMG. The photographing optical lens system includes four lens elements (E1, E2, E3 and E4) with no additional lens element disposed between each of the adjacent four lens elements.

The first lens element E1 with positive refractive power has an object-side surface being convex in a paraxial region thereof and an image-side surface being convex in a paraxial region thereof. The first lens element E1 is made of plastic material and has the object-side surface and the image-side surface being both aspheric. The image-side surface of the first lens element E1 has one inflection point.

The second lens element E2 with positive refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has three inflection points.

The third lens element E3 with negative refractive power has an object-side surface being concave in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has one inflection point. The object-side surface of the third lens element E3 has one convex critical point in an off-axis region thereof.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has one inflection point. The object-side surface of the fourth lens element E4 has one convex critical point in an off-axis region thereof. The image-side surface of the fourth lens element E4 has one concave critical point in an off-axis region thereof.

The reflective element E5 is made of glass material and located between the fourth lens element E4 and the image surface IMG along the optical axis, and will not affect the focal length of the photographing optical lens system. The reflective element E5 is a prism with an optical path folding function. For simplicity in illustration, FIG. 11 does not show the deflection effect caused by the reflective element E5 on the optical path. However, the reflective element E5 can have various configurations depending on actual design requirements, thereby causing different deflection effects on the optical path. Moreover, the reflective element E5 of this embodiment can have a configuration similar to, for example, one of the configurations shown in FIG. 41 to FIG. 47, which can be referred to foregoing descriptions corresponding to FIG. 41 to FIG. 47, and the details in this regard will not be provided again. Furthermore, the reflective element E5 of this embodiment can have a configuration similar to, for example, the configuration shown in FIG. 38, deflecting the optical path five times, which can be referred to foregoing descriptions corresponding to FIG. 38, and the details in this regard will not be provided again.

The filter E6 is made of glass material and located between the reflective element E5 and the image surface IMG, and will not affect the focal length of the photographing optical lens system. The image sensor IS is disposed on or near the image surface IMG of the photographing optical lens system.

The detailed optical data of the 6th embodiment are shown in Table 6A and the aspheric surface data are shown in Table 6B below.

TABLE 6A
6th Embodiment
f = 14.65 mm, Fno = 2.26, HFOV = 13.5 deg.

| Surface # | | Curvature Radius | | Thickness | Material | Index | Abbe # | Focal Length |
|---|---|---|---|---|---|---|---|---|
| 0 | Object | Plano | | Infinity | | | | |
| 1 | Stop | Plano | | −0.326 | | | | |
| 2 | Lens 1 | 10.9265 | (ASP) | 1.295 | Plastic | 1.544 | 56.0 | 9.42 |
| 3 | | −9.2455 | (ASP) | 0.040 | | | | |
| 4 | Lens 2 | 5.4226 | (ASP) | 0.773 | Plastic | 1.642 | 22.5 | 10.15 |
| 5 | | 30.6543 | (ASP) | 0.572 | | | | |
| 6 | Ape. Stop | Plano | | −0.096 | | | | |
| 7 | Lens 3 | −48.2931 | (ASP) | 0.399 | Plastic | 1.650 | 21.8 | −4.50 |
| 8 | | 3.1188 | (ASP) | 0.856 | | | | |
| 9 | Lens 4 | −22.2262 | (ASP) | 0.461 | Plastic | 1.544 | 56.0 | 26.23 |
| 10 | | −8.7543 | (ASP) | 0.030 | | | | |

| | | | | | | | |
|---|---|---|---|---|---|---|---|
| 11 | Stop | Plano | 0.400 | | | | |
| 12 | Prism | Plano | 15.000 | Glass | 1.804 | 46.6 | — |
| 13 | | Plano | 0.200 | | | | |
| 14 | Filter | Plano | 0.210 | Glass | 1.517 | 64.2 | — |
| 15 | | Plano | 0.639 | | | | |
| 16 | Image | Plano | — | | | | |

Note:
Reference wavelength is 587.6 nm (d-line).
An effective radius of the stop S1 (Surface 1) is 3.256 mm.
An effective radius of the stop S2 (Surface 11) is 2.165 mm.

TABLE 6B
Aspheric Coefficients

| Surface # | 2 | 3 | 4 | 5 |
|---|---|---|---|---|
| k = | −1.17090000E+00 | −2.77270000E+01 | 8.14900000E−01 | −8.87749000E+01 |
| A4 = | 2.46983012E−03 | −5.15302429E−03 | −2.29391295E−02 | −3.22148921E−02 |
| A6 = | −1.30108367E−03 | 5.29665699E−03 | 1.34671615E−02 | 3.88360602E−02 |
| A8 = | 3.81719362E−04 | −2.35823917E−03 | −4.44255607E−03 | −2.33387911E−02 |
| A10 = | −8.17559819E−05 | 5.79368713E−04 | 1.43175360E−03 | 1.12784031E−02 |
| A12 = | 1.21349965E−05 | −8.75490087E−05 | −5.29877929E−04 | −4.50437653E−03 |
| A14 = | −1.18777798E−06 | 8.39794177E−06 | 1.60464169E−04 | 1.40160649E−03 |
| A16 = | 7.40378981E−08 | −4.99390678E−07 | −3.29107167E−05 | −3.26525509E−04 |
| A18 = | −2.71803781E−09 | 1.67651095E−08 | 4.37459506E−06 | 5.62829661E−05 |
| A20 = | 4.62793748E−11 | −2.40590464E−10 | −3.62680723E−07 | −7.14026934E−06 |
| A22 = | — | — | 1.67584790E−08 | 6.53397813E−07 |
| A24 = | — | — | −2.85734737E−10 | −4.09157921E−08 |
| A26 = | — | — | −3.21818806E−12 | 1.56572393E−09 |
| A28 = | — | — | — | −2.75189093E−11 |
| Surface # | 7 | 8 | 9 | 10 |
| k = | 0.00000000E+00 | 0.00000000E+00 | 0.00000000E+00 | 0.00000000E+00 |
| A4 = | 6.28715744E−03 | 1.88096655E−02 | 1.36625101E−02 | 7.84372784E−03 |
| A6 = | 5.95056797E−02 | 3.16002688E−02 | −2.73924147E−03 | 3.53441222E−04 |
| A8 = | −7.99701235E−02 | −5.84979233E−02 | 1.40477831E−02 | 6.68831459E−03 |
| A10 = | 5.93692393E−02 | 3.54201660E−02 | −3.11013113E−02 | −1.80737503E−02 |
| A12 = | −3.02664688E−02 | −6.65305722E−03 | 3.35084400E−02 | 2.11640864E−02 |
| A14 = | 1.12145563E−02 | −4.38731044E−03 | −2.20438867E−02 | −1.47231071E−02 |
| A16 = | −3.05828738E−03 | 3.80657081E−03 | 9.59532926E−03 | 6.69308057E−03 |
| A18 = | 6.11273005E−04 | −1.42858669E−03 | −2.82629836E−03 | −2.04416621E−03 |
| A20 = | −8.81882721E−05 | 3.18037500E−04 | 5.57923215E−04 | 4.16490470E−04 |
| A22 = | 8.91490562E−06 | −4.32229788E−05 | −7.07431244E−05 | −5.43326830E−05 |
| A24 = | −5.97796761E−07 | 3.32654955E−06 | 5.20881315E−06 | 4.10605910E−06 |
| A26 = | 2.38396098E−08 | −1.11502635E−07 | −1.69311447E−07 | −1.36730090E−07 |
| A28 = | −4.27373831E−10 | — | — | — |

In the 6th embodiment, the equation of the aspheric surface profiles of the aforementioned lens elements is the same as the equation of the 1st embodiment. Also, the definitions of these parameters shown in Table 6C below are the same as those stated in the 1st embodiment with corresponding values for the 6th embodiment, so an explanation in this regard will not be provided again.

Moreover, these parameters can be calculated from Table 6A and Table 6B as the following values and satisfy the following conditions:

TABLE 6C
Values of Optical and Physical Parameters/Definitions

| | | | |
|---|---|---|---|
| f[mm] | 14.65 | (R4 + R6)/(R4 − R6) | 1.23 |
| Fno | 2.26 | TD/(CT2 + T23) | 3.44 |
| HFOV [deg.] | 13.5 | (CT2 + CT3)/CT1 | 0.91 |
| TL/ImgH | 5.85 | CT2/T34 | 0.90 |
| TD/BL | 0.26 | N1 | 1.544 |
| SD/TD | 0.38 | V2 | 22.5 |
| \|f2/f4\| | 0.39 | V1/V2 | 2.49 |
| \|f12/f4\| | 0.19 | V3/V4 | 0.39 |
| \|f/R4\| + \|f/R5\| | 0.78 | ET2/CT2 | 0.45 |
| (R1 + R4)/(R1 − R4) | −2.11 | ET2/ET3 | 0.35 |
| (R1 − R5)/(R1 + R5) | −1.58 | Sag3R1/CT3 | 0.73 |
| f/f3 | −3.26 | — | — |

### 7th Embodiment

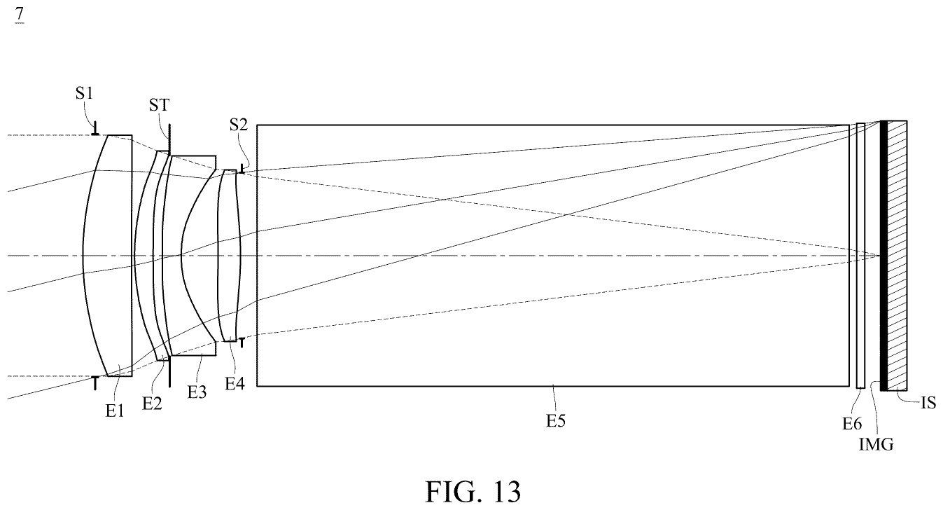

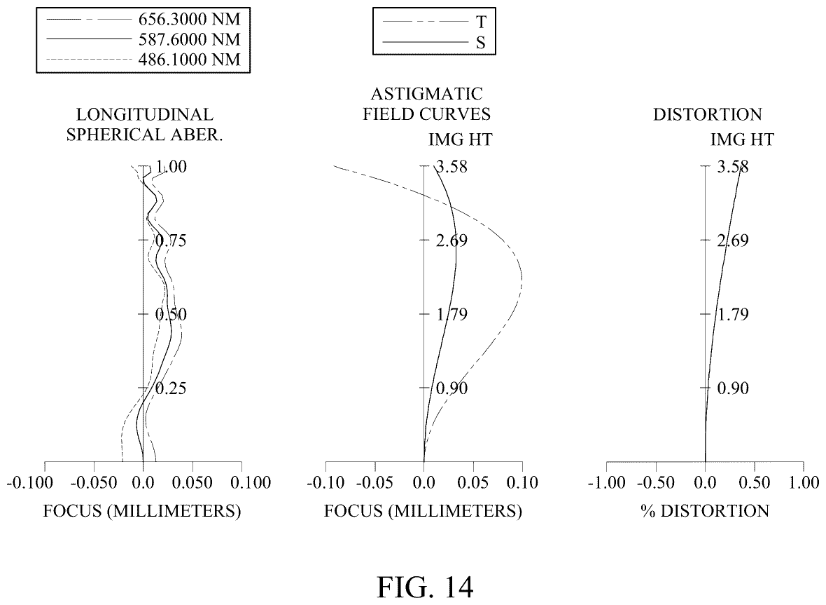

FIG. 13 is a schematic view of an image capturing unit according to the 7th embodiment of the present disclosure. FIG. 14 shows, in order from left to right, spherical aberration curves, astigmatic field curves and a distortion curve of the image capturing unit according to the 7th embodiment. In FIG. 13, the image capturing unit 7 includes the photographing optical lens system (its reference numeral is omitted) of the present disclosure and an image sensor IS. The photographing optical lens system includes, in order from an object side to an image side along an optical path, a stop S1, a first lens element E1, a second lens element E2, an aperture stop ST, a third lens element E3, a fourth lens element E4, a stop S2, a reflective element E5, a filter E6 and an image surface IMG. The photographing optical lens system includes four lens elements (E1, E2, E3 and E4) with no additional lens element disposed between each of the adjacent four lens elements.

The first lens element E1 with positive refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with positive refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has three inflection points.

The third lens element E3 with negative refractive power has an object-side surface being concave in a paraxial region thereof and an image-side surface being concave in a paraxial region thereof. The third lens element E3 is made of plastic material and has the object-side surface and the image-side surface being both aspheric. The object-side surface of the third lens element E3 has three inflection points. The object-side surface of the third lens element E3 has one convex critical point in an off-axis region thereof.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has one inflection point. The object-side surface of the fourth lens element E4 has one convex critical point in an off-axis region thereof. The image-side surface of the fourth lens element E4 has one concave critical point in an off-axis region thereof.

The reflective element E5 is made of glass material and located between the fourth lens element E4 and the image surface IMG along the optical axis, and will not affect the focal length of the photographing optical lens system. The reflective element E5 is a prism with an optical path folding function. For simplicity in illustration, FIG. 13 does not show the deflection effect caused by the reflective element E5 on the optical path. However, the reflective element E5 can have various configurations depending on actual design requirements, thereby causing different deflection effects on the optical path. Moreover, the reflective element E5 of this embodiment can have a configuration similar to, for example, one of the configurations shown in FIG. 41 to FIG. 47, which can be referred to foregoing descriptions corresponding to FIG. 41 to FIG. 47, and the details in this regard will not be provided again. Furthermore, the reflective element E5 of this embodiment can have a configuration similar to, for example, the configuration shown in FIG. 38, deflecting the optical path five times, which can be referred to foregoing descriptions corresponding to FIG. 38, and the details in this regard will not be provided again.

The filter E6 is made of glass material and located between the reflective element E5 and the image surface IMG, and will not affect the focal length of the photographing optical lens system. The image sensor IS is disposed on or near the image surface IMG of the photographing optical lens system.

The detailed optical data of the 7th embodiment are shown in Table 7A and the aspheric surface data are shown in Table 7B below.

TABLE 7A
7th Embodiment
f = 14.56 mm, Fno = 2.27, HFOV = 13.7 deg.

| Surface # | | Curvature Radius | | Thickness | Material | Index | Abbe # | Focal Length |
|---|---|---|---|---|---|---|---|---|
| 0 | Object | Plano | | Infinity | | | | |
| 1 | Stop | Plano | | −0.326 | | | | |
| 2 | Lens 1 | 7.9984 | (SPH) | 1.295 | Glass | 1.954 | 32.3 | 8.51 |
| 3 | | 515.6319 | (SPH) | 0.079 | | | | |
| 4 | Lens 2 | 5.3363 | (ASP) | 0.496 | Plastic | 1.587 | 28.3 | 11.40 |
| 5 | | 25.3762 | (ASP) | 0.441 | | | | |
| 6 | Ape. Stop | Plano | | −0.197 | | | | |
| 7 | Lens 3 | −103.0649 | (ASP) | 0.502 | Plastic | 1.660 | 20.4 | −4.91 |
| 8 | | 3.3536 | (ASP) | 0.979 | | | | |
| 9 | Lens 4 | −14.8684 | (ASP) | 0.595 | Plastic | 1.544 | 56.0 | 31.84 |
| 10 | | −8.1139 | (ASP) | 0.040 | | | | |

| | | | | | | | |
|---|---|---|---|---|---|---|---|
| 11 | Stop | Plano | 0.400 | | | | |
| 12 | Prism | Plano | 15.750 | Glass | 1.804 | 46.6 | — |
| 13 | | Plano | 0.200 | | | | |
| 14 | Filter | Plano | 0.210 | Glass | 1.517 | 64.2 | — |
| 15 | | Plano | 0.427 | | | | |
| 16 | Image | Plano | — | | | | |

Note:
Reference wavelength is 587.6 nm (d-line).
An effective radius of the stop S1 (Surface 1) is 3.232 mm.
An effective radius of the stop S2 (Surface 11) is 2.205 mm.

TABLE 7B
Aspheric Coefficients

| Surface # | 4 | 5 | 7 | 8 |
|---|---|---|---|---|
| k = | 0.00000000E+00 | 0.00000000E+00 | 0.00000000E+00 | 0.00000000E+00 |
| A4 = | −1.83857902E−02 | −4.22864828E−02 | −1.38500218E−03 | 3.16089405E−02 |
| A6 = | 2.36528771E−03 | 5.33823869E−02 | 7.42548540E−02 | 3.37045712E−02 |
| A8 = | 1.03218861E−02 | −7.74905522E−03 | −7.68976933E−02 | −7.40923564E−02 |
| A10 = | −9.75560509E−03 | −2.44889915E−02 | 3.52600024E−02 | 5.17492736E−02 |
| A12 = | 4.38626207E−03 | 2.30384907E−02 | −7.54355034E−03 | −1.84016569E−02 |
| A14 = | −1.19528153E−03 | −1.09905297E−02 | 7.27208390E−05 | 2.93944238E−03 |
| A16 = | 2.19438346E−04 | 3.41340406E−03 | 3.70986127E−04 | 2.56968735E−04 |
| A18 = | −2.94286035E−05 | −7.37271949E−04 | −9.51891067E−05 | −2.42576647E−04 |
| A20 = | 3.03058128E−06 | 1.11619262E−04 | 1.08165118E−05 | 5.87833097E−05 |
| A22 = | −2.32275185E−07 | −1.15510350E−05 | −3.58811251E−07 | −7.79380939E−06 |
| A24 = | 1.14499115E−08 | 7.71617112E−07 | −4.91079599E−08 | 5.71966377E−07 |
| A26 = | −2.60812259E−10 | −2.96674178E−08 | 5.76237321E−09 | −1.82234328E−08 |
| A28 = | — | 4.92004862E−10 | −1.87884667E−10 | — |

| Surface # | 9 | 10 |
|---|---|---|
| k = | 0.00000000E+00 | 0.00000000E+00 |
| A4 = | 3.00812886E−02 | 1.85881754E−02 |
| A6 = | −5.57499188E−03 | −9.44834384E−03 |
| A8 = | −3.73450580E−03 | 8.39100564E−03 |
| A10 = | 3.07069504E−03 | −9.31399559E−03 |
| A12 = | −1.29185253E−03 | 7.44863919E−03 |
| A14 = | 6.15289185E−04 | −3.96524672E−03 |
| A16 = | −2.68121011E−04 | 1.46072260E−03 |
| A18 = | 7.48808728E−05 | −3.79305065E−04 |
| A20 = | −1.21388303E−05 | 6.83407236E−05 |
| A22 = | 1.06297929E−06 | −8.10213030E−06 |
| A24 = | −4.13138137E−08 | 5.65234628E−07 |
| A26 = | 2.72603953E−10 | −1.74951793E−08 |

In the 7th embodiment, the equation of the aspheric surface profiles of the aforementioned lens elements is the same as the equation of the 1st embodiment. Also, the definitions of these parameters shown in Table 7C below are the same as those stated in the 1st embodiment with corresponding values for the 7th embodiment, so an explanation in this regard will not be provided again.

Moreover, these parameters can be calculated from Table 7A and Table 7B as the following values and satisfy the following conditions:

TABLE 7C
Values of Optical and Physical Parameters/Definitions

| | | | |
|---|---|---|---|
| f [mm] | 14.56 | (R4 + R6)/(R4 − R6) | 1.30 |
| Fno | 2.27 | TD/(CT2 + T23) | 5.66 |
| HFOV [deg.] | 13.7 | (CT2 + CT3)/CT1 | 0.77 |
| TL/ImgH | 5.92 | CT2/T34 | 0.51 |
| TD/BL | 0.25 | N1 | 1.954 |
| SD/TD | 0.45 | V2 | 28.3 |
| \|f2/f4\| | 0.36 | V1/V2 | 1.14 |
| \|f12/f4\| | 0.16 | V3/V4 | 0.36 |
| \|f/R4\| + \|f/R5\| | 0.72 | ET2/CT2 | 0.63 |
| (R1 + R4)/(R1 − R4) | −1.92 | ET2/ET3 | 0.27 |
| (R1 − R5)/(R1 + R5) | −1.17 | Sag3R1/CT3 | 0.53 |
| f/f3 | −2.97 | — | — |

### 8th Embodiment

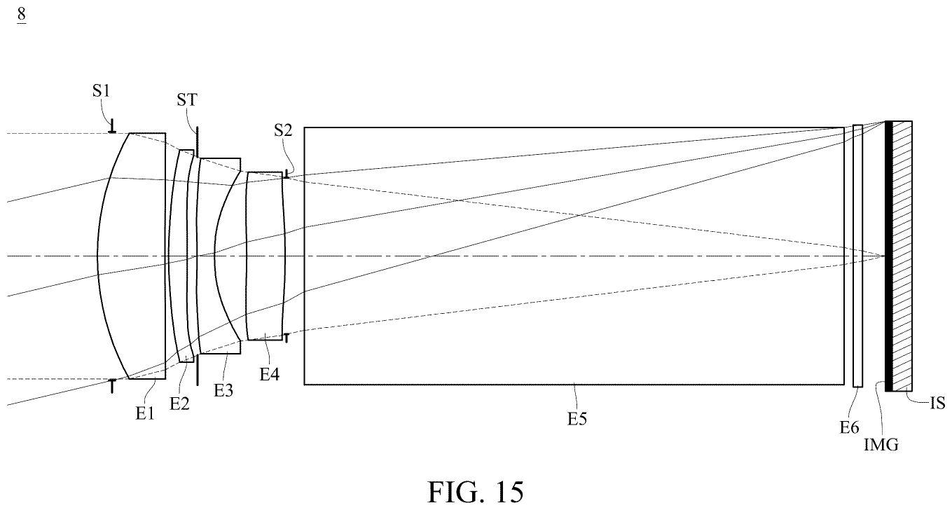

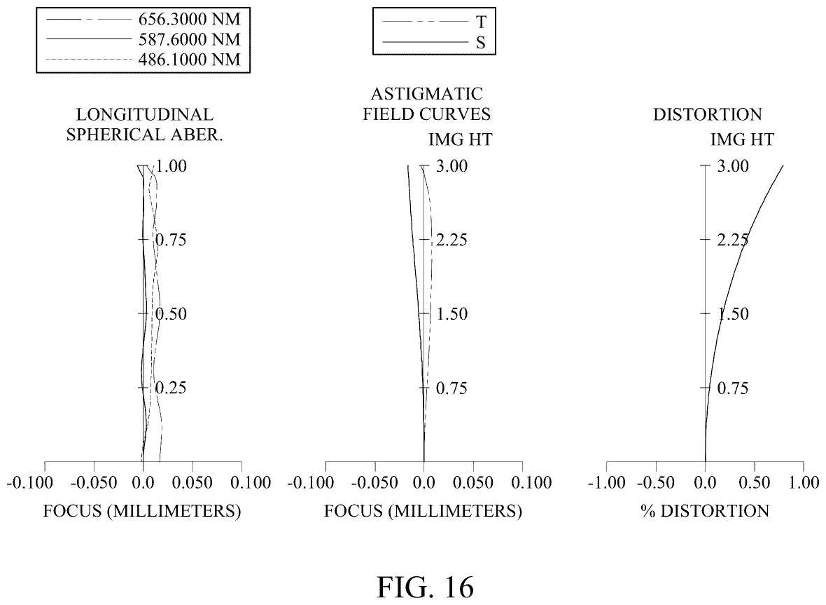

FIG. 15 is a schematic view of an image capturing unit according to the 8th embodiment of the present disclosure. FIG. 16 shows, in order from left to right, spherical aberration curves, astigmatic field curves and a distortion curve of the image capturing unit according to the 8th embodiment. In FIG. 15, the image capturing unit 8 includes the photographing optical lens system (its reference numeral is omitted) of the present disclosure and an image sensor IS. The photographing optical lens system includes, in order from an object side to an image side along an optical path, a stop S1, a first lens element E1, a second lens element E2, an aperture stop ST, a third lens element E3, a fourth lens element E4, a stop S2, a reflective element E5, a filter E6 and an image surface IMG. The photographing optical lens system includes four lens elements (E1, E2, E3 and E4) with no additional lens element disposed between each of the adjacent four lens elements.

The first lens element E1 with positive refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with positive refractive power has an object-side surface being convex in a paraxial region thereof and an image-side surface being convex in a paraxial region thereof. The second lens element E2 is made of plastic material and has the object-side surface and the image-side surface being both aspheric. The object-side surface of the second lens element E2 has one inflection point. The image-side surface of the second lens element E2 has one inflection point. The image-side surface of the second lens element E2 has one concave critical point in an off-axis region thereof.

The third lens element E3 with negative refractive power has an object-side surface being concave in a paraxial region thereof and an image-side surface being concave in a paraxial region thereof. The third lens element E3 is made of plastic material and has the object-side surface and the image-side surface being both aspheric. The object-side surface of the third lens element E3 has three inflection points. The object-side surface of the third lens element E3 has one convex critical point in an off-axis region thereof.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has one inflection point. The object-side surface of the fourth lens element E4 has one convex critical point in an off-axis region thereof.

The reflective element E5 is made of glass material and located between the fourth lens element E4 and the image surface IMG along the optical axis, and will not affect the focal length of the photographing optical lens system. The reflective element E5 is a prism with an optical path folding function. For simplicity in illustration, FIG. 15 does not show the deflection effect caused by the reflective element E5 on the optical path. However, the reflective element E5 can have various configurations depending on actual design requirements, thereby causing different deflection effects on the optical path. Moreover, the reflective element E5 of this embodiment can have a configuration similar to, for example, one of the configurations shown in FIG. 41 to FIG. 47, which can be referred to foregoing descriptions corresponding to FIG. 41 to FIG. 47, and the details in this regard will not be provided again. Furthermore, the reflective element E5 of this embodiment can have a configuration similar to, for example, the configuration shown in FIG. 38, deflecting the optical path five times, which can be referred to foregoing descriptions corresponding to FIG. 38, and the details in this regard will not be provided again.

The filter E6 is made of glass material and located between the reflective element E5 and the image surface IMG, and will not affect the focal length of the photographing optical lens system. The image sensor IS is disposed on or near the image surface IMG of the photographing optical lens system.

The detailed optical data of the 8th embodiment are shown in Table 8A and the aspheric surface data are shown in Table 8B below.

TABLE 8A
8th Embodiment
f = 12.54 mm, Fno = 2.29, HFOV = 13.3 deg.

| Surface # | | Curvature Radius | | Thickness | Material | Index | Abbe # | Focal Length |
|---|---|---|---|---|---|---|---|---|
| 0 | Object | Plano | | Infinity | | | | |
| 1 | Stop | Plano | | −0.326 | | | | |
| 2 | Lens 1 | 5.6323 | (SPH) | 1.500 | Glass | 1.911 | 35.2 | 6.29 |
| 3 | | 301.8005 | (SPH) | 0.084 | | | | |
| 4 | Lens 2 | 8.6569 | (ASP) | 0.413 | Plastic | 1.614 | 25.6 | 13.76 |
| 5 | | −335.0991 | (ASP) | 0.228 | | | | |
| 6 | Ape. Stop | Plano | | −0.008 | | | | |
| 7 | Lens 3 | −14.9793 | (ASP) | 0.387 | Plastic | 1.669 | 19.5 | −4.78 |
| 8 | | 4.1131 | (ASP) | 0.716 | | | | |
| 9 | Lens 4 | −15.3886 | (ASP) | 0.855 | Plastic | 1.544 | 56.0 | 68.76 |
| 10 | | −11.1166 | (ASP) | 0.030 | | | | |

| | | | | | | | |
|---|---|---|---|---|---|---|---|
| 11 | Stop | Plano | 0.400 | | | | |
| 12 | Prism | Plano | 12.000 | Glass | 1.804 | 46.6 | — |
| 13 | | Plano | 0.200 | | | | |
| 14 | Filter | Plano | 0.210 | Glass | 1.517 | 64.2 | — |
| 15 | | Plano | 0.514 | | | | |
| 16 | Image | Plano | — | | | | |

Note:
Reference wavelength is 587.6 nm (d-line).
An effective radius of the stop S1 (Surface 1) is 2.763 mm.
An effective radius of the stop S2 (Surface 11) is 1.739 mm.

TABLE 8B
Aspheric Coefficients

| Surface # | 4 | 5 | 7 | 8 |
|---|---|---|---|---|
| k = | 0.00000000E+00 | 0.00000000E+00 | 0.00000000E+00 | 0.00000000E+00 |
| A4 = | −1.83857247E−02 | −4.22864319E−02 | −8.73832590E−03 | 2.12472987E−02 |
| A6 = | 2.36497922E−03 | 5.33820501E−02 | 1.02598837E−01 | 6.00376639E−02 |
| A8 = | 1.03225015E−02 | −7.74817556E−03 | −1.14778575E−01 | −9.61850581E−02 |
| A10 = | −9.75627677E−03 | −2.44902317E−02 | 7.03072506E−02 | 6.83537627E−02 |
| A12 = | 4.38671204E−03 | 2.30395655E−02 | −3.35690068E−02 | −3.68316101E−02 |
| A14 = | −1.19547805E−03 | −1.09911425E−02 | 1.54791060E−02 | 2.13098113E−02 |
| A16 = | 2.19496011E−04 | 3.41364257E−03 | −6.50391847E−03 | −1.18570519E−02 |
| A18 = | −2.94400637E−05 | −7.37336387E−04 | 2.12841818E−03 | 4.93074960E−03 |
| A20 = | 3.03210312E−06 | 1.11631345E−04 | −4.98187819E−04 | −1.37879313E−03 |
| A22 = | −2.32404494E−07 | −1.15525775E−05 | 7.99116103E−05 | 2.45033796E−04 |
| A24 = | 1.14562678E−08 | 7.71745007E−07 | −8.35284015E−06 | −2.50948329E−05 |
| A26 = | −2.60949720E−10 | −2.96736264E−08 | 5.13784763E−07 | 1.13035784E−06 |
| A28 = | — | 4.92138769E−10 | −1.41418137E−08 | — |

| Surface # | 9 | 10 |
|---|---|---|
| k = | 0.00000000E+00 | 0.00000000E+00 |
| A4 = | 1.32263072E−02 | 7.50309516E−03 |
| A6 = | 1.12688940E−02 | −4.38835781E−04 |
| A8 = | −1.31266370E−02 | 1.05682628E−02 |
| A10 = | 5.82052132E−03 | −2.82748709E−02 |
| A12 = | −1.36020617E−03 | 3.85097459E−02 |
| A14 = | 4.10007734E−04 | −3.33743255E−02 |
| A16 = | −2.44051400E−04 | 1.96643652E−02 |
| A18 = | 1.18430818E−04 | −7.97895084E−03 |
| A20 = | −4.38649973E−05 | 2.19284524E−03 |
| A22 = | 1.16395164E−05 | −3.89425121E−04 |
| A24 = | −1.79692833E−06 | 4.02921158E−05 |
| A26 = | 1.16192513E−07 | −1.84394430E−06 |

In the 8th embodiment, the equation of the aspheric surface profiles of the aforementioned lens elements is the same as the equation of the 1st embodiment. Also, the definitions of these parameters shown in Table 8C below are the same as those stated in the 1st embodiment with corresponding values for the 8th embodiment, so an explanation in this regard will not be provided again.

Moreover, these parameters can be calculated from Table 8A and Table 8B as the following values and satisfy the following conditions:

TABLE 8C
Values of Optical and Physical Parameters/Definitions

| | | | |
|---|---|---|---|
| f[mm] | 12.54 | (R4 + R6)/(R4 − R6) | 0.98 |
| Fno | 2.29 | TD/(CT2 + T23) | 6.60 |
| HFOV [deg.] | 13.3 | (CT2 + CT3)/CT1 | 0.53 |
| TL/ImgH | 5.84 | CT2/T34 | 0.58 |
| TD/BL | 0.31 | N1 | 1.911 |
| SD/TD | 0.47 | V2 | 25.6 |
| \|f2/f4\| | 0.20 | V1/V2 | 1.38 |
| \|f12/f4\| | 0.07 | V3/V4 | 0.35 |
| \|f/R4\| + \|f/R5\| | 0.87 | ET2/CT2 | 0.75 |
| (R1 + R4)/(R1 − R4) | −0.97 | ET2/ET3 | 0.35 |
| (R1 − R5)/(R1 + R5) | −2.21 | Sag3R1/CT3 | 0.21 |
| f/f3 | −2.62 | — | — |

### 9th Embodiment

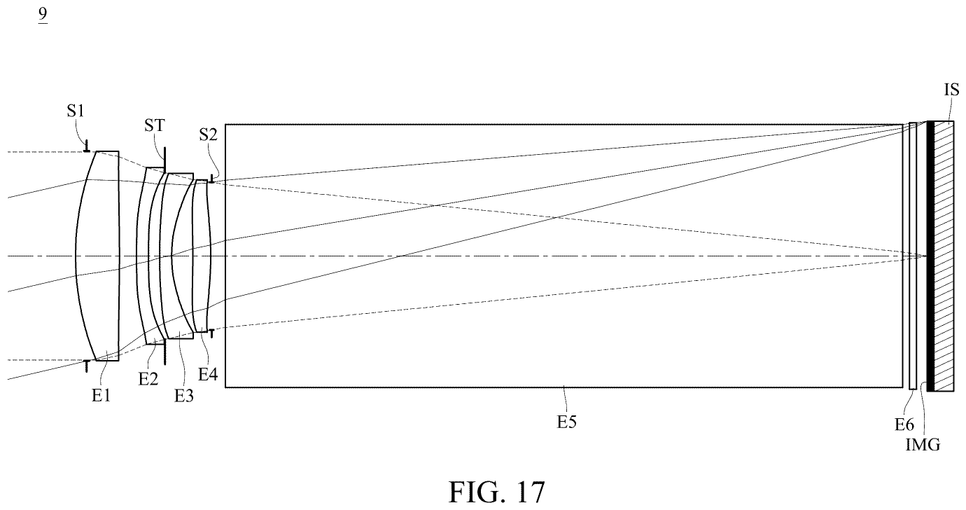

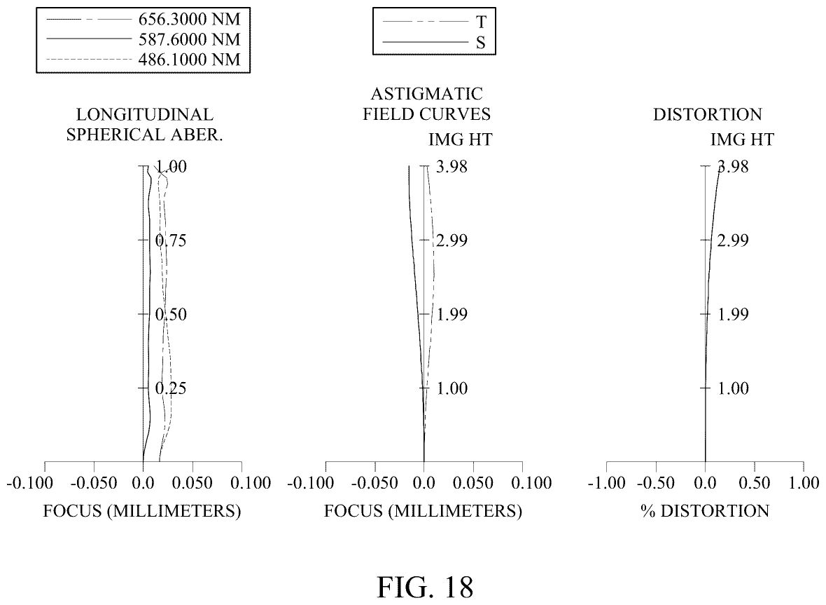

FIG. 17 is a schematic view of an image capturing unit according to the 9th embodiment of the present disclosure. FIG. 18 shows, in order from left to right, spherical aberration curves, astigmatic field curves and a distortion curve of the image capturing unit according to the 9th embodiment. In FIG. 17, the image capturing unit 9 includes the photographing optical lens system (its reference numeral is omitted) of the present disclosure and an image sensor IS. The photographing optical lens system includes, in order from an object side to an image side along an optical path, a stop S1, a first lens element E1, a second lens element E2, an aperture stop ST, a third lens element E3, a fourth lens element E4, a stop S2, a reflective element E5, a filter E6 and an image surface IMG. The photographing optical lens system includes four lens elements (E1, E2, E3 and E4) with no additional lens element disposed between each of the adjacent four lens elements.

The first lens element E1 with positive refractive power has an object-side surface being convex in a paraxial region thereof and an image-side surface being convex in a paraxial region thereof. The first lens element E1 is made of glass material and has the object-side surface and the image-side surface being both aspheric. The image-side surface of the first lens element E1 has one inflection point. The image-side surface of the first lens element E1 has one concave critical point in an off-axis region thereof.

The second lens element E2 with positive refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has one inflection point.

The third lens element E3 with negative refractive power has an object-side surface being concave in a paraxial region thereof and an image-side surface being concave in a paraxial region thereof. The third lens element E3 is made of plastic material and has the object-side surface and the image-side surface being both aspheric. The object-side surface of the third lens element E3 has two inflection points. The object-side surface of the third lens element E3 has one convex critical point in an off-axis region thereof.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has one inflection point. The object-side surface of the fourth lens element E4 has one convex critical point in an off-axis region thereof. The image-side surface of the fourth lens element E4 has one concave critical point in an off-axis region thereof.

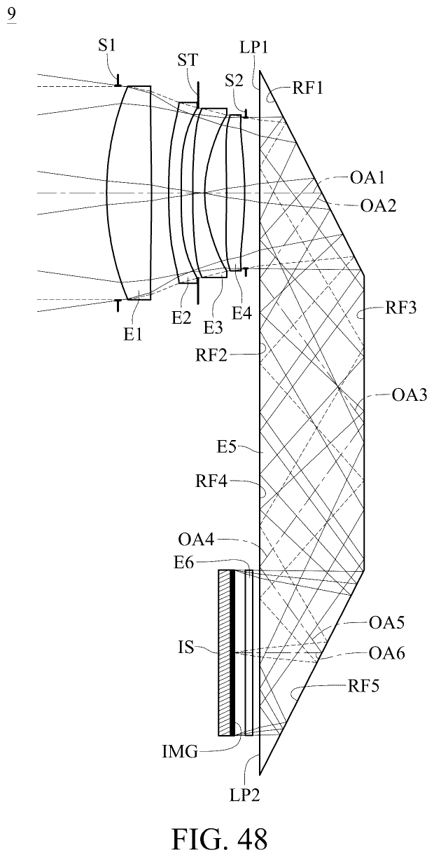

The reflective element E5 is made of glass material and located between the fourth lens element E4 and the image surface IMG along the optical axis, and will not affect the focal length of the photographing optical lens system. The reflective element E5 is a prism with an optical path folding function. For simplicity in illustration, FIG. 17 does not show the deflection effect caused by the reflective element E5 on the optical path. However, the reflective element E5 can have various configurations depending on actual design requirements, thereby causing different deflection effects on the optical path. For example, please refer to FIG. 48, which shows a schematic view of a configuration of another reflective element and its associated light path deflection in the image capturing unit according to the 9th embodiment. In FIG. 48, the reflective element E5 has, in sequence along a travelling direction of light on the optical path, a first light permeable surface LP1, a first reflective surface RF1, a second reflective surface RF2, a third reflective surface RF3, a fourth reflective surface RF4, a fifth reflective surface RF5 and a second light permeable surface LP2. The first reflective surface RF1 deflects the optical path from a first optical axis OA1 to a second optical axis OA2, the second reflective surface RF2 deflects the optical path from the second optical axis OA2 to a third optical axis OA3, the third reflective surface RF3 deflects the optical path from the third optical axis OA3 to a fourth optical axis OA4, the fourth reflective surface RF4 deflects the optical path from the fourth optical axis OA4 to a fifth optical axis OA5, the fifth reflective surface RF5 deflects the optical path from the fifth optical axis OA5 to a sixth optical axis OA6, and the optical path arrives at the image surface IMG along the sixth optical axis OA6. In FIG. 48, the reflective element E5 deflects the optical path five times, where an angle between a vector of the optical axis at the object side (e.g., the first optical axis OA1) and a vector of the optical axis at the image side (e.g., the sixth optical axis OA6) can be 180 degrees. Moreover, the reflective element E5 of this embodiment can have a configuration similar to, for example, one of the configurations shown in FIG. 41 to FIG. 47, which can be referred to foregoing descriptions corresponding to FIG. 41 to FIG. 47, and the details in this regard will not be provided again.

The filter E6 is made of glass material and located between the reflective element E5 and the image surface IMG, and will not affect the focal length of the photographing optical lens system. The image sensor IS is disposed on or near the image surface IMG of the photographing optical lens system.

The detailed optical data of the 9th embodiment are shown in Table 9A and the aspheric surface data are shown in Table 9B below.

TABLE 9A
9th Embodiment
f = 17.21 mm, Fno = 2.80, HFOV = 13.0 deg.

| Surface # | | Curvature Radius | | Thickness | Material | Index | Abbe # | Focal Length |
|---|---|---|---|---|---|---|---|---|
| 0 | Object | Plano | | Infinity | | | | |
| 1 | Stop | Plano | | −0.326 | | | | |
| 2 | Lens 1 | 7.8785 | (ASP) | 1.295 | Glass | 1.954 | 32.3 | 7.72 |
| 3 | | −104.0422 | (ASP) | 0.502 | | | | |
| 4 | Lens 2 | 15.5091 | (ASP) | 0.360 | Plastic | 1.639 | 23.5 | 33.11 |
| 5 | | 57.6578 | (ASP) | 0.488 | | | | |
| 6 | Ape. Stop | Plano | | −0.156 | | | | |
| 7 | Lens 3 | −53.0407 | (ASP) | 0.350 | Plastic | 1.669 | 19.5 | −6.16 |
| 8 | | 4.4816 | (ASP) | 0.625 | | | | |
| 9 | Lens 4 | −23.3445 | (ASP) | 0.526 | Plastic | 1.544 | 56.0 | 31.36 |
| 10 | | −9.9356 | (ASP) | 0.030 | | | | |

| | | | | | | | |
|---|---|---|---|---|---|---|---|
| 11 | Stop | Plano | 0.400 | | | | |
| 12 | Prism | Plano | 20.000 | Glass | 1.804 | 46.6 | — |
| 13 | | Plano | 0.200 | | | | |
| 14 | Filter | Plano | 0.210 | Glass | 1.517 | 64.2 | — |
| 15 | | Plano | 0.320 | | | | |
| 16 | Image | Plano | — | | | | |

Note:
Reference wavelength is 587.6 nm (d-line).
An effective radius of the stop S1 (Surface 1) is 3.100 mm.
An effective radius of the stop S2 (Surface 11) is 2.179 mm.

TABLE 9B
Aspheric Coefficients

| Surface # | 2 | 3 | 4 | 5 |
|---|---|---|---|---|
| k = | −2.11008000E−01 | 2.01555000E+01 | −6.14001000E+00 | −2.82868000E+01 |
| A4 = | −8.04515054E−04 | −5.17055372E−03 | −2.01020064E−02 | 1.16908272E−02 |
| A6 = | 2.73677131E−04 | 4.36209605E−03 | 3.09176530E−02 | 2.11731275E−02 |
| A8 = | −1.69738373E−05 | −1.72585811E−03 | −2.13522538E−02 | −3.45405983E−02 |
| A10 = | −1.70723939E−05 | 4.09918997E−04 | 1.04805551E−02 | 3.16442300E−02 |
| A12 = | 5.94389394E−06 | −6.15279909E−05 | −3.93832906E−03 | −1.99034959E−02 |
| A14 = | −9.26433291E−07 | 5.83384022E−06 | 1.15310569E−03 | 9.20853684E−03 |
| A16 = | 7.87222562E−08 | −3.34070810E−07 | −2.69221922E−04 | −3.20731623E−03 |
| A18 = | −3.52545814E−09 | 1.03174861E−08 | 5.13871747E−05 | 8.35560277E−04 |
| A20 = | 6.52411414E−11 | −1.26582112E−10 | −7.99490285E−06 | −1.58838330E−04 |
| A22 = | — | — | 9.61397699E−07 | 2.11876434E−05 |
| A24 = | — | — | −8.10916546E−08 | −1.86540419E−06 |
| A26 = | — | — | 4.15039610E−09 | 9.68563514E−08 |
| A28 = | — | — | −9.54039676E−11 | −2.23872549E−09 |
| Surface # | 7 | 8 | 9 | 10 |
| k = | 0.00000000E+00 | 0.00000000E+00 | 0.00000000E+00 | 0.00000000E+00 |
| A4 = | 7.95821459E−02 | 6.27655715E−02 | 1.42951585E−02 | 5.79657909E−03 |
| A6 = | −8.02866781E−02 | −8.32940922E−02 | −1.02011303E−02 | −2.94407425E−03 |
| A8 = | 4.27471919E−02 | 5.58946547E−02 | 8.88203869E−03 | 4.15901276E−03 |
| A10 = | −1.04496816E−02 | −2.33387505E−02 | −8.49610562E−03 | −5.02568453E−03 |
| A12 = | −8.72712439E−04 | 7.27011779E−03 | 7.61198822E−03 | 4.65726395E−03 |
| A14 = | 1.57724588E−03 | −2.35700439E−03 | −4.81901841E−03 | −2.93541859E−03 |
| A16 = | −6.06538191E−04 | 8.59845596E−04 | 2.03267900E−03 | 1.24397036E−03 |
| A18 = | 1.43504108E−04 | −2.59026299E−04 | −5.72674568E−04 | −3.55785921E−04 |
| A20 = | −2.42494041E−05 | 5.31549476E−05 | 1.07249516E−04 | 6.79718590E−05 |
| A22 = | 2.99981886E−06 | −6.87091954E−06 | −1.28896779E−05 | −8.33489535E−06 |
| A24 = | −2.57802169E−07 | 5.07421666E−07 | 9.03222049E−07 | 5.94278816E−07 |
| A26 = | 1.35318539E−08 | −1.64093952E−08 | −2.81178852E−08 | −1.87487953E−08 |
| A28 = | −3.21650948E−10 | — | — | — |

In the 9th embodiment, the equation of the aspheric surface profiles of the aforementioned lens elements is the same as the equation of the 1st embodiment. Also, the definitions of these parameters shown in Table 9C below are the same as those stated in the 1st embodiment with corresponding values for the 9th embodiment, so an explanation in this regard will not be provided again.

Moreover, these parameters can be calculated from Table 9A and Table 9B as the following values and satisfy the following conditions:

TABLE 9C
Values of Optical and Physical Parameters/Definitions

| | | | |
|---|---|---|---|
| f[mm] | 17.21 | (R4 + R6)/(R4 − R6) | 1.17 |
| Fno | 2.80 | TD/(CT2 + T23) | 5.77 |
| HFOV [deg.] | 13.0 | (CT2 + CT3)/CT1 | 0.55 |
| TL/ImgH | 6.32 | CT2/T34 | 0.58 |
| TD/BL | 0.19 | N1 | 1.954 |
| SD/TD | 0.34 | V2 | 23.5 |
| \|f2/f4] | 1.06 | V1/V2 | 1.37 |
| \|f12/f4 | 0.20 | V3/V4 | 0.35 |
| \|f/R4\| + \|f/R5\| | 0.62 | ET2/CT2 | 1.46 |
| (R1 + R4)/(R1 − R4) | −1.32 | ET2/ET3 | 0.73 |
| (R1 − R5)/(R1 + R5) | −1.35 | Sag3R1/CT3 | 0.75 |
| f/f3 | −2.79 | — | — |

### 10th Embodiment

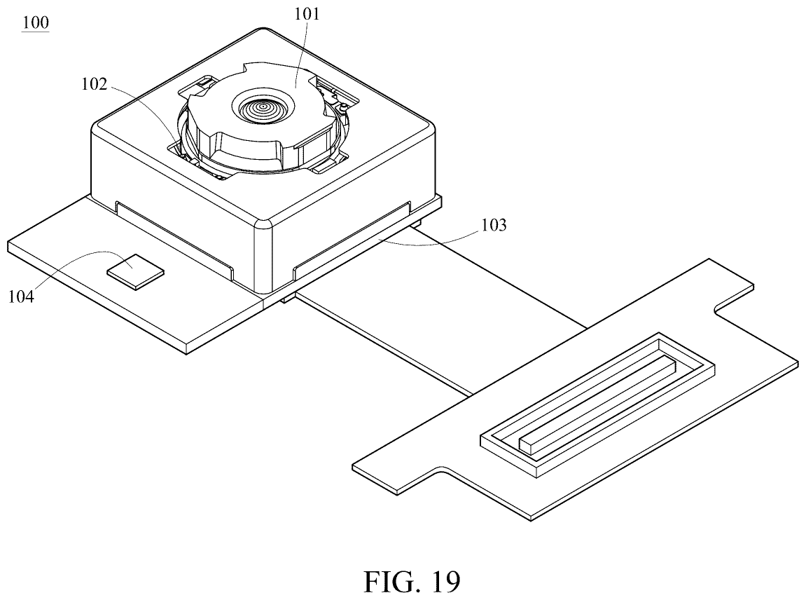

FIG. 19 is a perspective view of an image capturing unit according to the 10th embodiment of the present disclosure. In this embodiment, an image capturing unit 100 is a camera module including a lens unit 101, a driving device 102, an image sensor 103 and an image stabilizer 104. The lens unit 101 includes the photographing optical lens system as disclosed in the 1st embodiment, a barrel and a holder member (their reference numerals are omitted) for holding the photographing optical lens system. However, the lens unit 101 may alternatively be provided with the photographing optical lens system as disclosed in other embodiments of the present disclosure, and the present disclosure is not limited thereto. The imaging light converges in the lens unit 101 of the image capturing unit 100 to generate an image with the driving device 102 utilized for image focusing on the image sensor 103, and the generated image is then digitally transmitted to other electronic component for further processing.

The driving device 102 can have auto focusing functionality, and different driving configurations can be obtained through the usages of voice coil motors (VCM), micro electro-mechanical systems (MEMS), piezoelectric systems or shape memory alloy materials. The driving device 102 is favorable for obtaining a better imaging position of the lens unit 101, so that a clear image of the imaged object can be captured by the lens unit 101 with different object distances. The image sensor 103 (for example, CMOS or CCD), which can feature high photosensitivity and low noise, is disposed on the image surface of the photographing optical lens system to provide higher image quality.

The image stabilizer 104, such as an accelerometer, a gyro sensor and a Hall Effect sensor, is configured to work with the driving device 102 to provide optical image stabilization (OIS). The driving device 102 working with the image stabilizer 104 is favorable for compensating for pan and tilt of the lens unit 101 to reduce blurring associated with motion during exposure. In some cases, the compensation can be provided by electronic image stabilization (EIS) with image processing software, thereby improving image quality while in motion or low-light conditions.

### 11th Embodiment

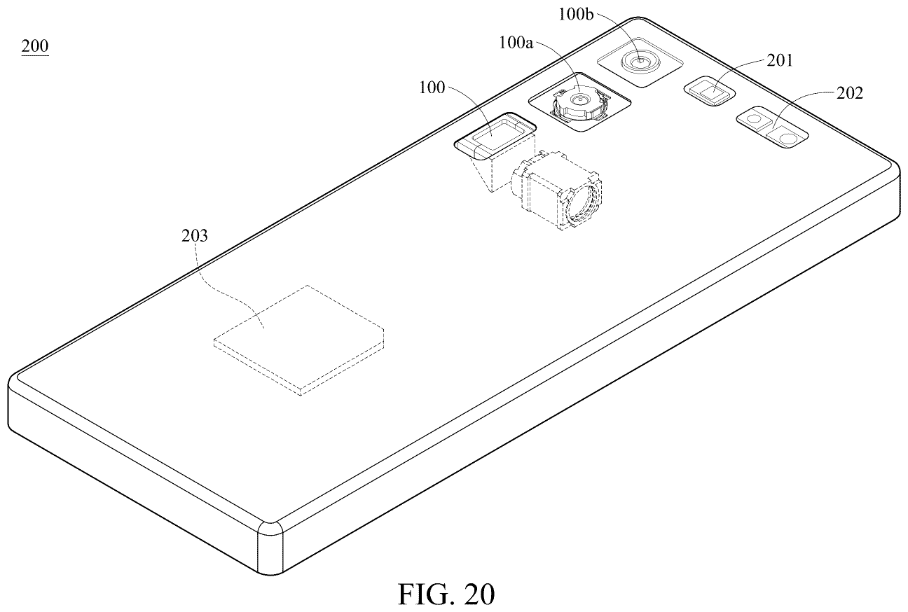

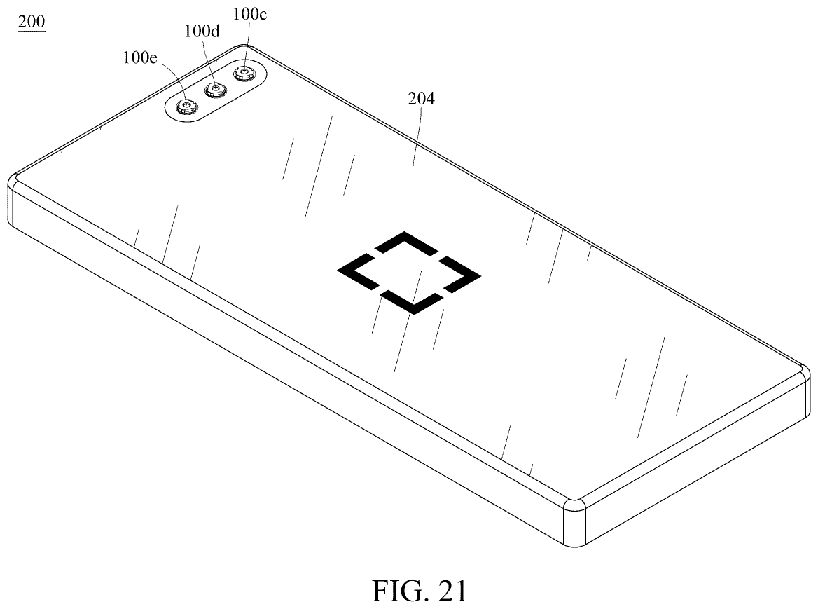

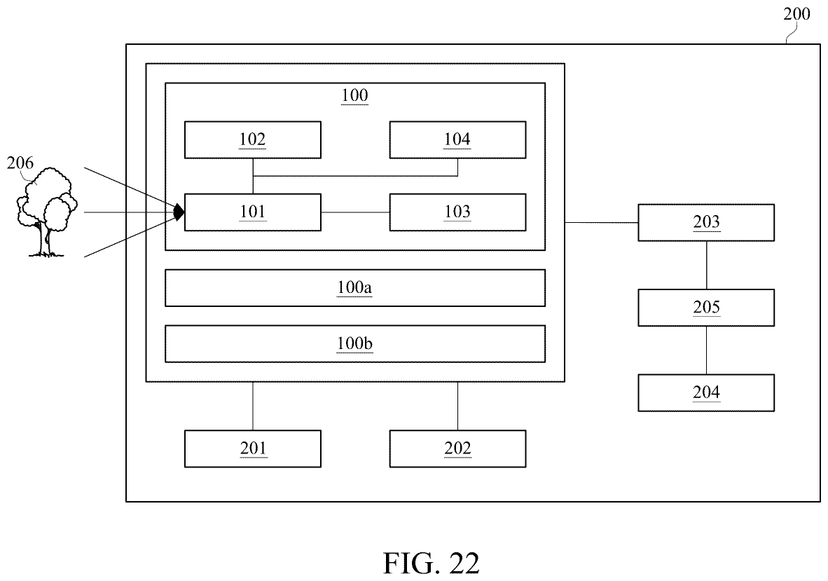

FIG. 20 is one perspective view of an electronic device according to the 11th embodiment of the present disclosure, FIG. 21 is another perspective view of the electronic device in FIG. 20, and FIG. 22 is a block diagram of the electronic device in FIG. 20.

In this embodiment, an electronic device 200 is a smartphone including the image capturing unit 100 as disclosed in the 10th embodiment, an image capturing unit 100a, an image capturing unit 100b, an image capturing unit 100c, an image capturing unit 100d, an image capturing unit 100e, a flash module 201, a focus assist module 202, an image signal processor 203, a display module 204 and an image software processor 205. The image capturing unit 100, the image capturing unit 100a and the image capturing unit 100b are disposed on the same side of the electronic device 200, and each of the image capturing units 100, 100a and 100b has a single focal point. The focus assist module 202 can be a laser rangefinder or a ToF (time of flight) module, but the present disclosure is not limited thereto. The image capturing unit 100c, the image capturing unit 100d, the image capturing unit 100e and the display module 204 are disposed on the opposite side of the electronic device 200, and the display module 204 can be a user interface, such that the image capturing units 100c, 100d and 100e can be front-facing cameras of the electronic device 200 for taking selfies, but the present disclosure is not limited thereto. Furthermore, each of the image capturing units 100a, 100b, 100c, 100d and 100e can include the photographing optical lens system of the present disclosure and can have a configuration similar to that of the image capturing unit 100. In detail, each of the image capturing units 100a, 100b, 100c, 100d and 100e can include a lens unit, a driving device, an image sensor and an image stabilizer, and can also include a light-folding element for folding optical path. In addition, each lens unit of the image capturing units 100a, 100b, 100c, 100d and 100e can include the photographing optical lens system of the present disclosure, a barrel and a holder member for holding the photographing optical lens system.

The image capturing unit 100 is a telephoto image capturing unit with optical path folding function, the image capturing unit 100a is a wide-angle image capturing unit, the image capturing unit 100b is an ultra-wide-angle image capturing unit, the image capturing unit 100c is a wide-angle image capturing unit, the image capturing unit 100d is an ultra-wide-angle image capturing unit, and the image capturing unit 100e is a ToF image capturing unit. In this embodiment, the image capturing units 100, 100a and 100b have different fields of view, such that the electronic device 200 can have various magnification ratios so as to meet the requirement of optical zoom functionality. In addition, the image capturing unit 100e can determine depth information of the imaged object. Moreover, the light-folding configuration of the image capturing unit 100 can be similar to, for example, one of the configurations as shown in FIG. 30 to FIG. 40, which can be referred to foregoing descriptions corresponding to FIG. 30 to FIG. 40, and the details in this regard will not be provided again. In this embodiment, the electronic device 200 includes multiple image capturing units 100, 100a, 100b, 100c, 100d and 100e, but the present disclosure is not limited to the number and arrangement of image capturing units.

When a user captures images of an object 206, the light rays converge in the image capturing unit 100, the image capturing unit 100a or the image capturing unit 100b to generate images, and the flash module 201 is activated for light supplement. The focus assist module 202 detects the object distance of the imaged object 206 to achieve fast auto focusing. The image signal processor 203 is configured to optimize the captured image to improve image quality. The light beam emitted from the focus assist module 202 can be either conventional infrared or laser. In addition, the light rays may converge in the image capturing unit 100c, 100d or 100e to generate images. The display module 204 can include a touch screen, and the user is able to interact with the display module 204 and the image software processor 205 having multiple functions to capture images and complete image processing. Alternatively, the user may capture images via a physical button. The image processed by the image software processor 205 can be displayed on the display module 204.

### 12th Embodiment

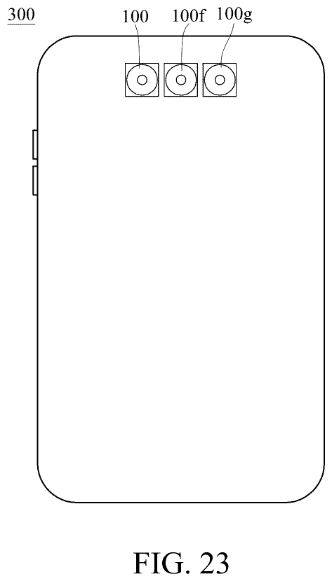

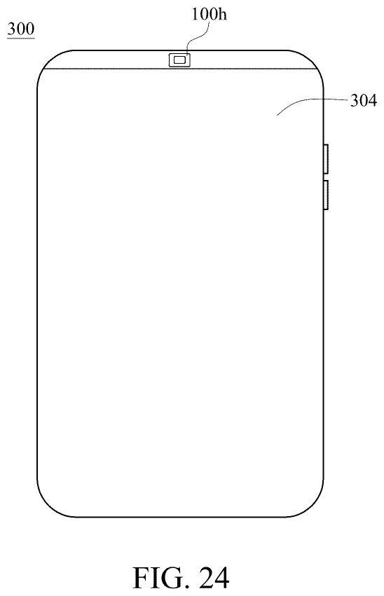

FIG. 23 is one schematic view of an electronic device according to the 12th embodiment of the present disclosure, and FIG. 24 is another schematic view of the electronic device in FIG. 23.

In this embodiment, an electronic device 300 is a smartphone including the image capturing unit 100 as disclosed in the 10th embodiment, an image capturing unit 100f, an image capturing unit 100g, an image capturing unit 100h and a display module 304. As shown in FIG. 23, the image capturing unit 100, the image capturing unit 100f and the image capturing unit 100g are disposed on the same side of the electronic device 300, and each of the image capturing units 100, 100f and 100g has a single focal point. As shown in FIG. 24, the image capturing unit 100h and the display module 304 are disposed on the opposite side of the electronic device 300, such that the image capturing unit 100h can be a front-facing camera of the electronic device 300 for taking selfies, but the present disclosure is not limited thereto. Furthermore, each of the image capturing units 100f, 100g and 100h can include the photographing optical lens system of the present disclosure and can have a configuration similar to that of the image capturing unit 100. In detail, each of the image capturing units 100f, 100g and 100h can include a lens unit, a driving device, an image sensor and an image stabilizer. In addition, each lens unit of the image capturing units 100f, 100g and 100h can include the photographing optical lens system of the present disclosure, a barrel and a holder member for holding the photographing optical lens system.

The image capturing unit 100 is a telephoto image capturing unit, the image capturing unit 100f is a wide-angle image capturing unit, the image capturing unit 100g is an ultra-wide-angle image capturing unit, and the image capturing unit 100h is a wide-angle image capturing unit. In this embodiment, the image capturing units 100, 100f and 100g have different fields of view, such that the electronic device 300 can have various magnification ratios so as to meet the requirement of optical zoom functionality. Moreover, as shown in FIG. 24, the image capturing unit 100h can have a non-circular opening, and the barrel or lens elements in the image capturing unit 100h can have trimmed edges at their outermost positions so as to coordinate with the shape of the non-circular opening. Therefore, the length of the major axis and/or the minor axis of the image capturing unit 100h can be further reduced, which is favorable for reducing the size of the image capturing unit 100h so as to increase the ratio of the area of the display module 304 relative to that of the electronic device 300, and reduce the thickness of the electronic device 300, thereby achieving compactness. In this embodiment, the electronic device 300 includes multiple image capturing units 100, 100f, 100g and 100h, but the present disclosure is not limited to the number and arrangement of image capturing units.

### 13th Embodiment

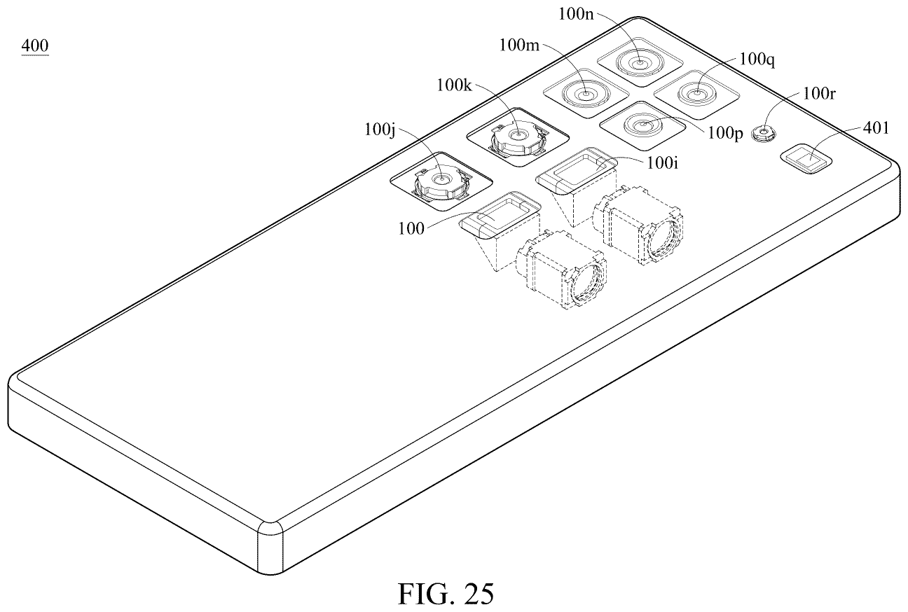

FIG. 25 is one perspective view of an electronic device according to the 13th embodiment of the present disclosure.

In this embodiment, an electronic device 400 is a smartphone including the image capturing unit 100 as disclosed in the 10th embodiment, an image capturing unit 100i, an image capturing unit 100j, an image capturing unit 100k, an image capturing unit 100m, an image capturing unit 100n, an image capturing unit 100p, an image capturing unit 100q, an image capturing unit 100r, a flash module 401, a focus assist module, an image signal processor, a display module and an image software processor (not shown). The image capturing units 100, 100i, 100j, 100k, 100m, 100n, 100p, 100q and 100r are disposed on the same side of the electronic device 400, while the display module is disposed on the opposite side of the electronic device 400. Furthermore, each of the image capturing units 100i, 100j, 100k, 100m, 100n, 100p, 100q and 100r can include the photographing optical lens system of the present disclosure and can have a configuration similar to that of the image capturing unit 100, and the details in this regard will not be provided again.

The image capturing unit 100 is a telephoto image capturing unit with optical path folding function, the image capturing unit 100i is a telephoto image capturing unit with optical path folding function, the image capturing unit 100j is a wide-angle image capturing unit, the image capturing unit 100k is a wide-angle image capturing unit, the image capturing unit 100m is an ultra-wide-angle image capturing unit, the image capturing unit 100n is an ultra-wide-angle telephoto image capturing unit, the image capturing unit 100p is a telephoto image capturing unit, the image capturing unit 100q is a telephoto image capturing unit, and the image capturing unit 100r is a ToF image capturing unit. In this embodiment, the image capturing units 100, 100i, 100j, 100k, 100m, 100n, 100p and 100q have different fields of view, such that the electronic device 400 can have various magnification ratios so as to meet the requirement of optical zoom functionality. In addition, the image capturing unit 100r can determine depth information of the imaged object. Moreover, the light-folding configuration of the image capturing units 100 and 100i can be similar to, for example, one of the structures shown in FIG. 30 to FIG. 40, which can be referred to foregoing descriptions corresponding to FIG. 30 to FIG. 40, and the details in this regard will not be provided again. In this embodiment, the electronic device 400 includes multiple image capturing units 100, 100i, 100j, 100k, 100m, 100n, 100p, 100q and 100r, but the present disclosure is not limited to the number and arrangement of image capturing units. When a user captures images of an object, the light rays converge in the image capturing unit 100, 100i, 100j, 100k, 100m, 100n, 100p, 100q or 100r to generate images, and the flash module 401 is activated for light supplement. Further, the subsequent processes are performed in a manner similar to the abovementioned embodiments, and the details in this regard will not be provided again.

The smartphones in the embodiments are only exemplary for showing the image capturing unit of the present disclosure installed in an electronic device, and the present disclosure is not limited thereto. The image capturing unit can be optionally applied to optical systems with a movable focus. Furthermore, the photographing optical lens system of the image capturing unit features good capability in aberration corrections and high image quality, and can be applied to 3D (three-dimensional) image capturing applications, in products such as digital cameras, mobile devices, digital tablets, smart televisions, network surveillance devices, dashboard cameras, vehicle backup cameras, multi-camera devices, image recognition systems, motion sensing input devices, unmanned aerial vehicles, wearable devices, portable video recorders and other electronic imaging devices.

The foregoing description, for the purpose of explanation, has been described with reference to specific embodiments. It is to be noted that TABLES 1A-9C show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. A photographing optical lens system comprising four lens elements, the four lens elements being, in order from an object side to an image side along an optical path, a first lens element, a second lens element, a third lens element and a fourth lens element, and each of the four lens elements having an object-side surface facing toward the object side and an image-side surface facing toward the image side;
wherein the first lens element has positive refractive power, the object-side surface of the first lens element is convex in a paraxial region thereof, the second lens element has positive refractive power, the object-side surface of the second lens element is convex in a paraxial region thereof, the third lens element has negative refractive power, the image-side surface of the third lens element is concave in a paraxial region thereof, the image-side surface of the fourth lens element is convex in a paraxial region thereof, and at least one surface of at least one lens element in the photographing optical lens system has at least one inflection point;
wherein an axial distance between the object-side surface of the first lens element and the image-side surface of the fourth lens element is TD, an axial distance between the image-side surface of the fourth lens element and an image surface is BL, a focal length of the second lens element is f2, a focal length of the fourth lens element is f4, a central thickness of the first lens element is CT1, a central thickness of the second lens element is CT2, a central thickness of the third lens element is CT3, a curvature radius of the object-side surface of the first lens element is R1, a curvature radius of the object-side surface of the third lens element is R5, and the following conditions are satisfied:
$$\begin{matrix}0.05 < TD / BL < 0 \text{.60} ; \\ 0.05 < \vert f 2 / f 4 \vert < 1.5 ; \\ 0.1 < ( C T 2 + C T 3 ) / C T 1 < 1. ; and \\ - 4.5 < ( R 1 - R 5 ) / ( R 1 + R 5 ) < 0.25 .\end{matrix}$$

2. The photographing optical lens system of claim 1, wherein the fourth lens element has positive refractive power, and at least one of the object-side surface and the image-side surface of the fourth lens element has at least one inflection point.

3. The photographing optical lens system of claim 1, wherein the central thickness of the first lens element is CT1, the central thickness of the second lens element is CT2, the central thickness of the third lens element is CT3, a focal length of the photographing optical lens system is f, a focal length of the third lens element is f3, and the following conditions are satisfied:
$$\begin{matrix}0.3 < ( C T 2 + C T 3 ) / C T 1 < 0.85 ; and \\ - 5. < f / f 3 < - 1.8 .\end{matrix}$$

4. The photographing optical lens system of claim 1, wherein a focal length of the photographing optical lens system is f, a curvature radius of the image-side surface of the second lens element is R4, the curvature radius of the object-side surface of the third lens element is R5, and the following condition is satisfied:
$$0.05 < \vert f / R 4 \vert + \vert f / R 5 \vert < 2.8 .$$

5. The photographing optical lens system of claim 1, wherein a curvature radius of the image-side surface of the second lens element is R4, a curvature radius of the image-side surface of the third lens element is R6, and the following condition is satisfied:
$$0.2 < ( R 4 + R 6 ) / ( R 4 - R 6 ) < 180 .$$

6. The photographing optical lens system of claim 1, wherein an f-number of the photographing optical lens system is Fno, half of a maximum field of view of the photographing optical lens system is HFOV, and the following conditions are satisfied:
$$1.5 < Fno < 2.5 ;$$
$$and$$
$$5. degrees < HVOC < 20. degrees .$$

7. The photographing optical lens system of claim 1, further comprising an aperture stop, wherein an axial distance between the aperture stop and the image-side surface of the fourth lens element is SD, the axial distance between the object-side surface of the first lens element and the image-side surface of the fourth lens element is TD, and the following condition is satisfied:
$$0.05 < SD / TD < 0.90 .$$

8. The photographing optical lens system of claim 1, wherein an Abbe number of the third lens element is V3, an Abbe number of the fourth lens element is V4, and the following condition is satisfied:
$$0.1 < V 3 / V 4 < 0.85 .$$

9. The photographing optical lens system of claim 1, wherein a displacement in parallel with an optical axis from an axial vertex of the object-side surface of the third lens element to a maximum effective radius position of the object-side surface of the third lens element is Sag3R1, the central thickness of the third lens element is CT3, and the following condition is satisfied:
$$- 0.10 < Sag 3 R 1 / CT 3 < 0.80 .$$

10. The photographing optical lens system of claim 1, wherein a distance in parallel with an optical axis between a maximum effective radius position of the object-side surface of the second lens element and a maximum effective radius position of the image-side surface of the second lens element is ET2, the central thickness of the second lens element is CT2, and the following condition is satisfied:
$$0.5 < ET 2 / CT 2 < 1.5 .$$

11. The photographing optical lens system of claim 1, wherein the axial distance between the object-side surface of the first lens element and the image-side surface of the fourth lens element is TD, the axial distance between the image-side surface of the fourth lens element and the image surface is BL, the focal length of the second lens element is f2, the focal length of the fourth lens element is f4, the central thickness of the first lens element is CT1, the central thickness of the second lens element is CT2, the central thickness of the third lens element is CT3, the curvature radius of the object-side surface of the first lens element is R1, the curvature radius of the object-side surface of the third lens element is R5, a refractive index of the first lens element is N1, an Abbe number of the second lens element is V2, an axial distance between the third lens element and the fourth lens element is T34, and the following conditions are satisfied:
$$0.19 \leq TD / BL \leq 0.31 ;$$
$$0.2 \leq \vert f 2 / f 4 \vert \leq 1.14 ;$$
$$0.48 \leq ( CT 2 + CT 3 ) / CT 1 \leq 0.91 ;$$
$$- 2.8 \; 8 \leq ( R 1 - R 5 ) / ( R 1 + R 5 ) \leq - 0 \text{.19} ;$$
$$1.544 \leq N 1 \leq 1.954 ;$$
$$22.5 \leq V 2 \leq 5 6. ;$$
$$and$$
$$0.39 \leq CT 2 / T 34 \leq 0.90 .$$

12. The photographing optical lens system of claim 1, further comprising a reflective element located between the fourth lens element and the image surface along a direction of the optical path.

13. The photographing optical lens system of claim 12, wherein the reflective element has at least two reflective surfaces.

14. An image capturing unit comprising:
the photographing optical lens system of claim 1; and
an image sensor disposed on the image surface of the photographing optical lens system.

15. An electronic device comprising:
the image capturing unit of claim 14.

16. A photographing optical lens system comprising four lens elements, the four lens elements being, in order from an object side to an image side along an optical path, a first lens element, a second lens element, a third lens element and a fourth lens element, and each of the four lens elements having an object-side surface facing toward the object side and an image-side surface facing toward the image side;
wherein the first lens element has positive refractive power, the object-side surface of the first lens element is convex in a paraxial region thereof, the second lens element has positive refractive power, the third lens element has negative refractive power, the image-side surface of the third lens element is concave in a paraxial region thereof, and at least one surface of at least one lens element in the photographing optical lens system has at least one inflection point;
wherein an axial distance between the object-side surface of the first lens element and the image-side surface of the fourth lens element is TD, an axial distance between the image-side surface of the fourth lens element and an image surface is BL, a refractive index of the first lens element is N1, an Abbe number of the second lens element is V2, a central thickness of the second lens element is CT2, an axial distance between the third lens element and the fourth lens element is T34, and the following conditions are satisfied:
$$0.05 < TD / BL < 0.6 ;$$
$$1.65 < N 1 < 2.2 ;$$
$$10. < V 2 < 45. ;$$
$$and$$
$$0.05 < CT 2 / T 34 < 1. .$$

17. The photographing optical lens system of claim 16, wherein the first lens element is made of glass material;
wherein the Abbe number of the second lens element is V2, and the following condition is satisfied:
$$15. < V 2 < 40.0 .$$

18. The photographing optical lens system of claim 16, wherein the refractive index of the first lens element is N1, an Abbe number of the first lens element is V1, the Abbe number of the second lens element is V2, and the following conditions are satisfied:
$$1.75 < N 1 < 2.1 ;$$
$$and$$
$$0.8 < V 1 / V 2 < 2. 0 .$$

19. The photographing optical lens system of claim 16, wherein the axial distance between the object-side surface of the first lens element and the image-side surface of the fourth lens element is TD, the axial distance between the image-side surface of the fourth lens element and the image surface is BL, and the following condition is satisfied:
$$0.12 < TD / BL < 0.35 .$$

20. The photographing optical lens system of claim 16, wherein a curvature radius of the object-side surface of the first lens element is R1, a curvature radius of the image-side surface of the second lens element is R4, and the following condition is satisfied:
$$- 3.00 < ( R 1 + R 4 ) / ( R 1 - R 4 ) < 0 .$$

21. The photographing optical lens system of claim 16, wherein the axial distance between the object-side surface of the first lens element and the image-side surface of the fourth lens element is TD, the central thickness of the second lens element is CT2, an axial distance between the second lens element and the third lens element is T23, and the following condition is satisfied:
$$4.5 < TD / ( CT 2 + T 23 ) < 8.00 .$$

22. The photographing optical lens system of claim 16, wherein a composite focal length of the first lens element and the second lens element is f12, a focal length of the fourth lens element is f4, and the following condition is satisfied:
$$0.01 < \vert f 12 / f 4 \vert < 0. 27 .$$

23. The photographing optical lens system of claim 16, wherein the object-side surface of the fourth lens element has at least one critical point in an off-axis region thereof;
wherein an axial distance between the object-side surface of the first lens element and the image surface is TL, a maximum image height of the photographing optical lens system is ImgH, and the following condition is satisfied:
$$5.5 < TL / ImgH < 7. 0 .$$

24. The photographing optical lens system of claim 16, wherein a distance in parallel with an optical axis between a maximum effective radius position of the object-side surface of the second lens element and a maximum effective radius position of the image-side surface of the second lens element is ET2, a distance in parallel with the optical axis between a maximum effective radius position of the object-side surface of the third lens element and a maximum effective radius position of the image-side surface of the third lens element is ET3, and the following condition is satisfied:
$$0.1 < ET 2 / ET 3 < 0.85 .$$

25. The photographing optical lens system of claim 16, further comprising a reflective element located between the fourth lens element and the image surface along a direction of the optical path, wherein the reflective element has at least three reflective surfaces.
